(19) United States
(12) Patent Application Publication
(10) Pub. No.: US 2024/0295362 A1
(43) Pub. Date: Sep. 5, 2024

(54) HEAT EXCHANGER AND METHOD OF MANUFACTURING A HEAT EXCHANGER

(71) Applicant: Woodside Energy Technologies Pty Ltd, Perth (AU)

(72) Inventor: Geoffrey Byfield, Nedlands (AU)

(21) Appl. No.: 18/660,533

(22) Filed: May 10, 2024

Related U.S. Application Data
(63) Continuation-in-part of application No. 16/023,478, filed on Jun. 29, 2018, now Pat. No. 12,007,176.
Application No. 16/023,478 is a continuation of application No. PCT/AU2017/050275, filed on Mar. 30, 2017.

(30) Foreign Application Priority Data
Mar. 30, 2016 (AU) 2016901182

(51) Int. Cl. F28D 7/00; B33Y 80/00; F28F 1/04

(52) U.S. Cl. CPC F28D 7/0008; F28F 1/04; B33Y 80/00

(57) ABSTRACT

A heat exchanger has a plurality of sets of fluid channels, each fluid channel having first and second end portions and an intermediate portion between the first and second end portions. The first end portions in a plane perpendicular to a direction of fluid flow in the channels have respective end perimeters which are in a first configuration, where adjacent end portions of different sets of fluid channels have a total first shared heat transfer length, this being a summation of lengths of mutually opposed perimeters of the adjacent end portions of the different sets. The intermediate portions of the channels in a plane transverse to the direction of fluid flow have respective intermediate channel perimeters, the intermediate portions having a second configuration with a total second shared heat transfer length being a summation of lengths of mutually opposed channel perimeters of the adjacent channels of the different sets.

### CROSS-REFERENCE TO RELATED APPLICATIONS

This application is a Continuation-In-Part of U.S. patent application Ser. No. 16/023,478, filed Jun. 29, 2018, which is a continuation of PCT/AU2017/050275, filed Mar. 30, 2017, which claims priority from Australian Patent Application No. 2016901182, filed Mar. 30, 2016, the disclosures of which are all incorporated herein by reference in their entireties.

### TECHNICAL FIELD

This specification discloses a heat exchanger and method of manufacturing a heat exchanger. The heat exchanger may be used for fluids including gases, liquids and two-phase fluid flows.

### BACKGROUND

The function of many types of heat exchangers is to transfer as much heat as possible from one fluid to another fluid in as little space as possible, with as low a pressure drop (pumping loss) as possible. It would be desirable to configure the geometry of a given heat exchanger to suit a given rate of heat exchange, if there were a practical and feasible way to do so.

Printed Circuit Heat Exchangers have been produced to provide a compact type of heat exchanger as an alternative to traditional shell and tube heat exchangers for locations where space savings are required for example in industrial plants. Printed circuit heat exchangers are marketed as being four to six times smaller and lighter than conventional designs such as shell-and-tube exchangers.

Printed circuit heat exchangers are manufactured using flat metal plates that form the core structure of the heat exchanger. Fluid flow channels are ‘printed’ into the flat metal plates by etching or ‘chemical milling’. These fluid flow channels are typically semicircular in cross section with a depth of 1.5 mm to 3 mm. The etched plates are then stacked on top of each other and diffusion bonded, converting the plates into a solid metal block containing the precisely engineered ‘printed’ fluid flow channels.

The plates are stacked such that there are alternate spacings between adjacent plates to form, respectively, the hot and cold fluid flow paths. The fluid flow paths within each plate carry the same kind of fluid at the same kind of temperature. Consequently, heat transfer only takes place between these adjacent plates. Whilst the manufacturers of printed circuit heat exchangers boast that they offer high heat transfer surface area per unit volume of the exchanger, resulting in reduced weight, space, and supporting structure, the manner in which the plates are stacked to form prior art printed circuit heat exchangers results in inherent inefficiencies in heat transfer.

Another disadvantage of printed circuit heat exchangers is that blockages of the fluid flow channels can easily occur because of the inherently small size of the channels which are typically in the range of 0.5 mm to 2 mm. Blockages require chemical cleaning which can be difficult in some installations. To avoid such blockages, it is known to install filtration devices so that the fluids entering the printed circuit heat exchanger are extremely clean. However, this adds to the overall cost of the system with maintenance of the filtration systems being required.

The above reference to the background art does not constitute an admission that the art forms part of the common general knowledge of a person of ordinary skill in the art. The above references are also not intended to limit the scope the application of the disclosed neat exchanger or its method of manufacture.

### SUMMARY

In a first aspect there is disclosed heat exchanger comprising: a plurality of sets of fluid channels each fluid channel having first and second end portions and an intermediate portion between the first and second end portions, the first end portions in a plane perpendicular to a direction of fluid flow in the channels have respective end perimeters which are in a first configuration wherein adjacent end portions of different sets of fluid channels have a total first shared heat transfer length being a summation of lengths of mutually opposed perimeters of the adjacent end portions of the different sets; and wherein the intermediate portions in a plane transverse to the direction of fluid flow have respective intermediate channel perimeters, the intermediate portions having a second configuration with a total second shared heat transfer length, being a summation of lengths of mutually opposed channel perimeters of the adjacent channels of the different sets, and wherein the total second shared heat transfer length is different to the total first heat transfer length.

In one embodiment the heat exchanger comprises at least one group of reconfiguring channels each group of reconfiguring channels having at least two channels from mutually different sets of channels; and wherein the at least one group of reconfiguring channels is reconfigured relative to adjacent channels from the first configuration to the second configuration wherein total the second shared heat transfer length is different to total first shared heat transfer length.

In one embodiment the total second shared heat transfer length is greater than the total first shared heat transfer length.

In one embodiment each group of reconfiguring channels is progressively rotated or twisted about an axis parallel to a direction of flow of fluid through the channels.

In one embodiment each group of reconfiguring channels is progressively rotated or twisted to an extent so that the channels in the reconfiguring group are, in at least one plane perpendicular to a flow of fluid, transposed relative to their position at one of the ends of the corresponding channels.

In one embodiment the channels in the reconfiguring group are maintained in their transposed position for at least a quarter of a length of the intermediate portion of the channels in the reconfiguring group.

In one embodiment the channels in the reconfiguring group of channels have their first end portions arranged in the first configuration and their second end portions in the first configuration and wherein the reconfiguring group of channels is progressively rotated or twisted from their transposed position so that the second end portions of the channels are in the first configuration.

In one embodiment at least a first set of the plurality of sets of channels is configured to have a first cross-sectional shape or area at the first end portion and a second cross sectional shape or area at least one point in their respective intermediate portions wherein the first cross sectional shape or area is different to the second cross sectional shape or area so that the second configuration is different to the first configuration.

In one embodiment the change in cross sectional shape of the first set of channels is accompanied by a change in juxtaposition of first set of channels relative to a second set of the plurality of sets of channels.

In one embodiment the second cross sectional shape is arranged so that a perimeter of the first set of channels in lies adjacent to a perimeter of two or more channels of the second set of channels.

In one embodiment the second cross sectional shape is generally triangular.

In one embodiment the first cross sectional shape is selected from the group comprising: circle, ellipse, polygon with four or more sides and a rounded polygon with four or more sides.

In one embodiment at least a second set of the plurality of sets of channels is configured to have a third cross sectional shape or area at the first end portion and a fourth cross sectional shape or area at least one point in their respective intermediate portions wherein the fourth cross sectional shape or area is different to the third cross sectional shape or area so that the second configuration is different to the first configuration.

In one embodiment in the first configuration the first end portions of the channels are arranged in alternating planes of channels so that each plane contains only channels from the same set of channels, and in the second configuration the channels are arranged in a chequerboard configuration wherein respective planes of channels include channels from different sets of channels.

In one embodiment the first configuration is a matrix comprising alternating rows of channels of different sets so that each row in the matrix comprises only channels of the same set and wherein the channels in the matrix are aligned in columns, and wherein mutually adjacent columns of channels are progressively offset relative to each other in a direction of the columns from the first ends to the intermediate portion so as to be arranged in the chequerboard configuration.

In one embodiment a cross sectional area of one or more channels in at least one of the sets of channels changes for at least a portion of the length of the one or more channels from the end portion to the intermediate portion.

In one embodiment a cross sectional shape of one or more channels in at least one of the sets of channels changes for at least a portion of the length of the one or more channels from the end portion to the intermediate portion.

In one embodiment the plurality of sets of fluid channels comprises a first set of channels and a second fluid channels and wherein in the first configuration the first end portions of the first set of channels have a first spacing from the first end portions of the second set of channels and in the second configuration the intermediate portions of the first set of channels have a second spacing from the intermediate portions of the second channels wherein the second spacing is less than the first spacing.

In one embodiment one or more of the channels in at least one of the sets of channels follow a three-dimensional helical or spiral path.

In one embodiment an internal surface of the at least one channel in at least one of the sets of channels is arranged to induce turbulence in fluid when flowing through the at least one first channel.

In one embodiment the internal surface of the at least one channel is one, or a combination of any two or more, of: (a) roughened; (b) provided with one or more grooves; (c) provided with one or more protruding ridges or rib; (d) provided raised dimples; and (e) provided with one or more fins; to induce turbulence in a fluid when flowing through the at least one first channel.

In one embodiment least one channel in at least one of the sets of channels has a channel wall of a thickness that varies at least one point in comparison to another point in that channel spaced upstream or downstream from the one point.

In one embodiment a first set of the channels has a first number of channels and a second set of channels has a second number of channels wherein the first number is different to the second number.

In one embodiment one or more of the channels in at least one of the sets of channels progressively changes in cross-sectional area from one end portion to an opposite end portion.

In one embodiment one or more of the channels in at least one of the sets of channels cyclically varies in cross sectional shape or area along a portion of a length of the channel.

In one embodiment the heat exchanger comprises a first inlet header and a first outlet header connected to the first end portions in the second end portions of a first set of channels; and a second inlet header and a second outlet header connected to the first end portions in a second end portions of a second set of channels; and wherein the headers are arranged to provide a counter-flow of fluid through the first set of channels and the second set of channels.

In one embodiment the heat exchanger comprises one or more passages which provide fluid communication between two or more channels in a common set of channels.

In a second aspect there is disclosed heat exchanger comprising:
a plurality of first fluid channels through which a first fluid can flow;
a plurality of second fluid channels through which a second fluid can flow;
and wherein for at least two points, one downstream of the other along a length of at least one of the first channels, one or both of a cross sectional area and a cross sectional shape of the least one of the first channels at one of the two points is different to that at the other of the two points.

In a third aspect there is disclosed a heat exchanger comprising:
a plurality of first fluid channels through which a first fluid can flow;
a plurality of second fluid channels through which a second fluid can flow;
and wherein one or more first channels comprise respective lengths that follow a three-dimensional spiral path.

In a fourth aspect there is disclosed a heat exchanger comprising:
a plurality of first fluid channels through which a first fluid can flow;
a plurality of second fluid channels through which a second fluid can flow;
and wherein at least one first channel has a first channel wall of a thickness that varies at least one point in comparison to another point spaced along the first channel.

In a fifth aspect there is disclosed a heat exchanger comprising:
a plurality of first fluid channels through which a first fluid can flow;
a plurality of second fluid channels through which a second fluid can flow;
wherein an internal surface of at least one first channel is arranged to induce turbulence in the first fluid when flowing through the at least one first channel.

In one embodiment the internal surface of the at least one first channel is one, or a combination of any two or more, of: (a) roughened; (b) provided with one or more grooves; (c) provided with one or more protruding ridges or rib; (d) provided with raised dimples; and (e) provided with one or more fins; to induce turbulence in a fluid when flowing through the at least one first channel.

In a sixth aspect there is disclosed a heat exchanger comprising:
a plurality of first fluid channels through which a first fluid can flow;
a plurality of second fluid channels through which a second fluid can flow;
and wherein one or both of a cross sectional area and a cross sectional shape of at least one first channel cyclically varies for at least a portion of the at least one first channel from a first end of the at least one first channel to a second opposite end of. the at least one first channel.

In a seventh aspect there is disclosed a heat exchanger comprising:
at least a first set of channels and a second set of channels, the first set of channels forming first flow paths for carrying a first fluid and the second set of channels forming second flow paths for carrying a second fluid;
a first wall surface area being a total surface area of material in the heat exchanger lying in a heat flow path between channels in the first and second sets in a first plane of the heat exchanger perpendicular to the first flow paths; and
a second wall surface area being a total surface area of material in the heat exchanger lying in a heat flow path between the first and second sets in a second plane of the heat exchanger perpendicular to the first flow paths, the second plane being either upstream or downstream of the first plane;
wherein the first wall surface area is different to the second wall surface area.

In one embodiment of the heat exchanger (a) the first and second sets of channels are in different positions relative to each other in the first plane compared to the second plane; or (b) a cross-sectional area or shape of at least one of the first and second sets of channels is different in the first plane compared to the second plane.

In one embodiment the heat exchanger comprises a first fluid Inlet header and first fluid outlet fluid header at opposite ends of the first sets of channels and a second fluid inlet header and a second fluid outlet header at opposite ends of the second sets of channels and wherein the first and second channels are arranged in alternating planar arrays adjacent the respective headers.

In an eighth aspect there is disclosed method of manufacturing a heat exchanger having at least two sets of channels comprising:
using an additive manufacturing technique to progressively build at least a main body of the heat exchanger the main body being provide a plurality of sets of fluid flow channels, each channel defining a respective fluid flow path having a first end portion, a second end portion and an intermediate portion;
wherein the configuration of the plurality of sets of channels that one of the end portions is different to the configuration of the set of channels in the intermediate portion.

In one embodiment the method comprises using the additive manufacturing technique to progressively build respective headers for the end portions of each of the sets of channels.

In one embodiment the method comprises building the headers in a continuous process with the building of the main body.

In one embodiment the method comprises constructing the headers separate to the main body and subsequently attaching the headers to the main body.

In one embodiment the method comprises utilising the additive manufacturing technique to progressively build at least two sets of fluid flow channels in a manner wherein one or more of a (a) position of at least one first channel relative to at least one second channel varies between two spaced apart points along a fluid flow path of the first channel; (b) a cross-sectional shape of at least one first channel varies between two spaced apart points along a fluid flow path of the first channel; and (c) a cross-sectional area of at least one first channel varies between two spaced apart points along a fluid flow path of the first channel.

In one embodiment the method comprises utilising the additive manufacturing technique to form an internal surface of at least one first channel in a manner to induce turbulence in a fluid when flowing through the at least one first channel.

In a ninth aspect there is disclosed a method of constructing a heat exchanger of any one of the first to seventh aspects comprising progressively building the plurality of sets of channels using an additive manufacturing technique.

In some embodiments, there is provided a heat exchanger. The heat exchanger may comprise: a plurality of sets of fluid channels each fluid channel having first and second end portions and an intermediate portion between the first and second end portions; the first end portions, in a plane perpendicular to a direction of fluid flow in the channels, having respective end perimeters which are in a first configuration wherein adjacent end portions of different sets of fluid channels have a total first shared heat transfer length being a summation of lengths of mutually opposed perimeters of the adjacent end portions of the different sets; the intermediate portions in a plane transverse to the direction of fluid flow having respective intermediate channel perimeters, the intermediate portions having a second configuration with a total second shared heat transfer length, being a summation of lengths of mutually opposed channel perimeters of the adjacent channels of the different sets; wherein the total second shared heat transfer length is different to the total first shared heat transfer length; and wherein in the first configuration the first end portions of the channels are arranged in alternating planes of channels so that each plane contains only channels from the same set of channels, and in the second configuration the channels are arranged in a chequerboard configuration wherein respective planes of channels include channels from different sets of channels.

In some embodiments, the first configuration is a matrix comprising alternating rows of channels of different sets so that each row in the matrix comprises only channels of the same set and wherein the channels in the matrix are aligned in columns.

In some embodiments, mutually adjacent columns of channels are progressively offset relative to each other in a direction of the columns from the first ends to the intermediate portion so as to be arranged in the chequerboard configuration.

In some embodiments, a cross sectional area of one or more channels in at least one of the sets of channels changes for at least a portion of the length of the one or more channels from the end portion to the intermediate portion.

In some embodiments, a cross sectional shape of one or more channels in at least one of the sets of channels changes for at least a portion of the length of the one or more channels from the end portion to the intermediate portion.

In some embodiments, there is provided a heat exchanger. The heat exchanger may comprise: a plurality of sets of fluid channels, each fluid channel having first and second end portions and an intermediate portion between the first and second end portions; the first end portions, in a plane perpendicular to a direction of fluid flow in the channels, having respective end perimeters which are in a first configuration wherein adjacent end portions of different sets of fluid channels have a total first shared heat transfer length being a summation of lengths of mutually opposed perimeters of the adjacent end portions of the different sets; wherein the intermediate portions in a plane transverse to the direction of fluid flow have respective intermediate channel perimeters, the intermediate portions having a second configuration with a total second shared heat transfer length, being a summation of lengths of mutually opposed channel perimeters of the adjacent channels of the different sets; wherein the total second shared heat transfer length is different to the total first heat transfer length; wherein at least a first set of the plurality of sets of channels is configured to have a first cross sectional shape or area at the first end portion and a second cross sectional shape or area at least one point in their respective intermediate portions wherein the first cross sectional shape or area is different to the second cross sectional shape or area so that the second configuration is different to the first configuration and the change in cross sectional shape of the first set of channels is accompanied by a change in juxtaposition of first set of channels relative to a second set of the plurality of sets of channels.

In some embodiments, the second cross sectional shape is arranged so that a perimeter of the first set of channels lies adjacent to a perimeter of two or more channels of the second set of channels.

In some embodiments, the second cross sectional shape is generally triangular.

In some embodiments, the first cross sectional shape is selected from the group comprising: circle, ellipse, polygon with four or more sides and a rounded polygon with four or more sides.

In some embodiments, at least a second set of the plurality of sets of channels is configured to have a third cross sectional shape or area at the first end portion and a fourth cross sectional shape or area at least one point in their respective intermediate portions.

In some embodiments, the fourth cross sectional shape or area is different to the third cross sectional shape or area so that the second configuration is different to the first configuration.

In some embodiments, there is provided a heat exchanger. The heat exchanger may comprise: a plurality of sets of fluid channels each fluid channel having first and second end portions and an intermediate portion between the first and second end portions; the first end portions, in a plane perpendicular to a direction of fluid flow in the channels, having respective end perimeters which are in a first configuration wherein adjacent end portions of different sets of fluid channels have a total first shared heat transfer length being a summation of lengths of mutually opposed perimeters of the adjacent end portions of the different sets; wherein the intermediate portions in a plane transverse to the direction of fluid flow have respective intermediate channel perimeters, the intermediate portions having a second configuration with a total second shared heat transfer length, being a summation of lengths of mutually opposed channel perimeters of the adjacent channels of the different sets; wherein the total second shared heat transfer length is different to the total first heat transfer length; and wherein the plurality of sets of fluid channels comprises a first set of channels and a second fluid channels and wherein in the first configuration the first end portions of the first set of channels have a first spacing from the first end portions of the second set of channels and in the second configuration the intermediate portions of the first set of channels have a second spacing from the intermediate portions of the second channels wherein the second spacing is less than the first spacing.

In some embodiments, an internal surface of the at least one channel in at least one of the sets of channels is arranged to induce turbulence in fluid when flowing through the at least one first channel.

In some embodiments, the internal surface of the at least one channel is one, or a combination of any two or more, of: (a) roughened; (b) provided with one or more grooves; (c) provided with one or more protruding ridges or rib; (d) provided raised dimples; and (e) provided with one or more fins; to induce turbulence in a fluid when flowing through the at least one first channel.

In some embodiments, at least one channel in at least one of the sets of channels has a channel wall of a thickness that varies at least one point in comparison to another point in that channel spaced upstream or downstream from the one point.

In some embodiments, a first set of the channels has a first number of channels and a second set of channels has a second number of channels wherein the first number is different to the second number.

In some embodiments, one or more of the channels in at least one of the sets of channels progressively changes in cross-sectional area from one end portion to an opposite end portion.

In some embodiments, one or more of the channels in at least one of the sets of channels cyclically varies in cross sectional shape or area along a portion of a length of the channel.

In some embodiments, the heat exchanger further comprises a first inlet header and a first outlet header connected to the first end portions and the second end portions respectively of a first set of channels; and a second inlet header and a second outlet header connected to the first end portions and the second end portions respectively of a second set of channels; and wherein the headers are arranged to provide a counter-flow of fluid through the first set of channels and the second set of channels.

In some embodiments, the heat exchanger further comprises one or more passages which provide fluid communication between two or more channels in a common set of channels.

In some embodiments, there is provided a heat exchanger. The heat exchanger may comprise: a plurality of first fluid channels through which a first fluid can flow; a plurality of second fluid channels through which a second fluid can flow; and wherein for at least two points, one downstream of the other along a length of at least one of the first channels, one or both of a cross sectional area and a cross sectional shape of the least one of the first channels at one of the two points is different to that at the other of the two points.

In some embodiments, there is provided a heat exchanger. The heat exchanger may comprise: at least a first set of channels and a second set of channels, the first set of channels forming first flow paths for carrying a first fluid and the second set of channels forming second flow paths for carrying a second fluid; a first wall surface area being a total surface area of material in the heat exchanger lying in a heat flow path between channels in the first and second sets in a first plane of the heat exchanger perpendicular to the first flow paths; and a second wall surface area being a total surface area of material in the heat exchanger lying in a heat flow path between the first and second sets in a second plane of the heat exchanger perpendicular to the first flow paths, the second plane being either upstream or downstream of the first plane; wherein the first wall surface area is different to the second wall surface area.

In some embodiments, (a) the first and second sets of channels are in different positions relative to each other in the first plane compared to the second plane; or (b) a cross-sectional area or shape of at least one of the first and second sets of channels is different in the first plane compared to the second plane.

In some embodiments, the heat exchanger further comprises a first fluid Inlet header and first fluid outlet fluid header at opposite ends of the first sets of channels and a second fluid inlet header and a second fluid outlet header at opposite ends of the second sets of channels and wherein the first and second channels are arranged in alternating planar arrays adjacent the respective headers.

In some embodiments, there is provided a method of manufacturing a heat exchanger having at least two sets of channels. The method may comprise: using an additive manufacturing technique to progressively build at least a main body of the heat exchanger the main body being provide a plurality of sets of fluid flow channels, each channel defining a respective fluid flow path having a first end portion, a second end portion and an intermediate portion; wherein the configuration of the plurality of sets of channels a one of the end portions is different to the configuration of the set of channels in the intermediate portion; and utilising the additive manufacturing technique to progressively build at least two sets of fluid flow channels in a manner wherein one or more of a (a) position of at least one first channel relative to at least one second channel varies between two spaced apart points along a fluid flow path of the first channel; (b) a cross-sectional shape of at least one first channel varies between two spaced apart points along a fluid flow path of the first channel; and (c) a cross-sectional area of at least one first channel varies between two spaced apart points along a fluid flow path of the first channel.

In some embodiments, the method further comprises using the additive manufacturing technique to progressively build respective headers for the end portions of each of the sets of channels.

In some embodiments, the method further comprises building the headers in a continuous process with the building of the main body.

In some embodiments, the method further comprises constructing the headers separate to the main body and subsequently attaching the headers to the main body.

In some embodiments, the method further comprises utilising the additive manufacturing technique to form an internal surface of at least one first channel in a manner to induce turbulence in a fluid when flowing through the at least one first channel.

In some embodiments, there is provided a method of manufacturing a heat exchanger having at least two sets of channels. The method may comprise: using an additive manufacturing technique to progressively build at least a main body of the heat exchanger the main body being provide a plurality of sets of fluid flow channels, each channel defining a respective fluid flow path having a first end portion, a second end portion and an intermediate portion end, wherein the configuration of the plurality of sets of channels at one of the end portions is different to the configuration of the set of channels in the intermediate portion; arranging the first end portions in a first configuration of alternating planes of channels so that each plane contains only channels from the same set of channels; rearranging or reorienting the channels so that the intermediate portions are in a second configuration where the channels are arranged in a chequerboard configuration wherein respective planes of channels include channels from different sets of channels; and rearranging or reorienting the channels from the second configuration so the second end portions revert to the first configuration.

In some embodiments, in the first configuration the first and second end portions are arranged as alternating rows and columns of channels wherein each row of end portions comprises only channels of the same set and each column of end portions comprises alternating channels of different sets.

In some embodiments, rearranging or reorienting the channels so that the intermediate portions are in a second configuration comprises progressively displacing mutually adjacent columns of the channels relative to each other in a direction of the columns from the first ends to the intermediate portion so as to be arranged in the chequerboard configuration.

In some embodiments, in the first configuration the first and second end portions are arranged as alternating rows and columns of channels wherein each row of end portions comprises only channels of the same set and each column of end portions comprises alternating channels of different sets.

In some embodiments, rearranging or reorienting the channels so that the intermediate portions are in a second configuration comprises nominally designating the columns as alternating first and second columns and progressively rotating or twisting pairs of mutually adjacent channels in the second columns about an axis parallel to a direction of flow of fluid through the channels so as to be arranged in the chequerboard configuration.

In some embodiments, there is provided a method of constructing a heat exchanger described herein, comprising progressively building the plurality of sets of channels using an additive manufacturing technique.

In some embodiments, there is provided a heat exchanger comprising: a plurality of sets of fluid channels, each fluid channel having first and second end portions and an intermediate portion between the first and second end portions; the first end portions, in a plane perpendicular to a direction of fluid flow in the channels, have respective end perimeters which are in a first configuration, wherein adjacent end portions of different sets of fluid channels have a total first shared heat transfer length being a summation of lengths of mutually opposed perimeters of the adjacent end portions of the different sets; the intermediate portions in a plane transverse to the direction of fluid flow have respective intermediate channel perimeters, the intermediate portions having a second configuration with a total second shared heat transfer length, being a summation of lengths of mutually opposed channel perimeters of the adjacent channels of the different sets; wherein the total second shared heat transfer length is different to the total first heat transfer length; and wherein in the first configuration the first end portions of the channels are arranged in alternating planes of channels so that each plane contains only channels from the same set of channels.

In some embodiments, in the second configuration, the channels are arranged in a chequerboard configuration.

In some embodiments, the heat exchanger comprises at least one group of reconfiguring channels each group of reconfiguring channels having at least two channels from mutually different sets of channels; and wherein the at least one group of reconfiguring channels is reconfigured relative to adjacent channels from the first configuration to the second configuration.

In some embodiments, each group of reconfiguring channels is progressively rotated or twisted about an axis parallel to a direction of flow of fluid through the channels.

In some embodiments, each group of reconfiguring channels is progressively rotated or twisted to an extent so that the channels in the reconfiguring group are, in at least one plane perpendicular to a flow of fluid, transposed relative to their position at one of the ends of the corresponding channels.

In some embodiments, the channels in the reconfiguring group are maintained in their transposed position for at least a quarter of a length of the intermediate portion of the channels in the reconfiguring group.

In some embodiments, the channels in the reconfiguring group of channels have their first end portions arranged in the first configuration and their second end portions in the first configuration and wherein the reconfiguring group of channels is progressively rotated or twisted from their transposed position so that the second end portions of the channels are in the first configuration.

In some embodiments, a cross sectional shape of one or more channels in at least one of the sets of channels changes for at least a portion of the length of the one or more channels from the end portion to the intermediate portion.

In some embodiments, the change in cross sectional shape of a first set of channels is accompanied by a change in juxtaposition of the first set of channels relative to a second set of channels.

In some embodiments, a cross sectional shape of the first set of channels is arranged so that a perimeter of the first set of channels lies adjacent to a perimeter of two or more channels of a second set of channels.

In some embodiments, the cross sectional shape of one or more channels in the intermediate portion is generally triangular.

In some embodiments, the cross sectional shape at the end portion of one or more channels is selected from the group comprising: circle, ellipse, polygon with four or more sides and a rounded polygon with four or more sides.

In some embodiments, a cross sectional area of one or more channels in at least one of the sets of channels changes for at least a portion of the length of the one or more channels from the end portion to the intermediate portion.

In some embodiments, at least a second set of the plurality of sets of channels is configured to have a cross sectional shape or area at the end portion that is different from a cross sectional shape or area at the intermediate portion.

In some embodiments, the first configuration is a matrix comprising alternating rows of channels of different sets so that each row in the matrix comprises only channels of the same set, and wherein the channels in the matrix are aligned in columns, and wherein mutually adjacent columns of channels are progressively offset relative to each other in a direction of the columns from the first ends to the intermediate portion so as to be arranged in the chequerboard configuration.

In some embodiments, the plurality of sets of fluid channels comprises a first set of channels and a second fluid channels, and wherein, in the first configuration, the first end portions of the first set of channels have a first spacing from the first end portions of the second set of channels, and in the second configuration, the intermediate portions of the first set of channels have a second spacing from the intermediate portions of the second channels, wherein the second spacing is less than the first spacing.

In some embodiments, one or more of the channels in at least one of the sets of channels follow a three-dimensional helical or spiral path.

In some embodiments, the total second shared heat transfer length is greater than the total first shared heat transfer length.

Disclosed herein in is a method of constructing a heat exchanger comprising progressively building the plurality of sets of channels using an additive manufacturing technique.

Disclosed herein is a method of manufacturing a heat exchanger having at least two sets of channels comprising: using an additive manufacturing technique to progressively build at least a main body of the heat exchanger, the main body being provided with a plurality of sets of fluid flow channels, each channel defining a respective fluid flow path having a first end portion, a second end portion and an intermediate portion, wherein the configuration of the plurality of sets of channels at one of the end portions is different to the configuration of the set of channels in the intermediate portion; arranging the first end portions in a first configuration of alternating planes of channels so that each plane contains only channels from the same set of channels; rearranging or reorienting the channels so that the intermediate portions are in a second configuration which is different to the first configuration; and rearranging or reorienting the channels from the second configuration so the second end portions revert to the first configuration.

Various features of the above aspects are defined in the dependent claims annexed to this specification and are incorporated in the Summary by way of reference.

### BRIEF DESCRIPTION OF THE DRAWINGS

Notwithstanding any other forms which may fall within the scope of the heat exchanger as set forth in the Summary, specific embodiments will now be described, by way of example only, with reference to the accompanying drawings, in which:

FIG. 1a is a perspective view of an embodiment of a portion of the disclosed heat exchanger;

FIG. 1b is a schematic representation of a manifold/header arrangement of the heat exchanger shown in FIG. 1a;

FIGS. 2a, 2b, 2c and 2d depict cross sectional profiles of fluid channels in planes of the heat exchanger extending from an end portion of the channels in a transition zone of the heat exchanger to an intermediate portion of the channels in a heat transfer zone of the heat exchanger and showing one technique for reconfiguration of the channels from the transition zone to the heat transfer zone in which groups of channels are twisted or rotated;

FIG. 3 depicts cross sectional profiles of fluid channels in planes of the heat exchanger extending from an end portion of the channels in a transition zone of the heat exchanger to an intermediate portion of the channels in a heat transfer zone of the heat exchanger and showing a second technique for reconfiguration of the channels from the transition zone to the heat transfer zone in which groups or columns of channels are linearly translated relative to each other;

FIGS. 4a, 4b and 4c depict cross sectional profiles of fluid channels in various planes of the heat exchanger extending from an end portion of the channels in a transition zone of the heat exchanger to an intermediate portion of the channels in a heat transfer zone of the heat exchanger and showing a third technique for reconfiguration of the channels from the transition zone to the heat transfer zone in which the cross sectional shape or profile of the channels together with their relative juxtaposition changes;

FIGS. 4d and 4e depict cross sectional profiles of fluid channels in various planes of a disclosed heat exchanger extending from an end portion of the channels in a transition zone of the heat exchanger to an intermediate portion of the channels in a heat transfer zone of the heat exchanger and showing a fourth technique for reconfiguration of the channels from the transition zone to the heat transfer zone in which the cross sectional shape or profile of the channels remains constant but their relative juxtaposition changes;

FIGS. 5a and 5b depict in various planes of a disclosed heat exchanger extending from an end portion of the channels in a transition zone (FIG. 5b) to an intermediate portion of the channels in a heat transfer zone (FIG. 5a) of an embodiment of the disclosed heat exchanger where a ratio of channels between the two sets is 3:1;

FIG. 6a depicts a plane in a heat transfer zone of a further embodiment of the disclosed heat exchanger where the channels in different sets have a different cross sectional shape or profile in the heat transfer zone, one set having a rounded quadrilateral profile with the other set having an octagonal profile;

FIG. 6b depicts one possible starting configuration of the different sets of channels for the embodiment of the heat exchanger shown in FIG. 6a, here the starting shape of the end portions of the channels in different sets is the same as that in the intermediate portion shown in FIG. 6a;

FIG. 6c depicts an alternate starting configuration of the different sets of channels for the embodiment of the heat exchanger shown in FIG. 6a, here the starting shape of the end portions of the channels in different sets is different to that in the intermediate portion shown in FIG. 6a and more particularly the shape of the channels in different sets in the end portions of the same as each other;

FIGS. 7a and 7b depict in various planes of a disclosed heat exchanger extending from an end portion of the channels in a transition zone (FIG. 7b) to an intermediate portion of the channels in a heat transfer zone (FIG. 7a) of an embodiment of the disclosed heat exchanger where the channels of different sets have a different cross sectional shape or profile in the heat transfer zone, one set having a circular profile with the other set having a profile made from a plurality of joined concave walls;

FIGS. 8a, 8b and 8c depict an arrangement of channels in respective different sets of channels in a further embodiment of the disclosed heat exchanger where the channels are reconfigured from a first end portion to a second opposite end portion by way of a progressive change in cross-sectional area for channels in both set of channels;

FIGS. 9a, 9b and 9c depict an arrangement of channels in respective different sets of channels in a further embodiment of the disclosed heat exchanger in which the sets of channels are reconfigured from a first end portion to a second opposite end portion where the reconfiguration is manifested by a progressive change in cross-sectional area for a channel in one set of channels with the cross-sectional area for a channel in the other set of channels remaining constant;

FIGS. 10a, 10b and 10c depict an arrangement of channels in respective different sets of channels in a further embodiment of the disclosed heat exchanger in which the sets of channels are reconfigured from a first end portion to a second opposite end portion where the reconfiguration is a progressive increase in cross-sectional area for channels in one set of channels and a progressive decrease in cross-sectional area for channels in the other set of channels;

FIG. 11 depicts in cross-section a fluid flow channel that may be incorporated in an eighth embodiment of the disclosed heat exchanger in which the cross-sectional area of the channel cyclically varies along a portion of a length of the channel;

FIG. 12 depicts in cross-section flow channels of a further embodiment of the disclosed heat exchanger taking a form of a shell and tube heat exchanger;

FIG. 13 is a schematic representation of a fluid flow channel that follows a three-dimensional spiral path and may be incorporated in a further embodiment of the disclosed heat exchanger;

FIGS. 14a and 14b depict cross sectional profiles of fluid channels in identical configurations that shown in FIGS. 2a and 2d respectively but highlighting the cross-sectional area of the material of the heat exchanger through which heat is transferred between fluids flowing in the respective channels in spaced apart perpendicular planes of the heat exchanger;

FIGS. 15a and 15b depict cross sectional profiles of fluid channels in planes of the heat exchanger extending from an end portion of the channels in a transition zone of the heat exchanger to an intermediate portion of the channels in a heat transfer zone of the heat exchanger and showing one technique for reconfiguration of the channels from the transition zone to the heat transfer zone in which groups of channels are twisted or rotated and in which the fluid channels are quadrilaterals;

FIGS. 16a, 16b, 16c and 16d depict cross sectional profiles of fluid channels in planes of the heat exchanger extending from an end portion of the channels in a transition zone of the heat exchanger to an intermediate portion of the channels in a heat transfer zone of the heat exchanger and the technique for reconfiguration of the channels of FIG. 15;

FIG. 17 depicts cross sectional profiles of fluid channels in planes of the heat exchanger extending from an end portion of the channels in a transition zone of the heat exchanger to an intermediate portion of the channels in a heat transfer zone of the heat exchanger and showing one technique for changing the cross-sectional shape and/or area of the channels from the transition zone to the heat transfer zone;

FIGS. 18a and 18b depict cross sectional profiles of fluid channels in planes of the heat exchanger of FIG. 17 in which the fluid channels have different cross-sectional shape and/or area in the transition zone and the heat transfer zone;

FIG. 19 depicts cross sectional profiles of fluid channels in planes of the heat exchanger extending from an end portion of the channels in a transition zone of the heat exchanger to an intermediate portion of the channels in a heat transfer zone of the heat exchanger and showing one technique for reconfiguration of the channels from the transition zone to the heat transfer zone in which groups of channels are twisted or rotated and in which the fluid channels are triangular;

FIGS. 20a, 20b, 20c and 20d depict cross sectional profiles of fluid channels in planes of the heat exchanger extending from an end portion of the channels in a transition zone of the heat exchanger to an intermediate portion of the channels in a heat transfer zone of the heat exchanger and the technique for reconfiguration of the channels of FIG. 19;

FIG. 21 depicts cross sectional profiles of fluid channels in planes of the heat exchanger extending from an end portion of the channels in a transition zone of the heat exchanger to an intermediate portion of the channels in a heat transfer zone of the heat exchanger and showing one technique for changing the cross-sectional shape and/or area of the channels and in which groups of channels are translated from the transition zone to the heat transfer zone;

FIGS. 22a, 22b, 22c and 22d depict cross sectional profiles of fluid channels in planes of the heat exchanger extending from an end portion of the channels in a transition zone of the heat exchanger to an intermediate portion of the channels in a heat transfer zone of the heat exchanger and the technique for reconfiguration of the channels of FIG. 21;

FIGS. 23a, 23b and 23c depict cross sectional profiles of fluid channels in planes of the heat exchanger extending from an end portion of the channels in a transition zone of the heat exchanger to an intermediate portion of the channels in a heat transfer zone of the heat exchanger and showing one technique for changing the cross-sectional shape and/or area of the channels from the transition zone to the heat transfer zone;

FIGS. 24a, 24b and 24c depict cross sectional profiles of fluid channels in planes of the heat exchanger extending from an end portion of the channels in a transition zone of the heat exchanger to an intermediate portion of the channels in a heat transfer zone of the heat exchanger and showing one technique for changing the cross-sectional shape and/or area of the channels and in which groups of channels are translated from the transition zone to the heat transfer zone; and

FIGS. 25a, 25b and 25c depict cross sectional profiles of fluid channels in planes of the heat exchanger extending from an end portion of the channels in a transition zone of the heat exchanger to an intermediate portion of the channels in a heat transfer zone of the heat exchanger and showing one technique for changing the cross-sectional shape and/or area of the channels and in which groups of channels are translated from the transition zone to the heat transfer zone.

### DETAILED DESCRIPTION

Specific embodiments of the disclosed heat exchanger will now be described by way of example only. The terminology used herein is for the purpose of describing particular embodiments only, and is not intended to limit the scope of the disclosed heat exchanger. Unless defined otherwise, all technical and scientific terms used herein have the same meanings as commonly understood by one of ordinary skill in the art to pertaining to heat exchangers. In the drawings, it should be understood that like reference numbers refer to like parts.

Before one embodiment of the disclosed heat exchanger is explained in detail, it is to be understood that the disclosed heat exchanger is not limited in its application to the details of construction and the arrangements of components set forth in the following description or illustrated in the drawings. The disclosed heat exchanger is capable of other embodiments and of being practiced or being carried out in various ways. Also, it is to be understood that the phraseology and terminology used herein is for the purpose of description and should not be regarded as limiting.

The term ‘fluid’ as used herein refers to a gas or a liquid or a two-phase mixture of gas and liquid.

### Rotated or Twisted Channels

### Heat Exchanger 10a

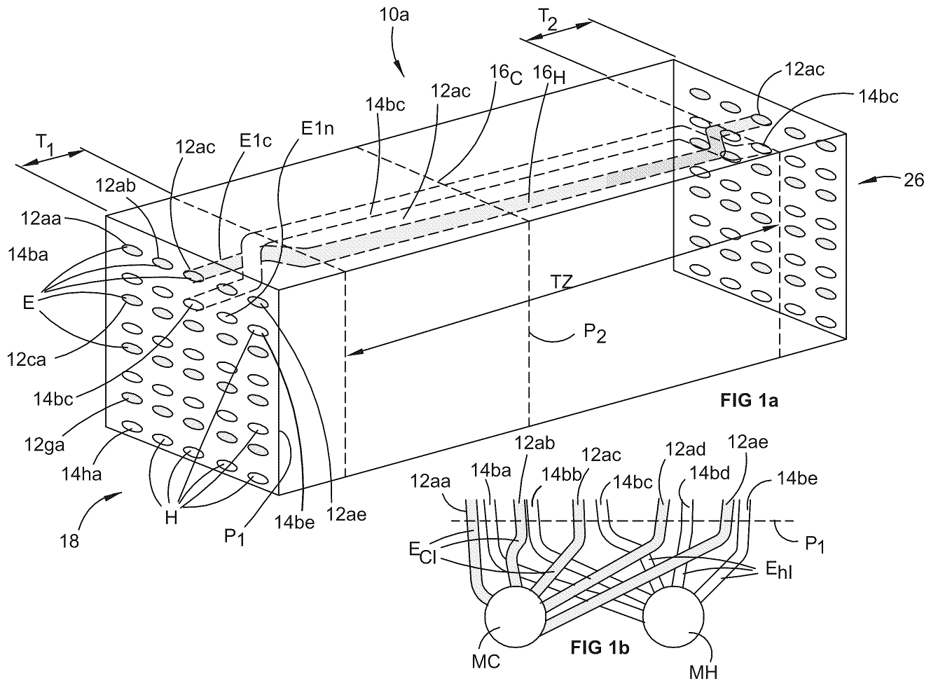

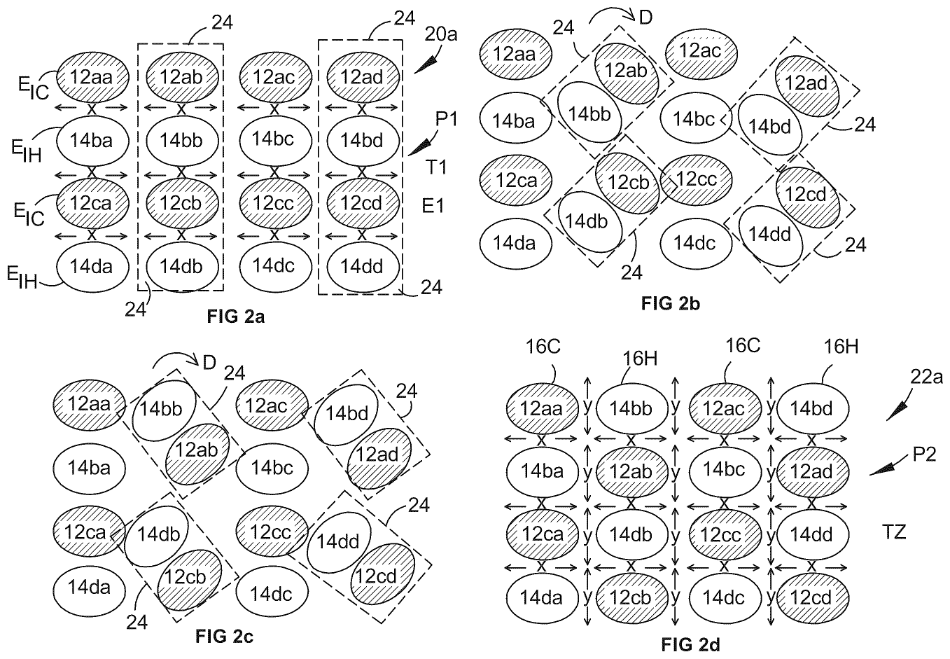

FIGS. 1a-2d depict a first embodiment of the disclosed heat exchanger 10a. The heat exchanger 10a comprises a plurality of sets of fluid channels. In this particular embodiment there are two sets of fluid channels H and C. For convenience the set of channels H may be considered as a set of channels for carrying a hot fluid while the set of channels C may be considered as a set of channels for carrying a cold fluid. The channels in the set H are depicted as channels with white ends while the channels in the set C are depicted as shaded.

The individual channels in the set C are denoted as channels 12ij where ij denote matrix positions which are referenced by letters a-z. In FIG. 1a at the top left-hand corner there is a channel 12aa and at a right-hand end of the same row there is a channel 12ae. However collectively and in general the channels 12ij are hereinafter referred to as channels “12”.

The individual channels in the set H are denoted as channels 14ij where ij denote matrix positions which are referenced by letters a-z. In FIG. 1a near the top left-hand corner there is a channel 14ba and at a right-hand end of the same row there is a channel 14be. However collectively and in general the channels 14ij are hereinafter referred to as channels “14”.

Each of the channels 12, 14 has a first end portion E1C, E1H and a second end portion E2C, E2H respectively (hereinafter referred to collectively and in general as “first end portions E1” and “second end portions E2”; further, for ease of description, the end portions in a general sense, whether they be the first end portions or the second end portions, are referred to hereinafter as “end portions E”).

In between the end portions E each channel 12, 14 has an intermediate portion 16C, 16H respectively (hereinafter referred to collectively and in general as “intermediate portions 16”).

The end portions E1C of the channels 12 at one end 18 of the heat exchanger 10a in the set C are connected to and are in fluid communication with a manifold MC. The end portions E1H of the channels 14 at the same end 18 of the heat exchanger 10a in the set H are connected to and are in fluid communication with a manifold MH.

The first end portions E1 in a plane P1 perpendicular to the direction of flow of fluid through the heat exchanger 10a have a first configuration 20a as shown in FIG. 2a. It will be noted that in this configuration adjacent channels of different sets H and C have a shared heat transfer length X. This is in effect the shared boundary or perimeter length between the walls of adjacent channels in the different sets. Thus, looking at FIG. 2a the channels 12aa and 14ba have a shared heat transfer length X; as do channels 12ab and 14bb; 12ac and 14bc; 12ad and 14bd; 14ba and 12ca, et cetera. So, in this example, there is a total first shared heat transfer length of 12X being the summation of the length of mutually opposed perimeters of the adjacent end portions of the different sets C and H.

FIG. 2d shows the intermediate portion 16 of the channels in the sets C and H in a plane P2 perpendicular to the direction of flow of fluid through the channels. It will be noted here that channels 12, 14 are now in a second configuration 22a which is different to the first configuration shown in FIG. 2a. The effect of this change in configuration is that now mutually adjacent channels of different sets C and H have a different, and in this particular embodiment increased, shared heat transfer length.

The change in the shared heat transfer length between channels in different sets C and H arises through a reorientation of the channels 12 and 14 so that now each channel in any set is adjacent to more than one channel of a different set. For example, with reference to FIG. 2d the channel 12aa in the set C is now adjacent to channels 14bb and 14ba in the set H. As a consequence, there is a shared heat transfer length X between the channel 12aa and the channel 14ba, and a shared heat transfer length Y between the channel 12aa and channel 14bb.

Carrying this analysis through for the entire configuration 22a the total shared heat transfer length between the channels, (which is the summation of the length of mutually opposed channel perimeters of adjacent channels of different sets H and C) is 12X+12Y. Thus the shared heat transfer length is different between two points along the fluid flow path. In particular in this embodiment the shared is heat transfer length increased by 12Y from the end 18 to the intermediate plane P2. This provides greater heat transfer efficiency than the configuration 20a shown in FIG. 2a.

In order to reconfigure the pattern of the channels from the configuration 20a to the configuration 22a at least one group of reconfiguring channels 24 is formed or selected. Each group of reconfiguring channels has at least two channels from mutually different sets of channels C and H. For example, FIG. 2b shows four groups of reconfiguring channels 24. These groups comprise channels 12ab and 14bb; 12ad and 14bd; 12cb and 14db; and 12cd and 14dd. Each group of the reconfiguring channels 24 has one channel 12 from the set C and one channel 14 from the set H. The effect of reorientation of the groups of channels 24 is to increase the shared heat transfer length of the channels 12, 14 from that in the configuration 20a to that in configuration 22a.

In this embodiment the reconfiguration is in the form of a progressive rotation or twisting of the reconfiguring groups 24 about an axis parallel to a direction of flow of fluid through the channels 12, 14. The progressive rotation is illustrated in the sequence of FIGS. 2a-2d, where the respective groups 24 are rotated in the clockwise direction shown by arrow D by 180° from their positions in the first configuration 20a to the second configuration 22a.

The reconfiguration of the channels 12, 14 from the first configuration 20a to second configuration 22a occurs over a transition zone T1 at one end of the heat exchanger 10a. As explained further below, in this embodiment there is a further reconfiguration of the channels 12, 14 from the second configuration 22a back to the first configuration 20a over a second transition zone T2 at an opposite end of the heat exchanger 10a.

In between the transition zones T1 and T2 there is a main heat exchanger zone TZ where the channels 12, 14 are maintained in the second configuration 22a. To maximise heat transfer the length of the zone TZ should be as long as possible in comparison to the overall flow path length of fluid flowing through the heat exchanger 10a. In one example the channels 12, 14 are maintained in the second configuration 22a, i.e. where the reorientated groups are maintained in their transposed positions, for a length of at least one quarter of the length of the fluid flow path through the heat exchanger 10a.

In this embodiment at a second end 26 of the heat exchanger 10a the second end portions E2 of the channels 12, 14 are also in the first configuration 20a. The reconfiguration of the channels from the second orientation 22a in heat transfer zone Z to the first configuration 20a at the end 26 occurs through the second transition zone T2. This reconfiguration can occur in one of two ways. Either the reorientated groups 24 can be rotated or twisted about an axis parallel to the direction of fluid flow in the clockwise direction D through 180° alternately they may be twisted or rotated in the anticlockwise direction by 180°.

In this specific embodiment the end portions E1 of channels 12 in the first set C may be, or are otherwise connected to, outlets while the end portions E1 of the channels 14 in the second set H may be, or are otherwise connected to, inlets. Conversely the end portions E2 the first of channels 12 in the first set C are inlets while the end portions E2 of the channels 14 in the second set H are outlets. As recognised by those skilled in the art with this arrangement of inlets and outlets the heat exchanger 10a is arranged as a counter-flow heat exchanger.

In an alternate embodiment it is possible to arrange the ends E1 of both channels 12 and 14 to be inlets and the ends E2 to of the channels to be outlets in which event the heat exchanger would be a parallel or concurrent flow heat exchanger. However, this has less thermal efficiency than the counter-flow heat exchanger.

In the present embodiment in the first orientation 20a the channels 12, 14 are arranged in alternating rows or planes of channels of the same type. Thus, with reference to FIG. 2a there is a top row or plane of channels 12aa-12ad in the set C, beneath this is a row of channels 14ba-14bd from the set H, beneath this is a row of channels 12ca-12cd from the set C, et cetera. This arrangement facilitates the connection of planes of channels of the same type to a corresponding manifold MC or MH in a header section of the heat exchanger 10a. In the second configuration 22a the channels 12, 14 may be considered to be in a chequerboard arrangement or configuration.

### Progressive Relative Linear Translation

There are alternate ways of reconfiguring the channels 12, 14 in the sets C and H so that the total first shared heat transfer length is different to the total second shared heat transfer length to thereby control heat transfer between fluids in the heat exchanger.

### Heat Exchanger 10b

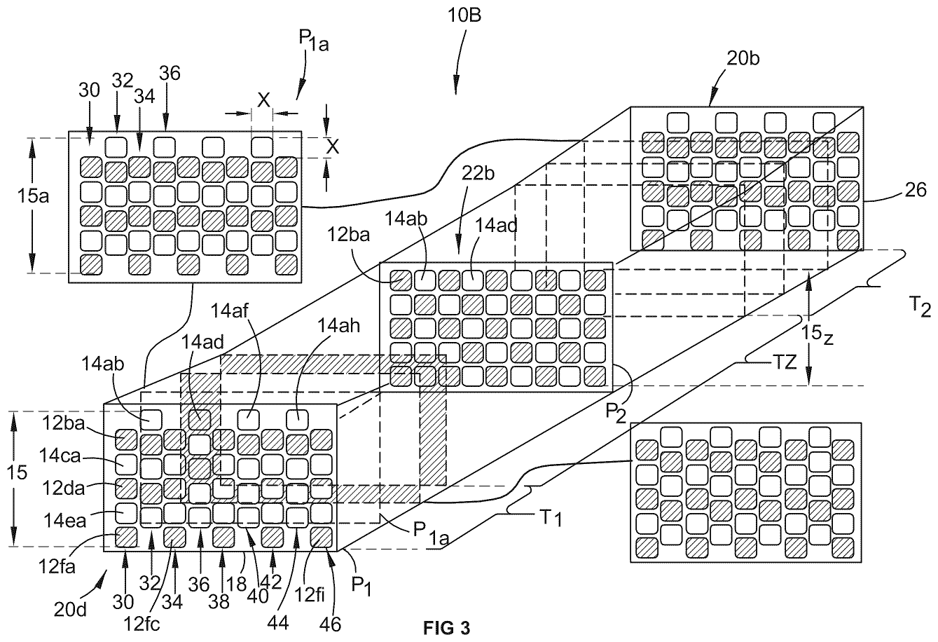

One of these alternatives is shown in FIG. 3 which shows a second embodiment of the heat exchanger 10b. The heat exchanger 10b comprises a first set C of channels 12 and a second set H of channels 14. In the first configuration 20b at an end 18 the channels 12 and 14 are again arranged in alternating rows or planes. However, in the very top row there are only four channels 14 and in the very bottom row there are only five channels 12. The channels 12 and 14 in the top and bottom rows are in alternate columns and staggered with respect to each other. In between the top and bottom rows there are nine channels of the same type in alternating rows or planes.

In this embodiment each of the channels 12, 14 have a cross sectional shape in the form of a rounded quadrilateral (and more particularly a square) with side lengths X. In the first configuration 20b in plane P1 the total first shared heat transfer length is 36X. This is a made up as follows:
between the rows commencing with the channels 12ba and 14ca there is a shared heat transfer length of 9X,
between the rows commencing with the channels 14ca and 12da there is a shared heat transfer length of 9X,
between the rows commencing with the channels 12da and 14ea there is a shared heat transfer length of 9X,
between the rows commencing with the channels 14ab and 12ba there is a shared heat transfer length of 4X, and
between the rows commencing with the channels 14ea and 12fa there is a shared heat transfer length of 5X.

Hence the summation of the length of mutually opposed perimeters of channels in the different sets C and H is: 9X+9X+9X+4X+5X=36X.

In the second configuration 22b the channels 12, 14 are in the chequerboard configuration and have a total second shared heat transfer length of 76X. This is made up as follows:
between respective adjacent rows of channels 12, 14 there is a shared heat transfer length of 9X, there are four sets of respective adjacent rows of channels and therefore the rows of channels contribute four lots of 9X, i.e. 36X of the shared heat transfer length,
between adjacent columns of channels 12, 14 there is an additional 5X of shared heat transfer length and there are eight lots of respective adjacent columns thus the columns contribute eight times 5X i.e. 40 X of the shared heat transfer length.

Hence the summation of the length of mutually opposed perimeters of channels in different sets C and H is 36X+40 X=76X.

In the heat exchanger 10b the reconfiguration of channels between the first configuration 20b and the second configuration 22b is by a progressive relative linear translation or offset of channels in mutually adjacent columns or groups in opposite directions. This progressive offset is at a maximum at the ends 18 and 26 coinciding with the beginning of the transition zone T1 and the end of the transition zone T2. The offset is at a minimum in the heat transfer zone TZ.

For example, looking at FIG. 3 in a plane P1 there is a transverse distance 15 between the top of the channels 14 in the top row to the bottom of the channels 12 in the bottom row. In the plane P1 this distance is marked as 15a and in the plane P2 this distance is marked as 15z.

The relationship between these distances is as follows: 15>15a>15z, so that the distance reduces to a minimum in the heat transfer zone TZ. When moving from the heat transfer zone TZ to the end of the transition zone T2 the progressive relative linear translation between the columns of channels is reversed so that at the end 26 the channels 12, 14 are once again arranged in separate planes in the configuration 20b.

The progressive relative translation between the mutually adjacent columns of channels may be effected for example by translating a first set of the columns 30, 34, 38, 42 and 46 in an upward direction relative to the intervening columns 32, 36, 40 and 44 when moving along the heat exchanger from the end 18 to the heat transfer zone TZ. The reverse translation may then occur from an opposite end of the heat transfer zone TZ to the end of the transition zone T2 at end 26.

Naturally the same effect can be achieved by alternate translations for example translating the intervening columns in a downward direction relative to the first set of columns; or translating the first set/group of the columns in an upward direction and the intervening set/group of columns in the downward direction.

### Change of Channel Shape or Cross-Sectional Profile

Another way of reconfiguring the channels 12, 14 in the sets C and H so that the total first shared heat transfer length is different to the total second shared heat transfer length is to reconfigure or otherwise change the cross-sectional shape of one or both of the channels 12, 14 from the end portions E to the intermediate portion 16.

### Heat Exchanger 10c

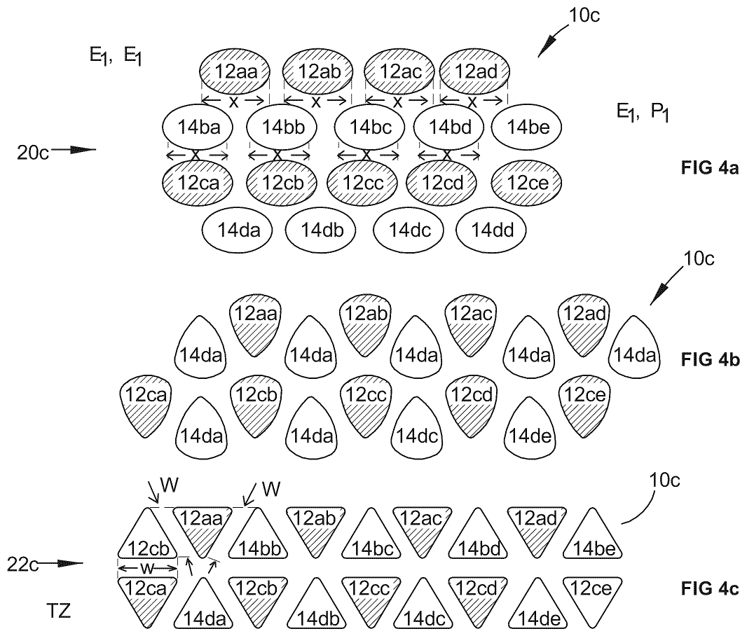

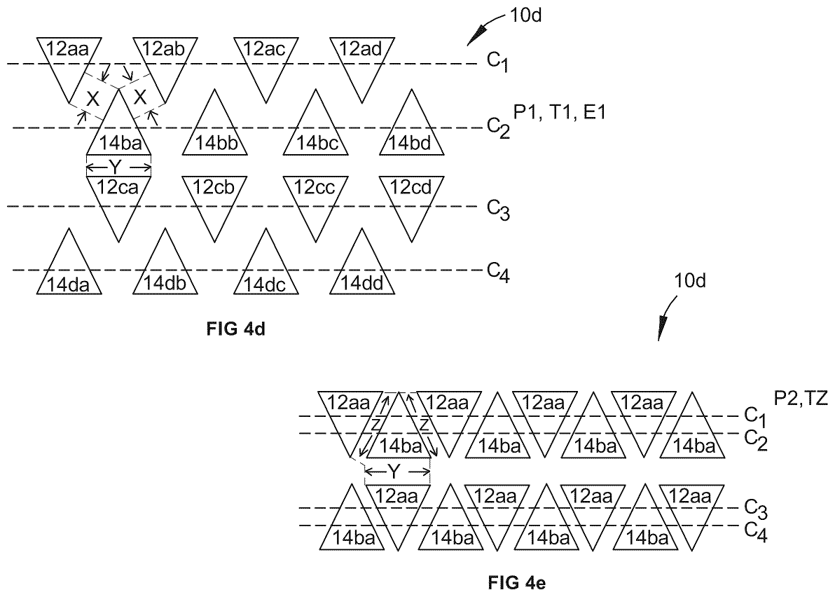

One example of this is shown in the heat exchanger 10c in FIGS. 4a to 4c. Here the channels 12 and 14 are of a generally elliptical cross-sectional shape or profile at the first and second end portions E1 and E2 and arranged in alternate rows or layers so as to have a first configuration similar to that of the channels 12, 14 in the first embodiment of the heat exchanger 10a shown in FIGS. 1a-2d. However, the cross sectional shape or profile of the channels 12 and 14 changes to a generally triangular shape or profile in the intermediate portion 16 coinciding with the heat transfer zone TZ. The reconfiguration is also accompanied by a progressive shifting of the channels 12 and 14 so as to occupy or reside in one half of the number of rows in the heat exchange zone Z as compared to the number of rows in the transition zones T1 and T2.

FIG. 4a shows the end portions E1 of the channels 12 and 14 in a first configuration 20c at an equivalent location to the plane P1 of FIG. 1a. (The same configuration would exist in the end portions E2.) The number of channels in each row also alternates by one for adjacent rows in the same set C or H. For example, in this specific embodiment there are four channels 12 in the first row and five channels 12 in the third row. If there were two further rows in the heat exchanger 10c then the next row of channels 12 below the row starting with channel 14da would have only four channels, and the subsequent row of channels 14 would have five channels. Similarly, the number of channels 14 alternates between four and five.

FIG. 4b shows the configuration of the channels 12 and 14 transitioning from the initial configuration shown in FIG. 4a to the configuration FIG. 4c.

FIG. 4c shows the channels 12 and 14 in the second configuration in the heat exchange zone Z. The cross-sectional shape or profile of the channels 12, 14 is now changed to a rounded equilateral triangular shape. Additionally, the channels 12 and 14 from mutually adjacent rows have merged in alternating fashion to form a single row. This has the effect of reducing the total number of rows of channels 12, 14 by half in the heat transfer zone Z.

Comparing the first and second shared heat exchange length in the first and second configurations 20c, 22c can be seen that:
the total first shared heat exchange length (shown in FIG. 4a) is approximately 13X, while
the total second shared heat exchange length (shown in FIG. 4c) is about 21W, where W is the length of any side of the triangular shaped channels in the intermediate portion 16. (The second shared heat exchange length will be greater than 21W due to the adjacency of the apexes in adjacent pairs of channels of different rows, e.g. the apex of channel 12aa has a common heat transfer perimeter with the facing apex of channel 14da)

Thus provided W>(13/21) X, or stated another way provided W>62% X then the second shared heat exchange length is greater than (and therefore different to) the first shared heat exchange length resulting in a greater degree of heat exchange in the heat exchange zone Z. It is envisaged that in embodiments of the system 10c the dimension W may be arranged to be in the order of 65% to 95% of X.

In a more general sense the above describes an embodiment of the disclosed heat exchanger 10 comprising a plurality of first fluid channels 12 through which a first fluid can flow, a plurality of second fluid channels 14 through which a second fluid can flow and where for at least a length of each first channel 12 a cross sectional area of each first channel progressively changes.

In this particular example the area changes from πXY/2 for the channels 12 at the end portion E1 to about W2/2 for the equilateral triangular shape of the channels 12 in the heat transfer zone Z. Of course in this embodiment the channels 14 also undergo the same change in cross-sectional area and indeed cross sectional shape.

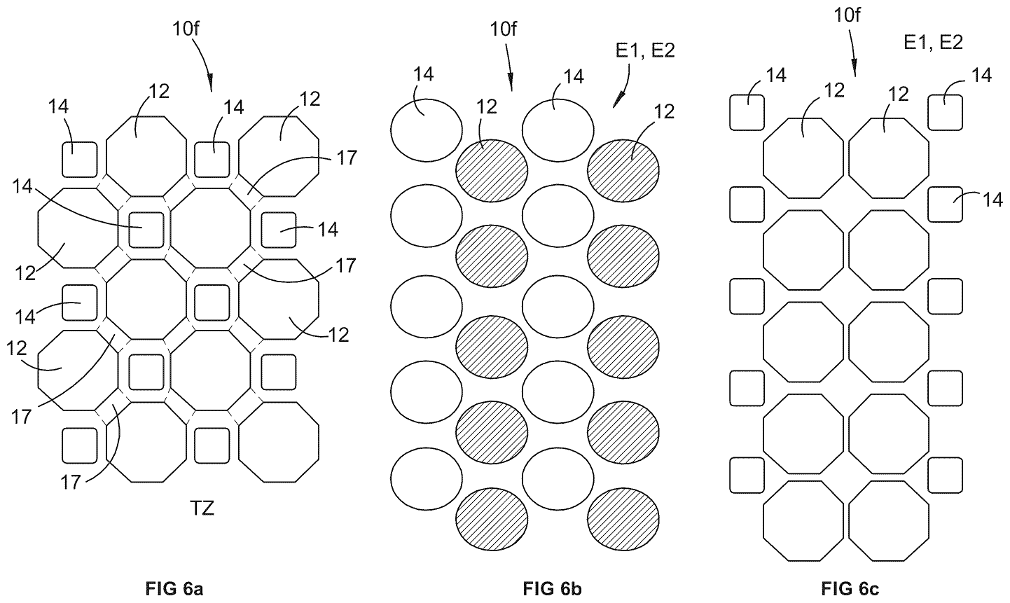

Additionally or alternately the above described embodiment of the heat exchanger 10c in FIGS. 4a and 4b may also be seen as one in which the cross sectional shape of the first or second or both channels 12, 14 progressively change in cross sectional shape from a shape having N sides (in this instance the ellipses at the end portions E may be considered as having an infinite number of sides) to a shape having M sides in the heat transfer zone Z (in this instance three sides for the equilateral triangles). Thus in a general sense the cross sectional shape changes from N sides to M sides where N≠M. A further example of such an embodiment is described later in this specification with reference to FIGS. 6a and 6b.

### Change in Spacing Between Sets of Channels

### Heat Exchanger 10d

A further mechanism by which the rate of exchange of heat can be varied by change in the configuration of sets of channels is by varying the spacing between sets of channels. This is illustrated in FIGS. 4d and 4e which depict an embodiment of a heat exchanger 10d in two spaced apart planes P1 and P2 respectively. The planes P1 and P2 are at the same relative locations in the exchanger 10d as shown in heat exchanger 10a of FIG. 1a and lie in the transition zone T1 and heat transfer zone TZ respectively.

FIG. 4d shows the first end portion of the channels 12 and 14 in a first configuration while FIG. 4d shows an intermediate portion of the channels 12 and 14 in a second configuration. As is readily apparent the difference between the first and second configurations is that the spacing or distance between different sets of channels 12 and 14 has changed. Specifically the spacing/distance between respective sets of channels 12 and 14 has decreased from the first end portions to the intermediate portions. The decrease in spacing is also accompanied by an interleaving of the respective different channels.

In FIG. 4d channels 12, 14 are arranged in respective alternating rows having centrelines C1-C4. The channel 14ba has a shared heat transfer length X with channel 12aa, a shared heat transfer length X with channel 12ab, and a shared heat transfer length Y with channel 12ca. Using the same nomenclature total first shared heat transfer length between the channels 12 and 14 in FIG. 4d is 14X+4Y. The configuration of the channels 12, 14 in FIG. 4d facilitates convenient connection to respective headers (not shown) of the heat exchanger 10d.

In FIG. 4e the distance or spacing between the centrelines C1-C4 has reduced in comparison to that in FIG. 4d. The channel 14ba has a shared heat transfer length Z with channel 12aa, a shared heat transfer length Z with channel 12ab, and a shared heat transfer length Y with channel 12ca. Using the same nomenclature total second shared heat transfer length between the channels 12 and 14 in FIG. 4e is 14Z+4Y.

As Z>X it necessarily follows that the second shared heat transfer length 14Z+4Y is different to and specifically greater than 14X+4Y. In addition to this increased heat transfer length between the two different configurations the actual distance or thickness of material in the heat exchanger between the channels different of different sets 12, 14 has reduced. This also leads to an increase in the heat transfer coefficient due to a decrease in thermal inertia.

To summarise in the above described embodiments of the heat exchanger 10a, 10b 10c and 10d (hereafter referred to collectively and in general as “heat exchanger 10”) the channels 12, 14 are reconfigured to change and in these examples increase the total shared heat exchange length between at least one of the transition zones T1 and T2 on the one hand and the heat transfer zone TZ on the other. In broad terms the reconfigurations may be described as follows:
For the heat exchanger 10a the reconfiguration is by way of rotating or twisting groups of channels in different sets C and H.
For the heat exchanger 10b the reconfiguration is by way of progressive relative linear translation or displacement of adjacent columns of channels 12, 14.
For the heat exchanger 10c the reconfiguration is by way of changing the cross sectional shape or profile of the channels 12, 14.
For the heat exchanger 10 the reconfiguration is by way of changing the spacing/distance between the channels 12, 14 which is also accompanied by a reduction in the wall thickness of material between the adjacent channels of different sets 12, 14.

### Channel Ratios

A large number of alternative embodiments of the heat exchanger are also possible. The alternative embodiments may include having a different ratio of channels in the sets C and H. For example at present for each of the above described embodiments the ratio channels in the sets C and H is 1:1. However this need not be the case. For example the ratio may vary to be, but not limited to, 2:1 or 3:1 or any other ratio. The possibility of changing the ratio of channels between the respective different sets place for each and every embodiment described in the specification.

### Heat Exchanger 10e

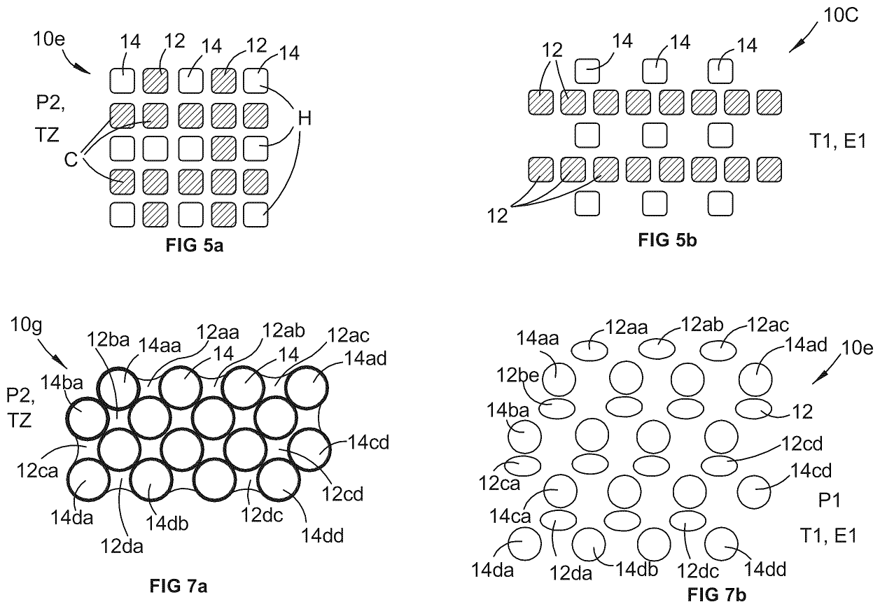

For example FIG. 5a shows a cross section through plane P2 in the heat transfer zone TZ of a heat exchanger 10e. FIG. 5b shows a cross-section through a plane P1 in the transition zone T1 the heat exchanger 10e This is a variation of the embodiment of the heat exchanger 10b (shown in FIG. 3) in which the number of channels 12 in the sets C is three times the number of channels 14 in the set H thereby providing a 3:1 ratio of channels in the different sets C and H.

### Different Channel Shapes in Different Sets of Channels

In each of the above described embodiments of the heat exchanger 10 the channels 12, 14 in the different sets C and H respectively are shown as having the same cross-sectional shape and cross-sectional area in successive transverse planes in the heat exchanger. However, embodiments are not limited in this manner and it is possible for the channels in the sets C and H to have different cross sectional shape and/or cross-sectional area.

### Heat Exchanger 10f

For example, FIGS. 6a and 6b illustrate intermediate and end portions respectively of different channels 12, 14 in a further embodiment of the disclosed heat exchanger 10f. In the heat exchanger 10f the fluid channels 12 of the have a cross-sectional area that is greater than that of the fluid channels 14 of in the primary heat transfer zone TZ. This is facilitated by the channels 12 and 14 having a different cross-sectional shape and configuration in the heat transfer zone as shown in FIG. 6a. However, at the end portions E1, E2 of these channels have the same shape and configuration, namely elliptical, as illustrated in FIG. 6b.

As with the previously described embodiments the channels 12 and 14 can be arranged in a first configuration similar to that shown in the embodiments of FIG. 1a, 2a, 3a or 4a to facilitate fluid coupling with manifolds MC and MH allowing fluid to flow into and out of the corresponding channels. Therefore in order for the channels 12, 14 to be reconfigured from the end portions E1, E2 to the intermediate portion, the channels 12, 14 will undergo a change in shape as well as a change in relative position.

The heat exchanger 10f is suited to applications in which the fluid in channels 14 is relatively clean and the fluid in channels 12 is comparatively dirty and hence the greater cross-sectional area for the fluid channels 12 allows the dirtier fluid to flow through the heat exchanger with less likelihood of clogging.

FIG. 6c shows an alternate configuration to that of FIG. 6b, for the end portions E1, E2 of the channels 12, 14. In this variation the shape of the channels 12, 14 at the end portions E1, E2 is a same as the shape of the channels in the heat transfer zone TZ. Accordingly in this variation of the heat exchanger 10f it is the relative position only of the channels 12, 14 changes from the end portions E1, E2 to the heat transfer zone TZ. This variation is somewhat akin to that described in relation to the heat exchanger 10d shown in FIGS. 4d and 4e.

Both variations of the heat exchanger 10f may be considered as representative of a more general embodiment of the heat exchanger in which the cross sectional shape of at least one of the sets of channels changes from the end portions which reside in the transition zones T1, T2 to the intermediate portion in the heat transfer zone TZ.

Optionally passages can be formed in the thickness of the material of the heat exchanger between channels in a particular set. Such passages most conveniently formed in the heat transfer zone TZ of a heat exchanger. FIG. 6a illustrates examples of the optional passages 17 formed between the channels 12. The channels 17 may assist in promoting equalised pressure and volumetric fluid flow through the channels 12. The existence of such passages 17 is not limited only to the configuration of channels 12, 14 in the heat exchanger shown in FIG. 6a. This may be applied to all of embodiments of disclosed in the specification.

### Heat Exchanger 10g

A further example of an embodiment of the heat exchanger 10g where the channels in the different sets C and H have different configuration is shown in FIGS. 7a and 7b. In this embodiment the channels 12 in the set C may carry a cold fluid while the channels 14 in the set H carry a hot fluid. The fluid channels 12 have convex walls while the fluid channels 14 have concave, and more particularly circular, walls.

This arrangement is suitable when the fluid in channels 12 is a high pressure fluid whilst the fluid in channels 14 is a low pressure fluid. The concave shape of the fluid channel walls helps to contain the high pressure fluid with a higher design temperature.

In the heat exchanger 10e, FIG. 7a illustrates the arrangement of channels 12, 14 in the primary heat transfer zone TZ in a plane P2. FIG. 7b illustrates the configuration of end portions E1 of the channels 12, 14 in the transition zone T1 through a plane P1 of the heat exchanger. From this can be seen that the reconfiguration of channels 12, 14 from the end portion E1 to the intermediate portion in the heat exchange zone TZ involves both a reconfiguration of the shape of channels 12 and a relative repositioning of the channels 12 and 14.

The use of concave walls, or other configurations of walls which do not have distinct or sharp corners may be useful where the fluid is “dirty” or contains suspended solid particles. This minimises the risk of accumulation of solids in the channels.

In other applications, the fluid channels can be arranged to have a cross-section which varies, e.g., widens to accept greater volumetric flows or narrows for slowing volumetric flow rates. In other applications, the wall thickness of one or both of the fluid channels 12 and 14 may be tapered gradually to provide optimal stiffness or improved stress distribution along the length of the fluid channels.

### End to End Change in Channel Cross Sectional Shape

### Heat Exchanger 10h

In the above described embodiments the heat exchangers 10 have transition zones T1 and T2 at opposite ends in which the configuration and/or cross sectional area of the end portions of the channels is the same. However this need not be the case. The configuration and/or cross sectional area of at least one of the sets of the channels at opposite ends may be different to each other.

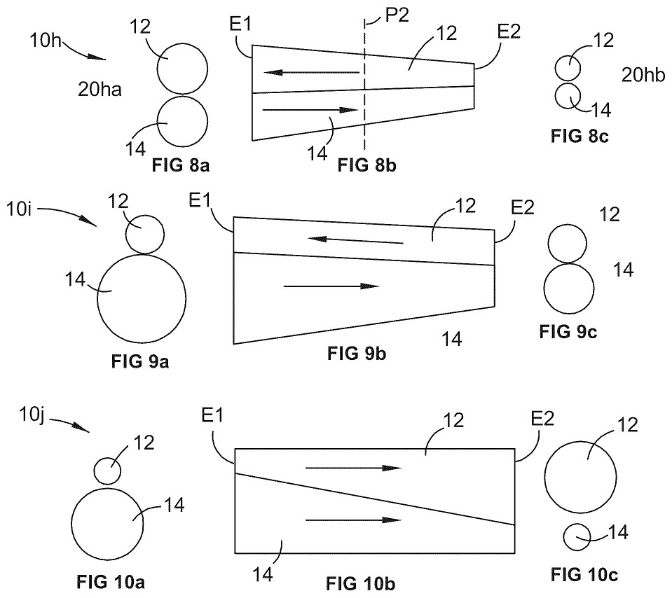

Examples of heat exchangers were at least one of the sets of channels has a cross-sectional area that is different at opposite ends of the heat exchanger are shown in FIGS. 8a-10c. In these exchangers at least one of the sets of channels has a continuously varying cross-sectional area from one end to another. Channels having a progressively increasing or decreasing cross-sectional area from end to end find use in accommodating or indeed promoting a change in phase of the fluid flowing through the corresponding channel. This may occur for example were a liquid refrigerant vaporises as it flows through the heat exchanger. The change in cross-sectional area also provides the ability to control flow rate and pressure drop across the heat exchanger.

FIGS. 8a-8c show a channel 12 and a channel 14 for a heat exchanger 10h in which the cross-sectional area of each of the channels 12 and 14 progressively changes along the length of that channel. FIG. 8a show a front view of the end portions E1 of channels 12 and 14 at one end of a heat exchanger 10h with FIG. 8b showing the front view of end portions E2 of the channels 12 and 14 at a second opposite end of the heat exchanger 10h. The end portions E1 of the channels 12 and 14 are arranged in a first configuration 20ha, while the end portions E2 are arranged in a second different configuration 20hb. The difference in the configuration is manifested by a reduction in the cross-sectional area or perimeter length of the channels 12, 14 from end portions E1 to end portions E2. This is readily apparent from FIG. 8c which shows the longitudinal section view of the channels 12, 14 from end portion E1 to end portion E2.

In this embodiment both of the channels 12 and 14 have a decrease in cross-sectional area from end portion E1 to end portion E2. One application of this arrangement would be for example in the liquefaction of LNG. In such an application natural gas is provided as the feed stream to the end E1 of channel 14, while a liquid refrigerant is provided as a feed stream at the end portion E2 of the channel 12. By virtue of the heat exchange between the gas and the refrigerant the gas cools and condenses to form a liquid or at least a mixed phase of gas and liquid at the end portion E2 of channel 14. This coincides with an increase in the pressure of the fluid was in the channel 14 as it flows from the end portion E1 to the end portion E2.

In contrast the refrigerant entering at end E2 as a liquid is vaporised by virtue of the heat exchange with the gas the channel 14. The vaporisation is promoted or assisted by the increase in cross-sectional area of the channel 12 in a direction of flow from end portion E2 to end portion E1. The increase in cross-sectional area in this direction of flow of the refrigerant facilitates a decrease in fluid pressure.

It should also be recognised that in the arrangement shown in the heat exchanger 10h the total first shared heat transfer length of mutually opposed perimeters of the adjacent end portions E1 of the different channels 12, 14 is different to the total second shared heat transfer length of the opposed perimeters of the channels 12, 14 in a plane P2 which is made through an intermediate portion of the channels 12, 14.

A difference between the configuration of the channels 12, 14 of the heat exchanger 10h in terms of the variation in the total shared heat transfer length along different transverse planes in comparison to earlier embodiments for example shown in heat exchangers 10a-10g, is that this variation in the heat exchanger 10h is in substance for the entire length of the channels from end portion E1 to end portion E2. In contrast in the heat exchangers 10a-10i the variation in the total heat transfer length is at a maximum in the intermediate portion of the channels and a minimum at each of the opposite ends portions E1, E2.

### Heat Exchanger 10i

FIGS. 9a-9c depict a heat exchanger 10i which is a variation of the heat exchanger 10h in that only one of the channels, in this instance channel 14, has a change in cross-sectional area from end portion E1 and E2 whereas the channel 12 has a constant cross-sectional area from end to end. The embodiment of the heat exchanger 10i application similar to that of the exchanger 10h, but where only one of the fluids undergoes a phase change. The fluid which is expected to undergo phase change during the transfer in the heat exchanger flow through the channel with varying cross-sectional area, in this case being channel 14.

One example of an application for this type of heat exchanger would be in a propane cooling circuit. Here propane vapour is provided as a feed stream to the end portion E1 of the channel 14, with cold water being provided as the feed stream at the end portion E2 of the channel 12. As a result of the heat transfer between the propane and the water the propane may partially or fully condense to a liquid phase at the relatively small diameter end portion E2 of the channel 14. While the water flowing through channel 12 has an increase in temperature this is not sufficient to cause it to vaporize. Thus the water maintains its liquid phase flowing from the end portion E2 to the end portion E1 and therefore there is no need to vary the cross-sectional area of the channel 12 to facilitate a change in phase.

In a similar manner to that described above in relation to the heat exchanger 10h there is also clearly a changing the total heat transfer length between the channels 12, 14 from one of the end portions E1, E2 to an intermediate portion, for example in plane P2, of the channels 12, 14.

### Heat Exchanger 10j

FIGS. 10a-10c show further possible arrangement for a heat exchanger 10j in which the channels 12, 14 of both sets of channels vary in cross sectional area or length from one end portion E1 to the opposite end portion E2. In the heat exchanger 10j the variation in cross-sectional area of the channels 12, 14 is complimentary from end portion E1 to end portion E2. That is, the cross-sectional area of channel 12 increases from end portion E1 to end portion E2 whereas the cross-sectional area of channel 14 decreases from an end portion E1 to end portion E2.

The heat exchanger 10j may find application again in situations where the fluid passing through the heat exchanger changes phase. The difference with respect to the heat exchanger 10h being that the fluid flow in the channels of the heat exchanger 10j is concurrent rather than counter current. Thus for example a natural gas feed stream may be provided as the input at end portion E1 of channel 14, while a phase changing refrigerant feed stream is provided as the input at an end portion E1 of the channel 12. Thus the flow of the natural gas and the refrigerant is in the same direction from one end of the heat exchanger to the other.

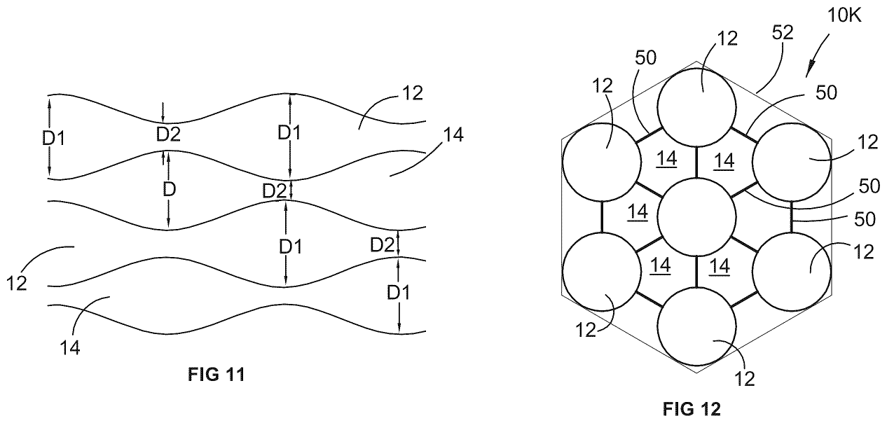

Another way of changing the cross sectional shape along the length of a channel is shown in FIG. 11, were a channel 12 or 14 (or of course both) may be formed so that its internal diameter cyclically varies along its length. If we assume that the channels 12, 14 are of a circular cross-section then the diameter D cyclically varies from maximum D1 to a minimum D2. This assists to break up the boundary layer effect of fluid flowing through the channels.

It should be noted that in these embodiments the relative juxtaposition of the channels 12, 14 does not change, or at least does not need to change, along the length of the heat exchanger as in the embodiments of the heat exchanger 10a, 10b and 10c. This may be seen as representing a different aspect of the disclosed heat exchanger which is independent of the need or desire to vary the total shared heat transfer length.

### Shell and Tube Heat Exchanger

### Heat Exchanger 10k

Referring back to the embodiment of the heat exchanger 10a shown in FIG. 1a the regions shown between the channels 12 and 14 may be completely filled with material so that the heat exchanger 10a is in effect a solid block of material. The solid material between the channels 12 and 14 may be seen as constituting shared walls of adjacent channels.

In an alternative embodiment however a plurality of fins or ribs may be provided to support the individual channels 12 and 14. The ribs or fins may together provide a further fluid flow path through which a third fluid may flow. This may be considered as a “shell flow path” for carrying a “shell fluid” which is passed into and out of the shell constituted by an outer peripheral wall of the heat exchanger 10a.

FIG. 12 shows a cross-section through a further embodiment of the heat exchanger 10k which comprises a plurality of channels 12 of circular cross-section from end to end joined together by a plurality of ribs or fins 50. The ribs/fins 50 are arranged in a pattern so as to define or form channels 14 between a group of fins and corresponding connected channels 12. By providing an outer wall or shell 52 about the channels 12 and 14 a shell and tube heat exchange has now been formed. Providing the shell 52 also results in the creation of additional channels 14a formed between the outer wall/shell 52 and the outer peripheral channels 12. Holes or slots may be formed in the ribs/fins 50 to facilitate flow of fluid between the channels 14 and 14a.

It should be noted that in the embodiment of the heat exchanger 10k shown in FIG. 12 the relative juxtaposition of the channels 12, 14 does not change, or at least does not need to change, along the length of the heat exchanger as in the embodiments of the heat exchanger 10a, 10b and 10c. This may be seen as representing a different aspect of the disclosed heat exchanger which is independent of the need or desire to vary the shared heat transfer length.

### Surface Finishing

The interior surface of the channels 12, 14 in the respective sets of channels C and H for each and every one of the embodiments of the heat exchangers 10a-10k described above and the heat exchangers 10L-10S described below may be provided with various surface finishes to achieve different effects and in particular enhance or improve the efficiency of heat exchange between fluids in the different channels.

For example, interior surface of the channels 12, 14 may be as smooth. However, in alternative embodiments the surface finish may be specifically designed to promote turbulence or otherwise interrupt or reduce the boundary effect of fluids flowing within the channels. Examples of this include providing the interior surface of either one or both of the channels 12, 14 with:
a prescribed surface roughness
raised dimples
grooves for example, but not limited to, spiral grooves similar to rifling in a barrel of a firearm
fins extending radially inward from the channel surfaces along the channels; the fins may be arranged in a spiral path similar to rifling, or may follow a wavelike path in a direction perpendicular to the radius, or indeed the fins may be provided with dimples or a prescribed roughness on their surface.

It should be noted that the provision of these types of surface finishes is independent of the relative juxtaposition of the channels 12, 14. That is, such surface finishes may be provided whether or not the juxtaposition of channels 12, 14 changes between any two points along the flow path in the heat exchanger.

This may be seen as representing a different aspect of the disclosed heat exchanger which is independent of the need or desire to vary the total shared heat transfer length. In broad terms in this aspect there is disclosed a heat exchanger comprising at least one fluid channel through which a fluid can flow the at least one fluid channel having an internal surface arranged to induce turbulence or interrupt or otherwise reduce the boundary effect of fluids flowing through the at least one fluid channel.

To achieve this effect the internal surface of the at least one channel may be one, or a combination of any two or more, of: (a) roughened; (b) provided with one or more grooves; (c) provided with one or more protruding ridges or rib; (d) provided with raised dimples; and (e) provided with one or more fins; to induce turbulence in a fluid when flowing through the at least one first channel.

As will be described in greater detail later these embodiments may be realised by use of an additive layer manufacturing process.

### Spiral/Helical Channel Paths

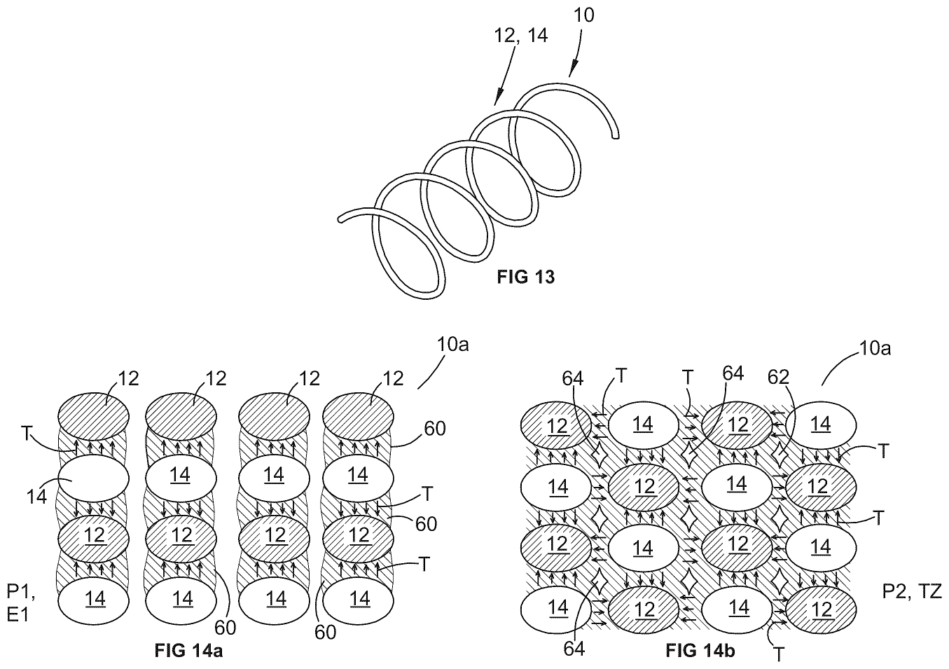

In further embodiments of the disclosed heat exchanger 10 the channels 12, 14 may be configured to follow a path that varies in three-dimensional space such as a helical path as shown in FIG. 13. In this example the channels 12, 14 have a constant cross-sectional shape and configuration but follow a helical or spiral path along the length of the heat exchanger. It is believed that such a path may be preferable over zigzag or serpentine paths in a common plane as such configurations are susceptible to the formation of dead zones at inflection points.

### Change of Heat Transfer Characteristics in Terms of Surface Area

In many of the above described embodiments the change of heat transfer characteristics of the heat exchangers is described in terms of changes in or variation of the shared heat transfer length between heat exchangers in different sets of heat exchangers. However this may also be described in terms of a change or variation in the wall surface area of the heat exchanger in a heat exchange path between channels in different sets of channels in planes perpendicular to the flow path. This is described for example with reference to FIGS. 14a and 14b. These Figures show a distribution of first and second channels in the heat exchanger identical to FIGS. 2a and 2d respectively. In describing the heat exchanger in relation to FIGS. 2a and 2d reference was made to the shared heat transfer length X and Y. This may be equivalently described in relation to the total surface area of material of the heat exchanger lying in a heat exchange path between channels of the first and second sets.

FIG. 14a shows distribution of first channels 12 second channels 14 in the plane P1 of the heat exchanger 10a shown in FIG. 1a. The arrows T show heat transfer paths from fluid flowing through the hot channels 14 to the cold channels 12. The heat is transferred through the solid material of the heat exchanger between the channels 12 and 14. The summation of the shaded areas 60 through which heat flows from the channels 14 to the channels 12 it constitutes the total surface area of material in the heat exchanger lying in the heat exchange path between the first and second sets of channels 12, 14 in the plane P1 which is a plane of the heat exchanger perpendicular to the first flow path constituted by the channels 12. This is independent of whether fluid is flowing into or out of the channels 12. It should be understood the plane P1 is of course also perpendicular to a second flow path constituted by the channels 14.

FIG. 14b shows the distribution of first channels 12 and second channels 14 in the plane P2 of the heat exchanger 10a. Here the channels 12 and 14 are rearranged so that there is a substantial increase surface area of material of the heat exchanger in the heat transfer paths T exist for transferring heat from the fluid in the channels 14 to the fluid in channels 12. The surface area is substantially the full surface area 62 (which is represented by the hashing in FIG. 14b) in the plane P2 of the heat exchanger 10a minus the area of the channels 12, 14 themselves and perhaps some small intermediate regions 64 where heat transfer may be minimal.

From a comparison between FIGS. 14a and 14b it becomes immediately apparent that in this and other embodiments of the disclosed heat exchanger the rearrangement or reorientation of the heat exchanger paths 12, 14 in the different sets C, H respectively enables a variation in the surface area of the material through each heat is transferred in two spaced apart planes of the heat exchanger perpendicular to the flow of fluid through the channels 12, 14.

Heat Exchanger with a Series of Fluid Channel Rotations

### Heat Exchanger 10L

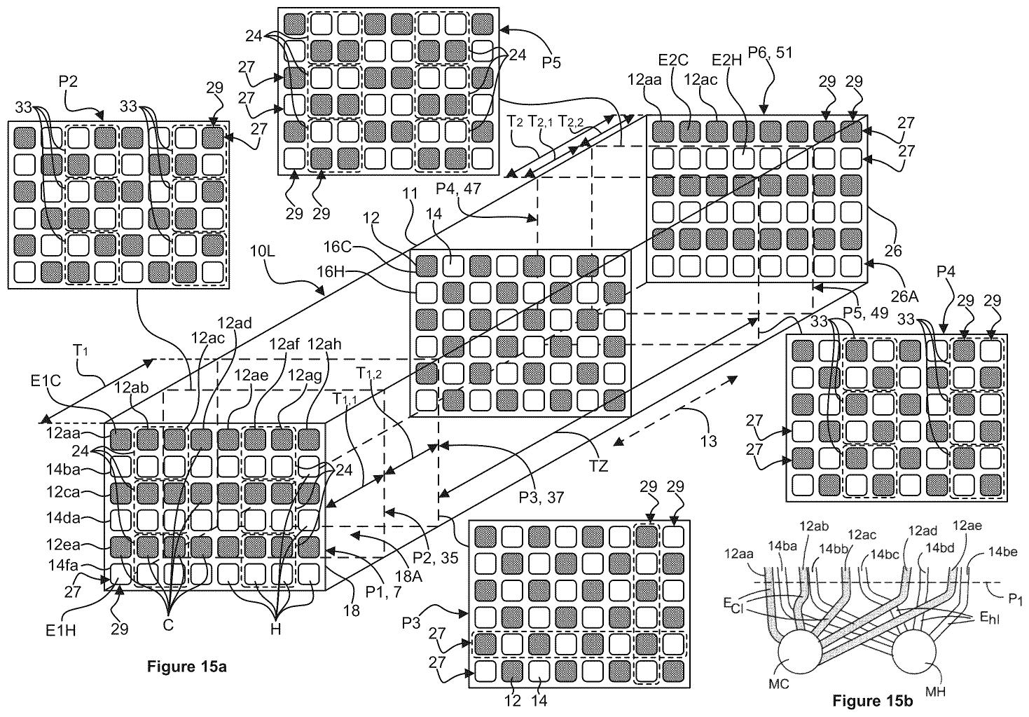

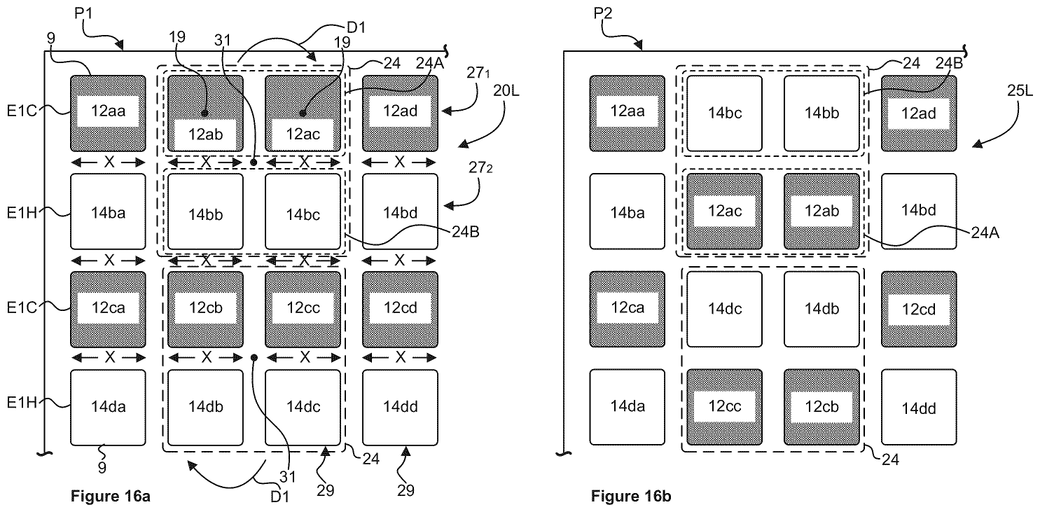

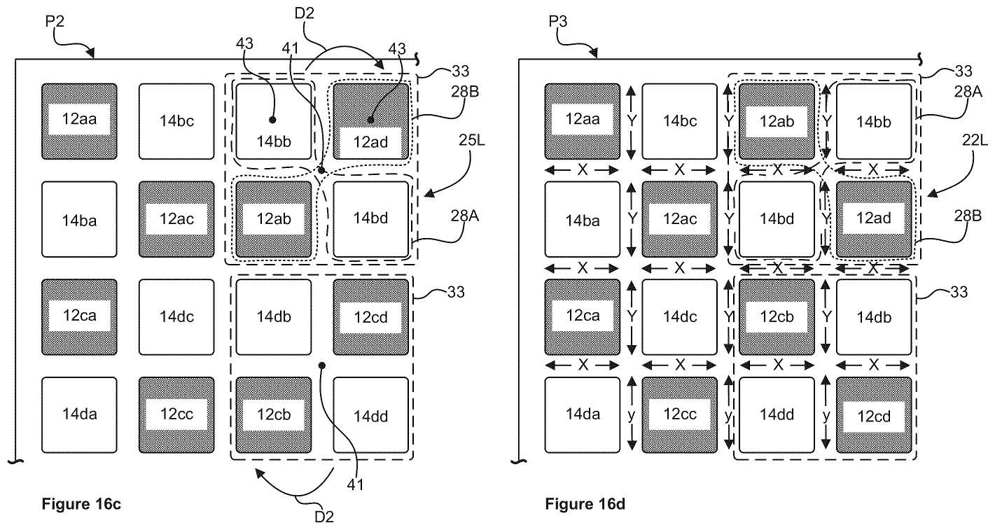

FIGS. 15a to 16d show another configuration of a heat exchanger 10L, according to some embodiments of the present disclosure. The heat exchanger 10L extends from a first end 18 to a second end 26. The heat exchanger 10L comprises a first end portion 18A. The first end portion 18A comprises the first end 18 of the heat exchanger 10L. The first end 18 may be considered a longitudinal end of the heat exchanger 10L. The heat exchanger 10L comprises a second end portion 26A. The second end portion 26A comprises the second end 26 of the heat exchanger 10L. The second end 26 may be considered a longitudinal end of the heat exchanger 10L.

The heat exchanger 10L comprises a body 11. The body 11 defines the first end 18 and the second end 26. The body 11 extends from the first end 18 of the heat exchanger 10L to the second end 26 of the heat exchanger 10L in a longitudinal direction 13 of the heat exchanger 10L.

The heat exchanger 10L comprises a plurality of fluid channels 12, 14. The fluid channels 12, 14 extend from the first end 18 of the heat exchanger 10L to the second end 26 of the heat exchanger 10L. In other words, the fluid channels 12, 14 extend along the longitudinal length of the heat exchanger 10L. One or more of the fluid channels 12, 14 of the heat exchanger 10L undergo a number of rotations or twists along their length. Specifically, a number of the fluid channels 12, 14 of the heat exchanger 10L undergo a series of rotations or twists along their length.

The fluid channels 12, 14 are in the form of channels in the body 11. One or more of the fluid channels 12, 14 defines a fluid flow path through the heat exchanger 10L. One or more of the fluid flow paths may extend from the first end 18 of the heat exchanger 10L to the second end 26 of the heat exchanger. In the illustrated embodiment, each fluid channel 12, 14 defines a fluid flow path through the heat exchanger 10L that extends from the first end 18 of the heat exchanger 10L to the second end 26 of the heat exchanger 10L. Each fluid channel 12, 14 defines a fluid channel surface 9 (see FIG. 16a). The fluid channel surface 9 may be considered an internal surface of the respective fluid channel 12, 14. The fluid channel surface 9 may be defined by the body 11.

In some embodiments, each fluid channel 12, 14 has a constant cross sectional shape between the first end 18 of the heat exchanger 10L and the second end 26 of the heat exchanger 10L. The cross-sectional shape may be viewed perpendicularly to a direction of fluid flow through the heat exchanger 10L, as described herein. The cross-sectional shape may be viewed perpendicularly to the longitudinal direction 13.

The cross sectional shape of one or more of the fluid channels 12, 14, at one or more points along the length of the heat exchanger 10L, is a rounded rectangle. In the embodiment illustrated in FIGS. 15a to 16d, the cross-sectional shape of each fluid channel 12, 14 is a rounded rectangle along the entire length of the heat exchanger 10L.

It will be appreciated, however, that in some embodiments, the cross-sectional shape of one or more of the fluid channels 12, 14 may be a different shape at one or more points along the length of the heat exchanger 10L. For example, the cross sectional shape of one or more of the fluid channels 12, 14 may be a circle, an ellipse, a polygon and/or a rounded polygon at one or more points along the length of the heat exchanger 10L. In some embodiments, the cross sectional shape of one or more of the fluid channels 12, 14 at the first end 18 and/or the second end 26 of the heat exchanger is circular. In some embodiments, the cross sectional shape of one or more of the fluid channels 12, 14 at the first end 18 and/or the second end 26 of the heat exchanger is triangular. In some embodiments, the cross sectional shape of one or more of the fluid channels 12, 14 changes along the length of the heat exchanger. For example, the cross-sectional shape of one or more of the fluid channels 12, 14 may change from generally circular to generally octagonal along the length of the heat exchanger 10L.

In some embodiments, the internal surface 9 of one or more of the fluid channels 12, 14 is arranged to induce turbulence in fluid flowing through the respective fluid channels 12, 14. To achieve this effect, the internal surface 9 of the respective channels 12, 14 may be one, or a combination of any two or more, of: (a) roughened; (b) provided with one or more grooves; (c) provided with one or more protruding ridges or rib; (d) provided with raised dimples; and (e) provided with one or more fins; to induce turbulence in a fluid when flowing through the at least one fluid channel 12, 14.

The heat exchanger 10L comprises a first transition zone T1. The first transition zone T1 is disposed at or near the first end 18 of the heat exchanger 10L. In some embodiments, the first transition zone T1 may be said to comprise the first end 18 of the heat exchanger 10L. The first transition zone T1 extends along a length of the heat exchanger 10L. In some embodiments, the first end portion 18A of the heat exchanger 10L is the first transition zone T1. One or more of the fluid channels 12, 14 extends through the first transition zone T1. In the illustrated embodiment, each fluid channel 12, 14 extends through the first transition zone T1.

The configuration of the fluid channels 12, 14 changes through at least part of the first transition zone T1. A position of one or more of the fluid channels 12, 14 changes with respect to a position of another one or more of the fluid channels 12, 14 through at least part of the first transition zone T1. A shape of one or more of the fluid channels 12, 14 may change across at least part of the first transition zone T1. Therefore, the change in configuration of the fluid channels 12, 14 across the first transition zone T1 may comprise one or both of a change in relative position of one or more fluid channels 12, 14 and a change in shape of one or more fluid channels 12, 14.

The heat exchanger 10L comprises a heat transfer zone TZ. The heat transfer zone TZ may be referred to as an intermediate zone of the heat exchanger 10L. The heat transfer zone TZ extends along a length of the heat exchanger 10L. One or more of the fluid channels 12, 14 extends through the heat transfer zone TZ. In the illustrated embodiment, each fluid channel 12, 14 extends through the heat transfer zone TZ. The heat transfer zone TZ is adjacent to the first transition zone T1.

The heat exchanger 10L comprises a second transition zone T2. The second transition zone T2 is disposed at or near the second end 26 of the heat exchanger 10L. In some embodiments, the second transition zone T2 may be said to comprise the second end 26 of the heat exchanger 10L. The second transition zone T2 extends along a length of the heat exchanger 10L. In some embodiments, the second end portion 26A is the second transition zone T2. One or more of the fluid channels 12, 14 extends through the second transition zone T2. In the illustrated embodiment, each fluid channel 12, 14 extends through the second transition zone T2. In the illustrated embodiment, each fluid channel 12, 14 extends through the first transition zone T1, the heat transfer zone TZ and the second transition zone T2. The heat transfer zone TZ is between the first transition zone T1 and the second transition zone T2.

The configuration of the fluid channels 12, 14 changes through at least part of the second transition zone T2. A position of one or more of the fluid channels 12, 14 changes with respect to a position of another one or more of the fluid channels 12, 14 through at least part of the second transition zone T2. A shape of one or more of the fluid channels 12, 14 may change across at least part of the second transition zone T2. The heat transfer zone TZ is adjacent to the second transition zone T2. In particular, the heat transfer zone TZ is between the first transition zone T2 and the second transition zone T2.

The heat exchanger 10L comprises a plurality of sets C, H of fluid channels 12, 14. Each set C, H comprises a plurality of respective fluid channels 12, 14. In the illustrated embodiment, there are two sets C, H of fluid channels 12, 14. That is, the heat exchanger 10L comprises a first set C of fluid channels 12. The first set C of fluid channels 12 comprises a plurality of fluid channels 12. That is, the fluid channels referred to with the reference numeral “12” in FIGS. 15a to 16d form at least part of the first set C. The heat exchanger 10L comprises a second set H of fluid channels 14. The second set H of fluid channels 14 comprises a plurality of fluid channels 14. That is, the fluid channels referred to with the reference numeral “14” in FIGS. 15a to 16d form at least part of the second set H.

For convenience, the first set C of fluid channels 12 may be considered as a set of fluid channels 12 configured to enable the flow of a cold fluid. The second set H of fluid channels 14 may be considered as a set of fluid channels 14 configured to enable the flow of a hot fluid. It will be appreciated however, that in some embodiments this may be reversed.

In FIGS. 15a to 16d, the fluid channels 12 of the first set C are shown as shaded channels and the fluid channels 14 of the second set H are shown as white channels. In other words, the fluid channels 12 configured to enable the flow of a cold fluid are shown as shaded channels and the fluid channels 14 configured to enable the flow of a hot fluid are shown as white channels.

The fluid channels 12, 14 are aligned into a number of rows 27 and a number of columns 29 at one or more points along the length of the heat exchanger 10L. FIG. 15a illustrates a number of notional planes P1, P2, P3, P4, P5, P6 along the heat exchanger 10L at which the fluid channels 12, 14 are aligned into rows 27 and columns 29.

In this embodiment, and throughout the other heat exchanger embodiments of this description. when fluid channels are aligned into rows, the fluid channels of a particular row are aligned in a first direction. In a number of the illustrated embodiments, the fluid channels 12, 14 of each row 27 are aligned in a horizontal direction. It will, however, be appreciated that the fluid channels of a row of fluid channels may be aligned in a direction other than the horizontal direction. That is, the fluid channels of a particular row may be diagonally aligned fluid channels. That is, they may be aligned in a direction that is transverse to the horizontal direction. For example, referring to FIG. 15a, diagonally aligned fluid channels 12, 14 as shown in plane P4 may be considered to be rows of fluid channels 12, 14. Throughout this description, a row of fluid channels may be referred to as a plane of fluid channels. That is, the fluid channels of a particular row of fluid channels may be said to be intersected by a common plane. In other words, the fluid channels of a particular row of fluid channels may be said to be co-linear at a respective point along their length.

When aligned into columns 29, the fluid channels 12, 14 of a particular column 29 are aligned in a second direction. The second direction is orthogonal to the first direction. In the illustrated embodiment, the fluid channels 12, 14 of each column 29 are aligned in a vertical direction. Throughout this description, column of fluid channels may be referred to as a plane of fluid channels. That is, the fluid channels of a particular column of fluid channels may be said to be intersected by a common plane. In other words, the fluid channels of a particular column of fluid channels may be said to be co-linear at a respective point along their length.

Each of the fluid channels 12 of the first set C has a respective first end portion E1C. Each of the fluid channels 12 of the first set C has a respective second end portion E2C. Each of the fluid channels 14 of the second set H has a respective first end portion E1H. Each of the fluid channels 14 of the second set H has a respective second end portion E2H. Hereinafter, the first end portions E1C, E1H and the second end portions E2C, E2H may be collectively, and in general, referred to as “first end portions E1” and “second end portions E2” respectively. Further, for ease of description, the end portions in a general sense, whether they be the first end portions or the second end portions, may be referred to hereafter as “end portions E”.

The first end portions E1 extend from the first end 18 of the heat exchanger 10L, along a first portion of the length of the heat exchanger 10L, towards the second end 26 of the heat exchanger 10L. The first end portion E1 of each fluid channel 12, 14 extends through at least part of the first transition zone T1. In some embodiments, the first end portion E1 of each fluid channel 12, 14 is the portion of the fluid channel 12, 14 that extends through the first transition zone T1. That is, the portion of a respective fluid channel 12, 14 that is within the first transition zone T1 may be considered the first end portion E1 of that fluid channel 12, 14.

In some embodiments, a respective end of one of the fluid channels 12, 14 may be considered the end portion E1 of that fluid channel 12, 14. That is, the point of a respective fluid channel 12, 14 that is at the first end 18 of the heat exchanger 10L may be considered the first end portion E1 of that fluid channel 12, 14.

The second end portions E2 extend from the second end 26 of the heat exchanger 10L, along a second portion of the length of the heat exchanger 10L, towards the first end 18 of the heat exchanger 10L. The second end portion E2 of each fluid channel 12, 14 extends through at least part of the second transition zone T2. In some embodiments, the second end portion E2 of each fluid channel 12, 14 is the portion of the fluid channel 12, 14 that extends through the second transition zone T2. That is, the portion of a respective fluid channel 12, 14 that is within the second transition zone T2 may be considered the second end portion E2 of that fluid channel 12, 14.

In some embodiments, a respective end of one of the fluid channels 12, 14 may be considered the end portion E2 of that fluid channel 12, 14. That is, the point of a respective fluid channel 12, 14 that is at the second end 26 of the heat exchanger 10L may be considered the first end portion E1 of that fluid channel 12, 14.

In between the end portions E, each channel 12, 14 has an intermediate portion 16C, 16H respectively. That is, the fluid channels 12 of the first set C have respective intermediate portions 16C. Similarly, the fluid channels 14 of the second set H have respective intermediate portions 16H. Hereinafter, the intermediate portions 16C, 16H may be referred to collectively, and in general, as “intermediate portions 16”.

The intermediate portion 16 of each fluid channel 12, 14 bridges the first end portion E1 and the second end portion E2 of that fluid channel 12, 14. That is, the intermediate portion 16 of a fluid channel 12, 14 extends from an inner end of the first end portion E1 of that fluid channel 12, 14 to an inner end of the second end portion E2 of that fluid channel 12, 14. The intermediate portion 16 of each fluid channel 12, 14 extends through at least part of the heat transfer zone TZ. In some embodiments, the intermediate portion 16C, 16H of each fluid channel 12, 14 is the portion of the fluid channel 12, 14 that extends through the heat transfer zone TZ.

The first end portions E1C of the fluid channels 12 of the first set C are connected to and are in fluid communication with a manifold MC (see FIG. 15b). The manifold MC is configured to enable the flow of fluid into and/or out of the fluid channels 12 of the first set C. The first end portions E1H of the fluid channels 14 of the second set H are connected to and are in fluid communication with a manifold MH (see FIG. 15B). The manifold MH is configured to enable the flow of fluid into and/or out of the fluid channels 14 of the second set H. It will be appreciated that in some embodiments, the manifold MC and the manifold MH may be combined into a single manifold that is configured to enable the flow of two fluids (i.e. hot fluid and the cold fluid) into and/or out of the first end portions E1 of the fluid channels 12, 14.

While not shown in the Figures, it will be appreciated that the second end portions E2C of the fluid channels 12 of the first set C are connected to and are in fluid communication with another manifold MC2. This manifold MC2, which may be referred to as a second manifold MC2, is configured to enable the flow of fluid into and/or out of the fluid channels 12 of the first set C. Further, the second end portions E2H of the fluid channels 14 of the second set H are connected to and are in fluid communication with another manifold MH2. This manifold MH2, which may be referred to as a second manifold MH2, is configured to enable the flow of fluid into and/or out of the fluid channels 14 of the second set H.

The first end portions E1, in a first plane P1 that is at a first point 7 along the length of the heat exchanger 10L, have a first configuration 20L as shown in FIG. 16A. In the illustrated embodiment, the first point 7 is the first end 18 of the heat exchanger 10L. The first plane P1 is perpendicular to a direction of flow of fluid through the heat exchanger 10L. The first plane P1 intersects outer ends of the first end portions E1. The first plane P1 maps to the first end 18 of the heat exchanger 10L. The first plane P1 is orthogonal to the longitudinal direction 13. It will be appreciated that where a configuration of fluid channels 12, 14 is described with reference to a respective plane, that configuration of fluid channels 12, 14 occurs at the point along the length of the heat exchanger 10L at which the plane is taken and/or disposed.

On the first plane P1, the fluid channels 12, 14 are arranged in a number of rows 27 and a number of columns 29. That is, at the first end 18 of the heat exchanger 10L, the fluid channels 12, 14 are arranged in a number of rows 27 and a number of columns 29. In particular, on the first plane P1, and therefore at the first end 18 of the heat exchanger 10L, the fluid channels 12, 14 are arranged in alternating rows 27 of fluid channels 12, 14 of the first set C and the second set H. The rows 27 of fluid channels 12, 14 on the first plane P1 alternate between rows 27 of the first set C of fluid channels 12 and rows 27 of the second set H of fluid channels 14. Therefore, at least part of the first end portions E1 of the fluid channels 12, 14 are arranged in alternating rows 27 of fluid channels 12, 14. Each row 27 of fluid channels 12, 14 comprises only fluid channels 12, 14 from the first set C of fluid channels 12 or only fluid channels 14 from the second set H of fluid channels 14.

In the illustrated embodiment, the number of rows 27 on the first plane P1 is different to the number of columns 29. Specifically, the number of rows 27 is greater than the number of columns 29 on the first plane P1. It will be appreciated. However, that in some embodiments, the number of rows 27 on the first plane P1 (i.e. at the first end 18) may be less than the number of columns 29. Alternatively, the number of rows 27 may be equal to the number of columns 29 on the first plane P1. In some embodiments, the number of columns 29 on the first plane P1 is double the number of rows 27 on the first plane P1. In some embodiments, the number of rows 27 on the first plane P1 is double the number of columns 29 on the first plane P1.

Referring to FIG. 16a, it will be noted that in this configuration 20L, adjacent channels 12, 14 of different sets H and C have a shared heat transfer length X. This is, in effect, the shared boundary or perimeter length between the walls of adjacent channels 12, 14 in the different sets C, H. Thus, looking at FIG. 16a, the channels 12aa and 14ba have a shared heat transfer length X; as do channels 12ab and 14bb; 12ac and 14bc; 12ad and 14bd; 14ba and 12ca, etc. So, in the illustrated example subset of channels 12, 14 shown at plane P1, there is a total first shared heat transfer length of 12X being the summation of the length of mutually opposed perimeters of the adjacent end portions of the different sets C and H.

In FIGS. 15a to 16d, the individual fluid channels 12 in the set C are denoted as fluid channels 12ij where ij denote matrix positions which are referenced by letters a z. That is, i and j are indicative of a row 27 and column 29 at which the respective fluid channel 12ij is located in the first plane P1. In FIG. 15a, at the top left-hand corner of the heat exchanger 10L when viewing plane P1, there is a channel 12aa, and at a right hand end of the same row 27, there is a channel 12ah. However, collectively and in general, the channels 12ij are referred to herein as fluid channels “12”.

The individual fluid channels 14 in the set H are denoted as fluid channels 14ij where ij denote matrix positions where are referenced by letters a-z. That is, i and j are indicative of a row 27 and column 29 at which the respective fluid channel 14ij is located in plane P1. In FIG. 15a near the top left hand corner there is a channel 14ba and at a right hand end of the same row 27 there is a channel 14be. However, collectively and in general, the channels 14ij are hereinafter referred to as channels “14”.

FIGS. 16b and 16c show another section of the heat exchanger 10L, in a second plane P2. In particular, FIGS. 16b and 16c show another section of the first end portions E1, in the second plane P2. The second plane P2 is perpendicular to the direction of flow of fluid through the heat exchanger 10L. The second plane P2 is orthogonal to the longitudinal direction 13. The second plane P2 is parallel to the first plane P1. The second plane P2 is longitudinally displaced with respect to the first plane P1. In particular, the second plane P2 is between the first plane P1 and the second end portions E2 of the fluid channels 12, 14. The second plane P2 is at an intermediate point 35 along the length of the heat exchanger 10L. The intermediate point 35 is between the first end 18 and the second end 26. In particular, the intermediate point 35 is within the first transition zone T1.

The fluid channels 12, 14 are in a second configuration 25L when viewed at the second plane P2. In other words, the fluid channels 12, 14 are in the second configuration 25L at the intermediate point 35 along the length of the heat exchanger 10L. The second configuration 25L is different to the first configuration 20L. That is, the configuration of the fluid channels 12, 14 has changed between the point 7 of the heat exchanger 10L corresponding to the first plane P1 and the point 35 of the heat exchanger 10L corresponding to the second plane P2.

In order to reconfigure the pattern of the fluid channels 12, 14 from the first configuration 20L to the second configuration 25L, one or more group 24 of fluid channels 12, 14 is formed or selected. Each group 24 of fluid channels 12, 14 may be referred to respectively as a first group 24 of fluid channels 12, 14. The one or more group 24 of fluid channels 12, 14 is selected at the outer end of the first end portions E1 of the fluid channels 12, 14. That is, the one or more first group 24 of fluid channels 12, 14 is selected at the first end 18 of the heat exchanger 10L. The fluid channels 12, 14 are arranged in rows 27 and columns 29 at the point at which the first group 24 is formed or selected.

Referring to FIG. 16a, each first group 24 of fluid channels 12, 14 comprises a first subset 24A of the first set C of fluid channels 12. Each first group 24 of fluid channels 12, 14 comprises a first subset 24B of the second set H of fluid channels 14. The first subset 24A of the first set C of fluid channels 12 comprises only fluid channels 12 of one row 27 of the first set C of fluid channels 12. In particular, the first subset 24A of the first set C of fluid channels 12 comprises only fluid channels 12 of a first row 271 of fluid channels 12, at the first point 7 of the heat exchanger 10L. The first subset 24B of the second set H of fluid channels 14 comprises only fluid channels 14 of one row 27 of the second set H of fluid channels 14. In particular, the first subset 24B of the second set H of fluid channels 14 comprises only fluid channels of a second row 272 of fluid channels 14, at the first point 7 of the heat exchanger 10L.

The row 27 of fluid channels 12 at the first point 7 along the length of the heat exchanger 10L from which the first subset 24A of the first set C of fluid channels 12 is selected is adjacent to the row 27 of fluid channels 14 from which the first subset 24B of the second set H of fluid channels 14 is selected. In other words, the first row 271 is adjacent to the second row 272. Therefore, the first group 24 of fluid channels 12, 14 comprises only fluid channels from the first row 271 of fluid channels 12 and fluid channels from the second row 272 of fluid channels 14.

In the embodiment of FIGS. 15a to 16b, each first group 24 of fluid channels 12, 14 comprises four fluid channels 12, 14. Each first group 24 of fluid channels 12, 14 comprises two fluid channels 12 of the first set C of fluid channels 12. Each first group 24 of fluid channels 12, 14 comprises two fluid channels 14 of the second set H of fluid channels 14. In other words, each first group 24 of fluid channels 12, 14 has at least two fluid channels 12, 14 from mutually different sets C and H. For example, FIG. 16a shows two first groups 24 of reconfiguring channels 12, 14. These first groups 24 comprise channels 12ab, 14bb, 12ac and 14bc; and 12cb, 14db, 12cc and 14dc respectively.

In this embodiment, each of the first groups 24 of fluid channels 12, 14 are directed through progressive rotation or twisting about a respective first axis 31. This may be referred to as a first rotation. The first axis 31 is parallel to the direction of flow of fluid through the channels 12, 14. In other words, the first axis 31 extends parallel to the longitudinal direction 13 of the heat exchanger 10L. The progressive rotation is illustrated in the sequence of FIGS. 16a to 16b, where the first groups 24 are rotated about respective first axes 31 in a clockwise direction shown by arrow D1, as the respective fluid channels 12, 14 extend away from the first end 18. Each first group 24 is rotated about the respective first axis 31 by a first angle of rotation. In the illustrated embodiment, the first angle of rotation is 180°. That is, each first group 24 of fluid channels 12, 14 is rotated about the first axis 31 by an angle of 180° as the respective fluid channels 12, 14 extend away from the first end 18. Applying the first rotation to the first groups 24 of fluid channels 12, 14 changes the configuration of the fluid channels 12, 14 from the first configuration 20L at the first point 7 to the second configuration 25L at the intermediate point 35.

The reconfiguration of the channels 12, 14 from the first configuration 20L to second configuration 25L occurs over a first length T1,1 of the first transition zone T1. In other words, each of the first groups 24 of fluid channels 12, 14 rotate, about their respective first axis 31, along the first length T1,1 of the first transition zone T1.

Each fluid channel 12, 14 of the first group 24 of fluid channels 12, 14 comprises a respective cross sectional midpoint 19. The cross sectional midpoint 19 may be considered a centroid of the respective fluid channel 12, 14 at a point along its length. The first axis 31 of a respective first group 24 of fluid channels 12, 14 is equidistant from the cross sectional midpoint 19 of each fluid channel 12, 14 of that first group 24 along the first length T1,1 of the first transition zone T1. That is, the distance between the first axis 31 of a respective first group 24 of fluid channels 12, 14 and the cross sectional midpoint 19 of each of the fluid channels 12, 14 of that first group 24 is equal. This distance remains equal throughout the rotation of the first group 24 of fluid channels 12, 14. In some embodiments, the distance between the first axis 31 of a respective first group 24 of fluid channels 12, 14 and the cross sectional midpoint 19 of one or more of the fluid channels 12, 14 of that first group 24 may be different to the distance between the first axis 31 and the cross sectional midpoint 19 of another fluid channel 12, 14 of that first group 24, along at least part of the first transition zone T1.

FIG. 16d shows another section of the heat exchanger 10L, in a third plane P3. The third plane P3 is taken at a boundary of the first end portions E1 of the fluid channels 12, 14 and the intermediate portions 16C, 16H of the fluid channels 12, 14. Therefore, the configuration of fluid channels 12, 16 shown in FIG. 16d reflects both the configuration of fluid channels 12, 14 at an inner end of the first end portions E1 and an outer end of the intermediate portions 16C, H. The third plane P3 is taken at the inner end of the first transition zone T1. The third plane P3 is taken at an outer end of the heat transfer zone TZ. That is, the third plane P3 is taken at the boundary between the first transition zone T1 and the heat transfer zone TZ. This point may be considered a second intermediate point 37 of the heat exchanger 10L.

The third plane P3 is perpendicular to the direction of fluid flow through the heat exchanger 10L. The third plane P3 is orthogonal to the longitudinal direction 13. The third plane P3 is parallel to the first plane P1 and the second plane P2. The third plane P3 is longitudinally displaced with respect to the first plane P1 and the second plane P2. In particular, the third plane P3 is between the second plane P2 and the second end portions E2 of the fluid channels 12, 14. In other words, the second intermediate point 37 of the heat exchanger 10L is between the first intermediate point 35 and the second end 26 of the heat exchanger 10L.

The fluid channels 12, 14 are in a third configuration 22L when viewed at the third plane P3. In other words, the fluid channels 12, 14 are in the third configuration 22L at the second intermediate point 37 of the heat exchanger 10L. The third configuration 22L is different to the first configuration 20L. The third configuration 22L is different to the second configuration 25L. That is, the configuration of the fluid channels 12, 14 has changed between the point of the heat exchanger 10L corresponding to the second plane P2 and the point of the heat exchanger 10L corresponding to the third plane P3. The third configuration 22L may be referred to as a heat transfer configuration.

In order to reconfigure the pattern of the fluid channels 12, 14 from the second configuration 25L to the third configuration 22L, one or more group 33 of fluid channels 12, 14 is formed or selected. Each group 33 of fluid channels 12, 14 may be referred to respectively as a second group 33 of fluid channels 12, 14.

The one or more second group 33 of fluid channels 12, 14 is selected at the intermediate point 35 along the length of the heat exchanger 10L. The plane P2 is taken at this intermediate point 35. The intermediate point 35 is an intermediate point of the first end portion 18A. In other words, the intermediate point 35 is an intermediate point of the first transition zone T1. The intermediate point 35 corresponds to an inner end of the first length T1,1. That is, the intermediate point 35 is a point positioned after the rotation of the one or more first groups 24 of fluid channels 12, 14 is complete. The fluid channels 12, 14 are again arranged in rows 27 and columns 29 at the intermediate point 35 at which the second groups 33 are formed or selected.

Referring to FIGS. 16c and 16d, each second group 33 of fluid channels 12, 14 comprises a second subset 28A of the first set C of fluid channels 12. Each second group 33 of fluid channels 12, 14 comprises a second subset 28B of the second set H of fluid channels 14. The second subset 28A of the first set C of fluid channels 12 comprises at least one fluid channel 12, 14 of the first subset 24A of the first set C of fluid channels 12. The second subset 28B of the second set H of fluid channels 14 comprises at least one fluid channel 12, 14 of the first subset 24B of the second set H of fluid channels 14.

The second subset 28A of the first set C of fluid channels 12 comprises only fluid channels 12 of the first row 271 of fluid channels 12 at the first plane P1. That is, the second subset 28A of the first set C of fluid channels 12 comprises only fluid channels 12 of one row of the fluid channels 12 at their outer ends (i.e. at the first end 18 of the heat exchanger 10L). In other words, the second subset 28A of the first set C of fluid channels 12 comprises only fluid channels of one row of fluid channels 12 at the first point 7 of the heat exchanger 10L.

The second subset 28B of the second set H of fluid channels 14 comprises only fluid channels 14 of the second row 272 of the second set H of fluid channels 14. That is, the second subset 28B of the second set H of fluid channels 14 comprises only fluid channels of one row of the fluid channels 14 at their outer ends (i.e. at the first end 18 of the heat exchanger 10L). In other words, the second subset 28B of the second set H of fluid channels 12 comprises only fluid channels 14 of one row of fluid channels 14 at the first point 7 of the heat exchanger 10L. The row of fluid channels 12 from which the second subset 28A of the first set C of fluid channels 12 is selected is adjacent to the row of fluid channels 14 from which the second subset 28B of the second set H of fluid channels 14 is selected.

In the illustrated embodiment, one example second subset 28A of the first set C of fluid channels 12 comprises fluid channels 12ad and 12ab. It is noted that both of these fluid channels 12 were aligned in the same row 27 at the first point 7 (shown at plane P1). One example second subset 28B of the second set H of fluid channels 14 comprises fluid channels 14bb and 14bd. It is noted that both of these fluid channels 14 were aligned in the same row at the first point 7 (shown at plane P1). This example second group 33 comprises only fluid channels 12, 14 from the first row 271 of fluid channels 12 and fluid channels from the second row 272 of fluid channels 14 at the first point 7 of the heat exchanger 10L. That is, this example second group 33 comprises only fluid channels from the first row 271 of fluid channels 12 at the first end 18 of the heat exchanger 10L and fluid channels from the second row 272 of fluid channels 14 at the first end 18 of the heat exchanger 10L.

Each second group 33 of fluid channels 12, 14 comprises at least two fluid channels 12 of the first set C of fluid channels 12. In the illustrated embodiment, each second group 33 of fluid channels 12, 14 comprises two fluid channels 12 of the first set C of fluid channels 12. Each second group 33 of fluid channels 12, 14 comprises at least two fluid channels 14 of the second set H of fluid channels 14. In the illustrated embodiment, each second group 33 of fluid channels 12, 14 comprises two fluid channels 12 of the second set H of fluid channels 12. In other words, each second group 33 of fluid channels 12, 14 has at least two fluid channels 12, 14 from mutually different sets C and H. For example, FIG. 16c shows two second groups 33 of reconfiguring channels 12, 14. These second groups 33 comprise channels 14bc, 14bb, 12ac and 12ab; and 14dc, 14db, 12cc and 12cb respectively. In the embodiment of FIGS. 15a to 16b, each second group 33 of fluid channels 12, 14 comprises four fluid channels 12, 14.

Each of the second groups 33 of fluid channels 12, 14 is directed through progressive rotation or twisting about a respective second axis 41. This may be referred to as a second rotation. The second axis 41 is parallel to the direction of flow of fluid through the channels 12, 14. In other words, the second axis 41 extends parallel to the longitudinal direction 13 of the heat exchanger 10L. The second axis 41 is parallel to the first axis 31. The progressive rotation is illustrated in FIGS. 16c and 16d, where the second groups 33 are rotated about respective second axes 41 in a clockwise direction shown by arrow D2. Each second group 33 is rotated about the associated second axis 41 by a second angle of rotation. In the illustrated embodiment, the second angle of rotation is 90°. That is, each second group 33 of fluid channels 12, 14 is rotated about the respective second axis 41 by an angle of 90°. Applying the second rotation to the second groups 33 of fluid channels 12, 14 changes the configuration of the fluid channels 12, 14 from the second configuration 25L to the third configuration 22L.

As described herein, the first angle of rotation is 180° and the second angle of rotation is 90°. In some embodiments, the sum of the first angle of rotation and the second angle of rotation is 270°. The first angle of rotation may be different to 180°. Similarly, the second angle of rotation may be different to 90°.

The reconfiguration of the fluid channels 12, 14 from the second configuration 25L to third configuration 22L occurs over a second length T1,2 of the first transition zone T1. In other words, each of the second groups 33 of fluid channels 12, 14 rotate, about their respective second axis 41, along the second length T1,2 of the first transition zone T1. Following this second rotation, the fluid channels 12, 14 are arranged in the third configuration 22L. The third configuration may be referred to as a heat transfer configuration.

The first length T1,1 of the first transition zone T1 is a different length of the first transition zone T1 than the second length T1,2 of the first transition zone T1. In other words, there is no overlap between the first length T1,1 of the first transition zone T1 and the second length T1,2 of the first transition zone T1. The first length T1,1 of the first transition zone T1 may therefore be said to be distinct from the second length T1,2 of the first transition zone T1. In the illustrated embodiment, the first length T1,1 of the first transition zone T1 is adjacent to the second length T1,2 of the first transition zone T1. That is, the first length T1,1 of the first transition zone T1 is immediately followed by the second length T1,2 of the first transition zone T1. It will be appreciated that in some embodiments, at least part of the second length T1,2 of the first transition zone T1 may overlap with at least part of the first length T1,1 of the first transition zone T1. In some embodiments, there may be an intermediate length of the heat exchanger between the first length T1,1 of the first transition zone T1 and the second length T1,2 of the first transition zone T1.

The first length T1,1 of the first transition zone T1 is about equal in length, in the longitudinal direction 13, to the second length T1,2 of the first transition zone T1. However, in some embodiments, the first length T1,1 of the first transition zone T1 may be of a different length, in the longitudinal direction 13, to the second length T1,2 of the first transition zone T1. For example, the first length T1,1 of the first transition zone T1 may be about twice as long as the second length T1,2 of the first transition zone T1.

Each fluid channel 12, 14 of the second group 33 of fluid channels 12, 14 comprises a respective cross sectional midpoint 43. The cross sectional midpoint 43 may be considered a centroid of the respective fluid channel 12, 14 at a point along its length. The second axis 41 of a respective second group 33 of fluid channels 12, 14 is equidistant from the cross sectional midpoint 43 of each fluid channel 12, 14 of that second group 33 along the second length T1,2 of the first transition zone T1. That is, the distance between the second axis 41 of a respective second group 33 of fluid channels 12, 14 and the cross sectional midpoint 43 of each of the fluid channels 12, 14 of that second group 33 is equal. This distance remains equal throughout the rotation of the second group 33 of fluid channels 12, 14. In some embodiments, the distance between the second axis 41 of a respective second group 33 of fluid channels 12, 14 and the cross sectional midpoint 43 of one or more of the fluid channels 12, 14 of that second group 33 may be different to the distance between the second axis 41 and the cross sectional midpoint 43 of another fluid channel 12, 14 of that second group 33, along at least part of the second length T1,2 of the first transition zone T1.

Referring to FIGS. 16a and 16c, it will be appreciated that the first axis 31 of one or more first group 24 of fluid channels 12, 14 and the second axis 41 of the corresponding second group 33 of fluid channels 12, 14 (i.e. the second group 33 that comprises a number of the fluid channels 12, 14 of a respective first group 24) are parallel. If the first axis 31 and/or the corresponding second axis 41 are extended along their lengths so that one is next to the other, the first axis 31 and the second axis 41 are separated by one or more columns 29 of channels 12, 14 at one or more points along the length of the first transition zone T1. In the illustrated embodiment, the first axes 31 shown in FIG. 16a are separated from their corresponding second axes 41 by one column 29 of fluid channels 12, 14 (the column 27 comprising fluid channels 12ac, 14bc, 12cc and 14dc if the heat exchanger 10L is viewed at the first plane P1, and the column 27 comprising fluid channels 14bb, 12ab, 14db and 12cb if the heat exchanger 10L is viewed at the second plane P2). That is, the first axis 31 and the corresponding second axis 41 are separated by one column 29 of fluid channels 12, 14 at at least one point of the first transition zone T1.

The fluid channels 12, 14 are arranged in the heat transfer configuration at the end of the second length T1,2 of the first transition zone T1. An end of the second length T1,2 of the first transition zone T1 corresponds to a start of the heat transfer zone TZ. As the end of the second length T1,2 of the first transition zone T1 corresponds to an end (i.e. the start) of the heat transfer zone TZ, the fluid channels 12, 14 are arranged in the heat transfer configuration when they reach the heat transfer zone.

The effect of the first rotation and the second rotation is that now mutually adjacent channels 12, 14 of different sets C and H have a different, and in this particular embodiment increased, shared heat transfer length. That is, in the heat transfer configuration, the fluid channels 12, 14 have an increased shared heat transfer length.

The change in the shared heat transfer length between channels 12, 14 in different sets C and H arises through a reorientation of the fluid channels 12, 14 so that now each channel 12, 14 in any set C, H is adjacent to more than one channel 12, 14 of a different set C, H. For example, with reference to FIG. 16d, the channel 14bc in the set H is now adjacent to channels 12aa, 12ac and 12ab in the set C. As a consequence, there is a shared heat transfer length X between the channel 14bc and the channel 12ac, and a shared heat transfer length Y between the channel 14bc and each of channels 12aa and 12ab.

Carrying this analysis through for the entire third configuration 22L, the total shared heat transfer length between the channels 12, 14, (which is the summation of the length of mutually opposed channel perimeters of adjacent channels 12, 14 of different sets H and C) is 12X+12Y. Thus, the shared heat transfer length is different between two points along the fluid flow path. In particular, in this embodiment the shared is heat transfer length increased by 12Y from the first end 18 to the end of the first transition zone T1. This provides greater heat transfer efficiency at the end of the first transition zone T1 and through the heat transfer zone TZ than the configuration 20L shown in FIG. 16a does at the first end 18.

As described herein, between the transition zones T1 and T2 there is a heat transfer zone TZ. In the heat transfer zone TZ, the fluid channels 12, 14 are maintained in the third configuration 22L. That is, the fluid channels 12, 14 are maintained in the heat transfer configuration as they extend through the heat transfer zone TZ. To maximise heat transfer, the length of the heat transfer zone TZ should be as long as possible in comparison to the overall flow path length of fluid flowing through the heat exchanger 10L.

At the second end 26 of the heat exchanger 10L, the second end portions E2 are arranged in the first configuration 20L. That is, the fluid channels 12, 14 are arranged in alternating rows 27 of fluid channels 12, 14 of the first set C and the second set H. This configuration 20L is shown in a plane P6 in FIG. 16a. The plane P6 may be referred to as a sixth plane P6. The sixth plane P6 is at a sixth point 51 along the length of the heat exchanger 10L. The sixth point 51 is the second end 26 of the heat exchanger 10L. The sixth plane P6 is perpendicular to a direction of flow of fluid through the heat exchanger 10L. The sixth plane P6 intersects outer ends of the second end portions E2. The sixth plane P6 maps to the second end 26 of the heat exchanger 10L. The sixth plane P6 is orthogonal to the longitudinal direction 13. It will be appreciated that where a configuration of fluid channels 12, 14 is described with reference to a respective plane, that configuration of fluid channels 12, 14 occurs at the point along the length of the heat exchanger 10L at which the plane is taken and/or disposed.

Referring to FIG. 15a, the heat transfer zone TZ ends at a third intermediate point 47 along the length of the heat exchanger 10L. That is, the heat transfer zone TZ extends between the second intermediate point 37 and the third intermediate point 47 of the heat exchanger 10L. The third intermediate point 47 is a fourth point along the heat exchanger 10L that is specifically shown in FIG. 15a. The third intermediate point 47 is closer to the second end 26 than the second intermediate point 37. At the third intermediate point 47, the fluid channels 12, 14 are arranged in the third configuration 22L. This configuration is shown with reference to a fourth plane P4 in FIG. 15a. Again, the fourth plane P4 is orthogonal to the longitudinal direction 13. As the fluid channels 12, 14 extend towards the second end 26 of the heat exchanger from the third intermediate point 47, their configuration changes to reverse the configuration changes that occurred in the first transition zone T1.

The reconfiguration of the fluid channels 12, 14 from the third configuration 22L in the heat transfer zone TZ to the first configuration 20L at the second end 26 of the heat exchanger 10L occurs through the second transition zone T2. This reconfiguration can occur in a number of ways, each of which involve reversing the effects of the first rotation and the second rotation of the first transition zone T1.

For example, starting at the third intermediate point 47, the fluid channels 12, 14 of the second groups 33 of fluid channels 12, 14 can be rotated, about their respective second axis 41, in a direction that is opposite to the second direction D2 as they extend towards the second end 26. Rotating the second groups 33 of fluid channels 12, 14 by the second angle of rotation (in this case,) 90° in this direction as they extend towards the second end 26 will reverse the change in configuration caused by the second rotation in the first transfer zone T1. That is, rotating the second groups 33 of fluid channels 12, 14, about their respective second axes 41, by 90°, in a direction that is opposite to the second direction D2, will change the configuration of the fluid channels 12, 14 from the third configuration 22L back to the second configuration 25L. This rotation may be referred to as a third rotation.

In the illustrated embodiment, the third rotation occurs over a first length T2,1 of the second transition zone T2. That is, the reconfiguration of the fluid channels 12, 14 from the third configuration 22L to the second configuration 25L occurs over the first length T2,1 of the second transition zone T2. The first length T2,1 of the second transition zone T2 extends between the third intermediate point 47 and a fourth intermediate point 49 along the length of the heat exchanger 10L. The first length T2,1 of the second transition zone T2 is between the heat transfer zone TZ and the second end 26 of the heat exchanger 10L. The described rotation of the relevant groups of fluid channels 12, 14 along the first length T2,1 of the second transition zone T2 results in the fluid channels 12, 14 being in the second configuration 25L fourth intermediate point 49. This configuration is shown with reference to a fifth plane P5 in FIG. 15a. Again, the fifth plane P5 is orthogonal to the longitudinal direction 13.

The fluid channels 12, 14 of the first groups 24 of fluid channels 12, 14 can be further rotated, about their respective first axis 31, in a direction that is opposite to the first direction D1, along a second length T2,2 of the second transition zone T2. Rotating the first groups 24 of fluid channels 12, 14 by the first angle of rotation (in this case, 180°) in this direction will reverse the change in configuration caused by the first rotation in the first transfer zone T1. That is, rotating the first group 24 of fluid channels 12, 14 about their respective first axis 31, by 180°, in a direction that is opposite to the first direction D1, along the second length T2,2 of the second transition zone T2, will change the configuration of the fluid channels 12, 14 from the second configuration 25L back to the first configuration 20L. It will be appreciated that a 180° rotation in the first direction D1 will also achieve the same result. Following these rotations, the fluid channels 12, 14 will then be arranged in the first configuration 20L at the second end 26 of the heat exchanger 10L. This configuration is shown with reference to the sixth plane P6 in FIG. 15a.

The first transition zone T1 is equal in length, in the longitudinal direction 13, to the second transition zone T2. In some embodiments, the first transition zone T1 may be longer, in the longitudinal direction 13, than the second transition zone T2. In some embodiments, the first transition zone T1 may be shorter, in the longitudinal direction 13, than the second transition zone T2.

The heat transfer zone TZ may be of a specified length with respect to one or both of the first transition zone T1 and the second transition zone T2. In the illustrated embodiment, the heat transfer zone TZ is longer than the first transition zone T1 and the second transition zone T2. In some embodiments, the heat transfer zone TZ is longer, in the longitudinal direction 13, than the first transition zone T1. In some embodiments, the heat transfer zone TZ is shorter, in the longitudinal direction 13, than the first transition zone T1. In some embodiments, the heat transfer zone TZ is longer, in the longitudinal direction 13, than the second transition zone T2. In some embodiments, the heat transfer zone TZ is shorter, in the longitudinal direction 13, than the second transition zone T2.

In some embodiments, the heat transfer zone TZ extends for at least one quarter of the length, in the longitudinal direction 13, of the heat exchanger 10L. That is, in at least one example, the channels 12, 14 are maintained in the third configuration 22L, i.e. where the reorientated groups are maintained in their transposed positions, for a length of at least one quarter of the length of the fluid flow path through the heat exchanger 10L.

The first end portions E1C of channels 12 in the first set C may be, or are otherwise connected to, outlets while the first end portions E1H of the channels 14 in the second set H may be, or are otherwise connected to, inlets. Conversely the second end portions E2C the first of channels 12 in the first set C may be inlets while the second end portions E2H of the channels 14 in the second set H may be outlets. With this arrangement of inlets and outlets the heat exchanger 10L are arranged such that the heat exchanger 10L is a counter flow heat exchanger.

In an alternate embodiment it is possible to arrange the first end portions E1 of both sets C, H of fluid channels 12, 14 to be inlets and the second end portions E2 to of the fluid channels 12, 14 to be outlets in which event the heat exchanger 10L would be a parallel or concurrent flow heat exchanger. However, this arrangement may have less thermal efficiency than the counter-flow heat exchanger.

In the illustrated embodiment, in the first configuration 20L, the fluid channels 12, 14 are arranged in alternating rows or planes of channels of the same type. Thus, with reference to FIG. 16a there is a top row 271 or plane of channels 12aa-12ad in the set C, beneath this is a row 272 of fluid channels 14ba-14bd from the set H, beneath this is a row of channels 12ca-12cd from the set C, etc. This arrangement facilitates the connection of planes of channels of the same type to a corresponding manifold MC or MH in a header section of the heat exchanger 10L.

The first end portions E1C of the first set C of fluid channels 12 are connected to a first header. The first header may be an inlet header in the case where the first end portions E1C are inlets for the cold fluid. The first header may be an outlet header in the case where the first end portions E1C are outlets for the cold fluid. The second end portions E2C of the first set C of fluid channels 12 are connected to a second header. The second header may be an inlet header in the case where the second end portions E2C are inlets for the cold fluid. The second header may be an outlet header in the case where the second end portions E2C are outlets for the cold fluid.

The first end portions E1H of the second set H of fluid channels 14 are connected to a first header. The first header may be an inlet header in the case where the first end portions E1H are inlets for the hot fluid. The first header may be an outlet header in the case where the first end portions E1H are outlets for the hot fluid. The second end portions E2H of the second set H of fluid channels 14 are connected to a second header. The second header may be an inlet header in the case where the second end portions E2H are inlets for the hot fluid. The second header may be an outlet header in the case where the second end portions E2H are outlets for the hot fluid.

It will be appreciated that in cases where the fluids directed through the heat exchanger are counter-flow (i.e. flowing in opposite directions along the length of the heat exchanger), the inlet header for the cold fluid will be on an opposite side of the heat exchanger 10L as the inlet header for the hot fluid. For example, a first inlet header may be connected to the first end portions E1C of the fluid channels 12 of the first set C and a second inlet header may be connected to the second end portions E2H of the fluid channels 14 of the second set H. Similarly, a first outlet header may be connected to the second end portions E2C of the fluid channels 12 of the first set C and a second outlet header may be connected to the first end portions E1H of the fluid channels 14 of the second set H. In such a case, the first inlet header, the first outlet header, the second inlet header and the second outlet header are configured to provide a counter-flow of fluid through the first set C of fluid channels 12 and the second set H of fluid channels 14.

In the third configuration 22L the fluid channels 12, 14 may be considered to be in a chequerboard configuration. The chequerboard configuration may be referred to as a chequerboard arrangement. That is, the heat transfer configuration may be referred to as a chequerboard configuration or a chequerboard arrangement.

It will be appreciated that the number of first groups 24 that is formed or selected is proportional to the total number of channels 12, 14 of the heat exchanger 10L. For example, there is one first group of channels 24 for each 2 row, 4 column group of adjacent channels 12, 14 of the heat exchanger 10L at each end 18, 26. Similarly, the number of second groups 33 that is formed or selected is also proportional to the total number of channels 12, 14 of the heat exchanger 10L. In the simplest case, where the heat exchanger 10L comprises a 2×4 grid of fluid channels 12, 14 at the first end 18 and the second end 26, only one first group 24 of fluid channels 12, 14 may be selected. The number of first groups 24 scales with the number of 2×4 grids of channels 12, 14 of the heat exchanger 10L. Similarly, in the simplest case, where the heat exchanger 10L comprises a 2×4 grid of fluid channels 12, 14, only one second group 33 of fluid channels 12, 14 may be selected.

### Heat Exchanger 10M

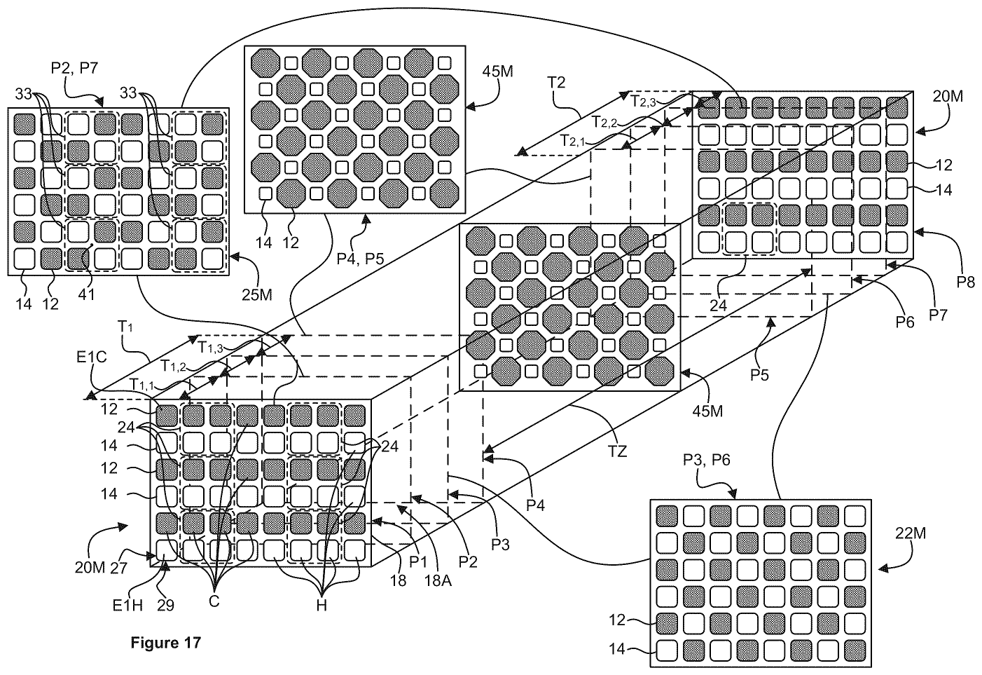

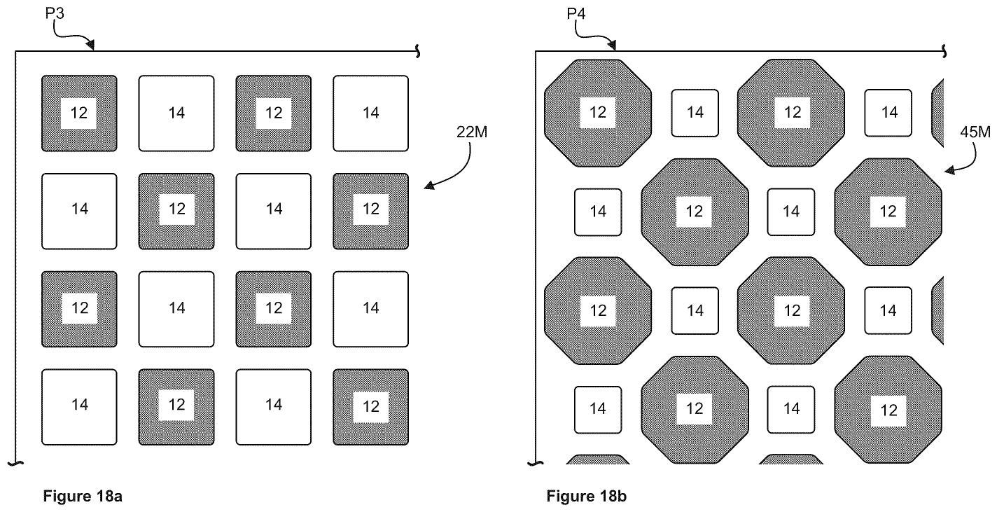

FIGS. 17 to 18b show another configuration of a heat exchanger 10M, according to some embodiments. The embodiment of the heat exchanger 10M of FIGS. 17 to 18b is similar to that of FIGS. 15a to 16d. However, the embodiment of the heat exchanger 10M shown in FIGS. 17 to 18b includes another change in fluid channel 12, 14 configuration in each of the first transition zone T1 and the second transition zone T2. The cross-sectional shape of the fluid channels 12, 14 through the heat transfer zone TZ is therefore different in the heat exchanger 10M of FIGS. 17 to 18b compared to that of FIGS. 15a to 16d.

Specifically, in the heat exchanger 10M embodiment of FIGS. 17 to 18b, the fluid channels 12, 14 are arranged in alternating rows 27 of channels at the first end 18 and the second end 26. This configuration, which may be referred to as a first configuration 20M, is shown with reference to the first plane P1 and the eighth plane P8 in FIG. 17. A number of the fluid channels 12, 14 undergo a first rotation like that described with reference to FIGS. 15a to 16b, along a first length T1,1 of the first transition zone T1 and along a third length of the second transition zone T2,3 respectively, as they extend inwards towards the heat transfer zone TZ. That is, one or more first groups 24 of fluid channels 12, 14 is selected at the first end 18 of the heat exchanger 10M and at the second end 26 of the heat exchanger 10M. These first groups 24 are rotated about respective first axes 31 by a first angle of rotation, along the first length T1,1 of the first transition zone T1 and the third length T1,3 of the first transition zone T1 respectively. The first angle of rotation is 180°, as described with reference to FIGS. 15a to 16d. Following this rotation, the fluid channels 12, 14 are arranged in a second configuration 25M. This configuration is shown with reference to a second plane P2 and a seventh plane P7 in FIG. 17.

Subsequent to this, a number of the fluid channels 12, 14 undergo a second rotation like that described with reference to FIGS. 15a to 16b, along a second length T1,2 of the first transition zone T1 and a second length T2,2 of the second transition zone T2. That is, one or more second groups 33 of fluid channels 12, 14 is selected at an intermediate point of each of the first transition zone T1 and the second transition zone T2. These second groups 33 are rotated about respective second axes 41 by a second angle of rotation, along the second length T1,2 of the first transition zone T1 and the second length T2,2 of the second transition zone T2. The second angle of rotation is 90° as described with reference to FIGS. 15a to 16d. Following this rotation, the fluid channels 12, 14 are arranged in a third configuration 22M. This configuration is shown with reference to a third plane P3 and a sixth plane P6 in FIG. 17.

As described herein, the first angle of rotation is 180° and the second angle of rotation is 90°. In some embodiments, the sum of the first angle of rotation and the second angle of rotation is 270°. The first angle of rotation may be different to 180°. Similarly, the second angle of rotation may be different to 90°.

The cross-sectional shape of one or more of the fluid channels 12, 14 also changes across at least part of the first transition zone T1 and across at least part of the second transition zone T2. In the embodiment illustrated FIGS. 17 to 18b, the cross-sectional shape of each of the fluid channels 12, 14 changes across a third length T1,3 of the first transition zone T1. The third length T1,3 of the first transition zone T1 is a different length of the first transition zone T1 than the first length T1,1. The third length T1,3 of the first transition zone T1 is a different length of the first transition zone T1 as the second length T1,2. The third length T1,3 of the first transition zone T1 may therefore be said to be distinct from the first length T1,1 and/or the second length T1,2. In other words, in the illustrated embodiment, there is no overlap between the third length T1,3 of the first transition zone T1 and either of the first length T1,1 or the second length T1,2.

The third length T1,3 of the first transition zone T1 is about equal in length, in the longitudinal direction 13, to the first length T1,1 of the first transition zone T1. The third length T1,3 of the first transition zone T1 is about equal in length, in the longitudinal direction 13, to the second length T1,2 of the first transition zone T1. However, in some embodiments, the third length T1,3 of the first transition zone T1 may be of a different length, in the longitudinal direction 13, to the first length T1,1 and/or the second length T1,2 of the first transition zone T1.

The cross-sectional shape of each of the fluid channels 12, 14 also changes across a first length T2,1 of the second transition zone T2. The first length T2,1 of the second transition zone T2 is a different length of the second transition zone T2 than the third length T2,3. The first length T2,1 of the second transition zone T2 is a different length of the second transition zone T2 as the second length T2,2. The first length T2,1 of the second transition zone T2 may therefore be said to be distinct from the second length T2,2 and/or the third length T2,3. In other words, in the illustrated embodiment, there is no overlap between the first length T2,1 of the second transition zone T2 and either of the second length T2,2 or the third length T2,3.

The first length T2,1 of the second transition zone T2 is about equal in length, in the longitudinal direction 13, to the third length T2,3 of the second transition zone T2. The first length T2,1 of the second transition zone T2 is about equal in length, in the longitudinal direction 13, to the second length T2,2 of the second transition zone T2. However, in some embodiments, the first length T2,1 of the second transition zone T2 may be of a different length, in the longitudinal direction 13, to the second length T2,2 and/or the third length T2,3 of the second transition zone T2.

In the embodiment of FIGS. 17 to 18b, the cross sectional shape of each fluid channel 12 of the first set C of fluid channels 12 changes from a first cross sectional shape to a second cross sectional shape along each of the third length T1,3 of the first transition zone T1 and the first length T2,1 of the second transition zone T2 as the fluid channels 12, 14 extend towards the heat transfer zone TZ. In particular, the cross-sectional shape of each fluid channel 12 of the first set C of fluid channels 12 changes from a rounded rectangle to a octagonal shape at the end of the first transition zone T1 and the second transition zone T2. The octagonal shape may be an octagon. The octagonal shape may be a rounded octagon. With such a change, an area of the cross sectional shape of the fluid channels 12 of the first set C of fluid channels 12 increases as the fluid channels 12 approach the heat transfer zone TZ. This change is illustrated with reference to planes P4 and P5 in FIG. 17.

The cross-sectional shape of each fluid channel 14 of the second set H of fluid channels 14 also changes along the third length T1,3 of the first transition zone T1 and long the first length T2,1 of the second transition zone T2. In particular, the cross sectional shape of each fluid channel 14 of the second set H of fluid channels 14 changes from a first cross-sectional shape to a second cross-sectional shape along the third length T1,3 of the first transition zone T1 and the first length T2,1 of the second transition zone T2 as the fluid channels 12, 14 extend towards the heat transfer zone TZ. The cross-sectional shape of each fluid channel 14 of the second set H of fluid channels 14 changes from a rounded rectangle to a smaller rounded rectangle at the end of the first transition zone T1 and the second transition zone T2. With such a change, an area of the cross sectional shape of the fluid channels 14 of the second set H of fluid channels 14 decreases as the fluid channels 14 approach the heat transfer zone TZ.

The changes in shape of the fluid channels 12, 14 result in the configuration of fluid channels 12, 14 changing from the third configuration 22M to a fourth configuration 45M. In this case, the fourth configuration 45M may be considered the heat transfer configuration. The fluid channels 12, 14 maintain the fourth configuration 45M through the heat transfer zone TZ. The cross-sectional shape of each fluid channel 12, 14 is constant across the heat transfer zone TZ.

Like with the embodiment of FIGS. 15a to 16d, at the second end 26 of the heat exchanger 10M of FIGS. 17 to 18b, the fluid channels 12, 14 are also arranged in the first configuration 20M. That is, the fluid channels 12, 14 are arranged in alternating rows of the first set C and the second set H. The reconfiguration of the fluid channels 12, 14 from the fourth configuration 45M in the heat transfer zone TZ to the first configuration 20M at the second end 26 of the heat exchanger 10M occurs through the second transition zone T2 as described herein. Specifically, the changes in configuration that the fluid channels 12, 14 undergo in the first transition zone T1 are reversed in the second transition zone T2.

The heat exchanger 10M of FIGS. 17 to 18b is suited for applications in which the fluid passing through the fluid channels 14 of the second set H is relatively clean and the fluid passing through the fluid channels 12 of the first set C is relatively dirty. The greater cross-sectional area of the fluid channels 12 allows the dirtier fluid to flow through the heat exchanger 10M with less likelihood of clogging the fluid channels 12 of the first set C.

Alternative Heat Exchanger with a Series of Fluid Channel Rotations

### Heat Exchanger 10N

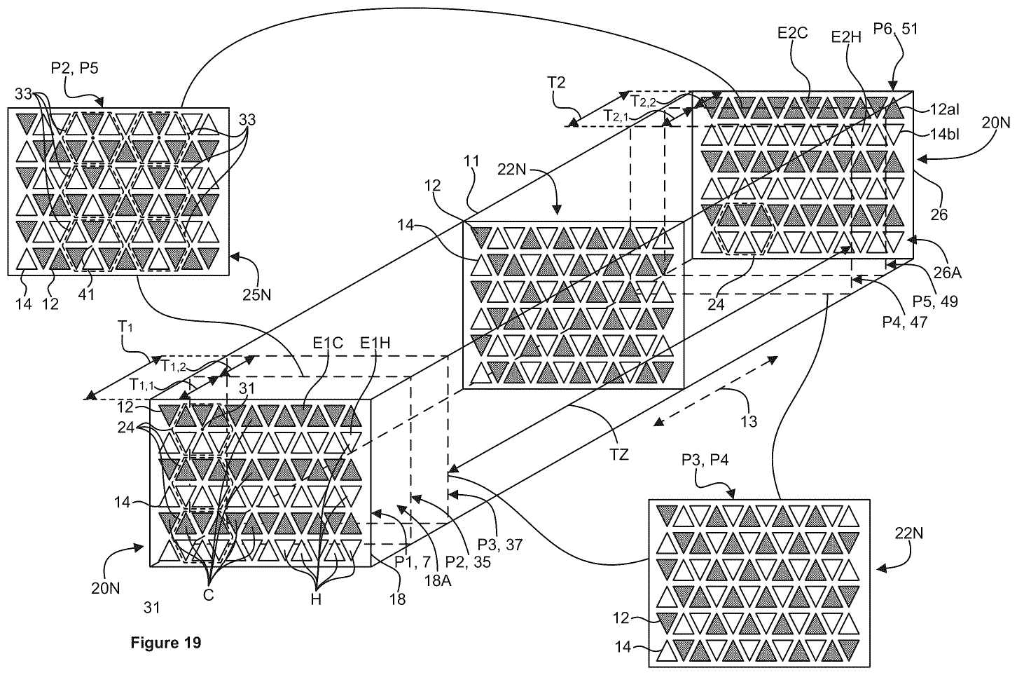

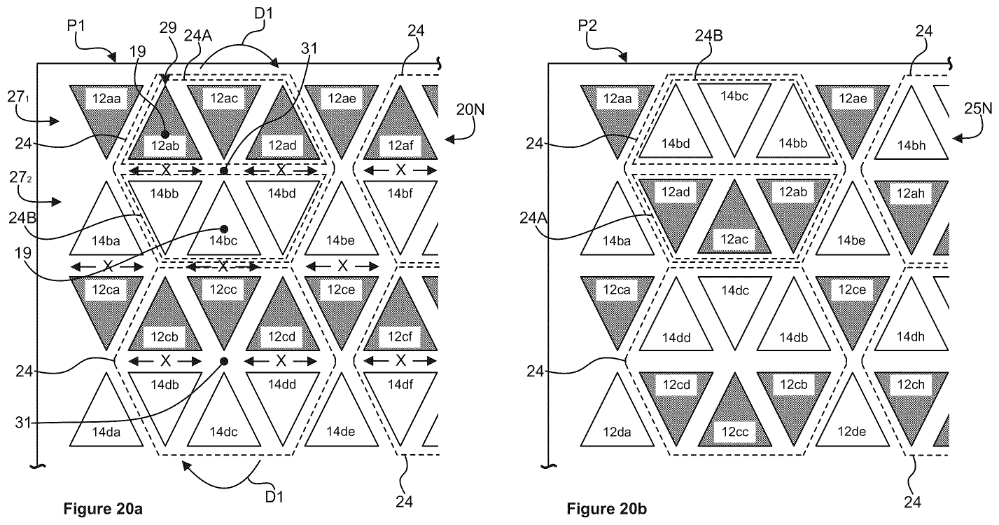

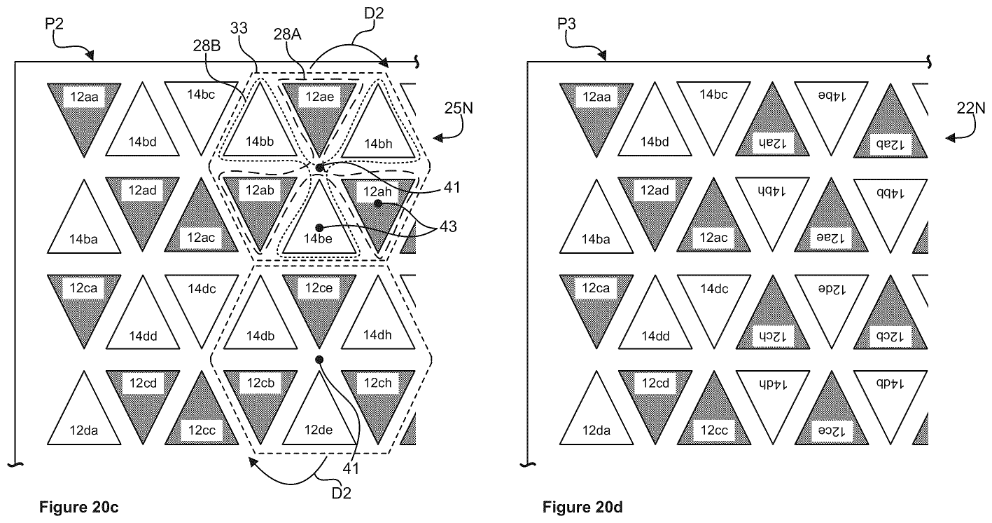

FIGS. 19 to 20d show another configuration of a heat exchanger 10N, according to some embodiments of the present disclosure. The heat exchanger 10N may comprise one or more features that is the same as, or similar to, the heat exchanger 10L described with reference to FIGS. 15a to 16d, or another one of the heat exchangers described herein. In such case, similar reference numerals may be used in the Figures for similar features.

The heat exchanger 10N extends from a first end 18 to a second end 26. The heat exchanger 10N comprises a first end portion 18A. The first end portion 18A comprises the first end 18 of the heat exchanger 10N. The first end 18 may be considered a longitudinal end of the heat exchanger 10N. The heat exchanger 10N comprises a second end portion 26A. The second end portion 26A comprises the second end 26 of the heat exchanger 10N. The second end 26 may be considered a longitudinal end of the heat exchanger 10N.

The heat exchanger 10N comprises a body 11. The body 11 defines the first end 18 and the second end 26. The body 11 extends from the first end 18 of the heat exchanger 10N to the second end 26 of the heat exchanger 10N in a longitudinal direction 13 of the heat exchanger 10N.

The heat exchanger 10N comprises a plurality of fluid channels 12, 14. The fluid channels 12, 14 extend from the first end 18 of the heat exchanger 10N to the second end 26 of the heat exchanger 10N. In other words, the fluid channels 12, 14 extend along the longitudinal length of the heat exchanger 10N. One or more of the fluid channels 12, 14 of the heat exchanger 10N undergo a number of rotations or twists along their length. Specifically, a number of the fluid channels 12, 14 of the heat exchanger 10N undergo a series of rotations or twists along their length.

The fluid channels 12, 14 are in the form of channels in the body 11. The fluid channels 12, 14 are in the form of channels in the body 11. One or more of the fluid channels 12, 14 defines a fluid flow path through the heat exchanger 10N. One or more of the fluid flow paths may extend from the first end 18 of the heat exchanger 10N to the second end 26 of the heat exchanger. In the illustrated embodiment, each fluid channel 12, 14 defines a fluid flow path through the heat exchanger 10N that extends from the first end 18 of the heat exchanger 10N to the second end 26 of the heat exchanger 10N. Each fluid channel 12, 14 defines a fluid channel surface 9 (see FIG. 20a). The fluid channel surface 9 may be considered an internal surface of the respective fluid channel 12, 14. The fluid channel surface 9 may be defined by the body 11.

The cross sectional shape of one or more of the fluid channels 12, 14, at one or more points along the length of the heat exchanger 10N is a rounded triangle. In the embodiment illustrated in FIGS. 19 to 20d, the cross-sectional shape of each fluid channel 12, 14 is a rounded triangle along the entire length of the heat exchanger 10N.

It will be appreciated, however, that in some embodiments, the cross-sectional shape of one or more of the fluid channels 12, 14 may be a different shape at one or more points along the length of the heat exchanger 10N. For example, the cross sectional shape of one or more of the fluid channels 12, 14 may be a circle, an ellipse, a rounded rectangle, a polygon and/or a rounded polygon at one or more points along the length of the heat exchanger 10N. In some embodiments, the cross sectional shape of one or more of the fluid channels 12, 14 at the first end 18 and/or the second end 26 of the heat exchanger is circular. In some embodiments, the cross sectional shape of one or more of the fluid channels 12, 14 at the first end 18 and/or the second end 26 of the heat exchanger is triangular. In some embodiments, the cross sectional shape of one or more of the fluid channels 12, 14 changes along the length of the heat exchanger 10N. For example, the cross sectional shape of one or more of the fluid channels 12, 14 may change from generally triangular to generally octagonal along the length of the heat exchanger 10N.

In some embodiments, the internal surface 9 of one or more of the fluid channels 12, 14 is arranged to induce turbulence in fluid flowing through the respective fluid channels 12, 14 as described with reference to one or more other heat exchanger embodiments described herein.

The heat exchanger 10N comprises a first transition zone T1. The first transition zone T1 is disposed at or near the first end 18 of the heat exchanger 10N. In some embodiments, the first transition zone T1 may be said to comprise the first end 18 of the heat exchanger 10N. The first transition zone T1 extends along a length of the heat exchanger 10N. In some embodiments, the first end portion 18A of the heat exchanger 10N is the first transition zone T1. One or more of the fluid channels 12, 14 extends through the first transition zone T1. In the illustrated embodiment, each fluid channel 12, 14 extends through the first transition zone T1.

The configuration of the fluid channels 12, 14 changes through at least part of the first transition zone T1. A position of one or more of the fluid channels 12, 14 changes with respect to a position of another one or more of the fluid channels 12, 14 through at least part of the first transition zone T1. A shape of one or more of the fluid channels 12, 14 may change across at least part of the first transition zone T1. Therefore, the change in configuration of the fluid channels 12, 14 across the first transition zone T1 may comprise one or both of a change in relative position of one or more fluid channels 12, 14 and a change in shape of one or more fluid channels 12, 14.

The heat exchanger 10N comprises a heat transfer zone TZ. The heat transfer zone TZ may be referred to as an intermediate zone of the heat exchanger 10N. The heat transfer zone TZ extends along a length of the heat exchanger 10N. One or more of the fluid channels 12, 14 extends through the heat transfer zone TZ. In the illustrated embodiment, each fluid channel 12, 14 extends through the heat transfer zone TZ. The heat transfer zone TZ is adjacent to the first transition zone T1.

The heat exchanger 10N comprises a second transition zone T2. The second transition zone T2 is disposed at or near the second end 26 of the heat exchanger 10N. In some embodiments, the second transition zone T2 may be said to comprise the second end 26 of the heat exchanger 10N. The second transition zone T2 extends along a length of the heat exchanger 10N. In some embodiments, the second end portion 26A is the second transition zone T2. One or more of the fluid channels 12, 14 extends through the second transition zone T2. In the illustrated embodiment, each fluid channel 12, 14 extends through the second transition zone T2. In the illustrated embodiment, each fluid channel 12, 14 extends through the first transition zone T1, the heat transfer zone TZ and the second transition zone T2.

The configuration of the fluid channels 12, 14 changes through at least part of the second transition zone T2. A position of one or more of the fluid channels 12, 14 changes with respect to a position of another one or more of the fluid channels 12, 14 through at least part of the second transition zone T2. A shape of one or more of the fluid channels 12, 14 may change across at least part of the second transition zone T2. The heat transfer zone TZ is adjacent to the second transition zone T2. In particular, the heat transfer zone TZ is between the first transition zone T2 and the second transition zone T2.

The heat exchanger 10N comprises a plurality of sets C, H of fluid channels 12, 14. Each set C, H comprises a plurality of respective fluid channels 12, 14. In the illustrated embodiment, there are two sets C, H of fluid channels 12, 14. That is, the heat exchanger 10N comprises a first set C of fluid channels 12. The first set C of fluid channels 12 comprises a plurality of fluid channels 12. That is, the fluid channels referred to with the reference numeral “12” in FIGS. 19 to 20d form at least part of the first set C. The heat exchanger 10N comprises a second set H of fluid channels 14. The second set H of fluid channels 14 comprises a plurality of fluid channels 14. That is, the fluid channels referred to with the reference numeral “14” in FIGS. 19 to 20d form at least part of the second set H.

For convenience, the first set C of fluid channels 12 may be considered as a set of fluid channels 12 configured to enable the flow of a cold fluid. The second set H of fluid channels 14 may be considered as a set of fluid channels 14 configured to enable the flow of a hot fluid. It will be appreciated however, that in some embodiments this may be reversed.

In FIGS. 19 to 20d, the fluid channels 12 of the first set C are shown as shaded channels and the fluid channels 14 of the second set H are shown as white channels. In other words, the fluid channels 12 configured to enable the flow of a cold fluid are shown as shaded channels and the fluid channels 14 configured to enable the flow of a hot fluid are shown as white channels.

The fluid channels 12, 14 are aligned into a number of rows 27 and a number of columns 29 at one or more points along the length of the heat exchanger 10N. FIG. 19 illustrates a number of notional planes P1, P2, P3, P4, P5, P6 along the heat exchanger 10N at which the fluid channels 12, 14 are aligned into rows 27 and columns 29.

Each of the fluid channels 12 of the first set C has a respective first end portion E1C. Each of the fluid channels 12 of the first set C has a respective second end portion E2C. Each of the fluid channels 14 of the second set H has a respective first end portion E1H. Each of the fluid channels 14 of the second set H has a respective second end portion E2H. Hereinafter, the first end portions E1C, E1H and the second end portions E2C, E2H may be collectively, and in general, referred to as “first end portions E1” and “second end portions E2” respectively. Further, for ease of description, the end portions in a general sense, whether they be the first end portions or the second end portions, may be referred to hereafter as “end portions E”.

As described with reference to the heat exchanger 10L of FIGS. 15a to 16d, the first end portions E1 extend from the first end 18 of the heat exchanger 10N, towards the second end 26 of the heat exchanger 10N. The first end portion E1 of each fluid channel 12, 14 extends through at least part of the first transition zone T1. In some embodiments, the first end portion E1 of each fluid channel 12, 14 is the portion of the fluid channel 12, 14 that extends through the first transition zone T1.

The second end portions E2 extend from the second end 26 of the heat exchanger 10N, towards the first end 18 of the heat exchanger 10N. The second end portion E2 of each fluid channel 12, 14 extends through at least part of the second transition zone T2. In some embodiments, the second end portion E2 of each fluid channel 12, 14 is the portion of the fluid channel 12, 14 that extends through the second transition zone T2.

In between the end portions E, each channel 12, 14 has an intermediate portion 16C, 16H respectively. That is, the fluid channels 12 of the first set C have respective intermediate portions 16C. Similarly, the fluid channels 14 of the second set H have respective intermediate portions 16H. Hereinafter, the intermediate portions 16C, 16H may be referred to collectively, and in general, as “intermediate portions 16”. The intermediate portion 16 of each fluid channel 12, 14 bridges the first end portion E1 and the second end portion E2 of that fluid channel 12, 14. The intermediate portion 16 of each fluid channel 12, 14 extends through at least part of the heat transfer zone TZ. In some embodiments, the intermediate portion 16C, 16H of each fluid channel 12, 14 is the portion of the fluid channel 12, 14 that extends through the heat transfer zone TZ.

The end portions E1 of the fluid channels 12, 14 are connected to and are in fluid communication with respective manifolds, as described with reference to the heat exchanger 10L of FIGS. 15a to 16d. The manifolds may enable the flow of hot fluid and cold fluid in the same direction through the heat exchanger 10N, or may enable the counter-flow of the hot and cold fluids.

The first end portions E1, in a first plane P1 that is at a first point 7 along the length of the heat exchanger 10N, have a first configuration 20N as shown in FIGS. 19 and 20A. In the illustrated embodiment, the first point 7 is the first end 18 of the heat exchanger 10N.

On the first plane P1, the fluid channels 12, 14 are arranged in a number of rows 27 and a number of columns 29. In particular, on the first plane P1, and therefore at the first end 18 of the heat exchanger 10N, the fluid channels 12, 14 are arranged in alternating rows 27 of fluid channels 12, 14 of the first set C and the second set H. Therefore, at least part of the first end portions E1 of the fluid channels 12, 14 are arranged in alternating rows 27 of fluid channels 12, 14. Each row 27 of fluid channels 12, 14 comprises only fluid channels 12, 14 from the first set C of fluid channels 12 or only fluid channels 14 from the second set H of fluid channels 14.

Referring to FIG. 20a, it will be noted that in the configuration 20N, adjacent channels 12, 14 of different sets H and C have a shared heat transfer length X. Looking at FIG. 20a, the channels 12ab and 14bb have a shared heat transfer length X; as do channels 12ad and 14bd; and 12af and 14bf; etc. So, in the illustrated example subset of channels 12, 14 shown at plane P1, there is a total first shared heat transfer length of 9X being the summation of the length of mutually opposed perimeters of the adjacent end portions of the different sets C and H.

Like as described with reference to the heat exchanger 10L of FIGS. 15a to 16d, in FIGS. 19 to 20d, the individual fluid channels 12 in the set C are denoted as fluid channels 12ij where ij denote matrix positions which are referenced by letters a z. Similarly, the individual fluid channels 14 in the set H are denoted as fluid channels 14ij where ij denote matrix positions where are referenced by letters a-z.

FIGS. 20b and 20c show another section of the heat exchanger 10N, in a second plane P2. In particular, FIGS. 20b and 20c show another section of the first end portions E1, in the second plane P2. The second plane P2 is longitudinally displaced with respect to the first plane P1. In particular, the second plane P2 is between the first plane P1 and the second end portions E2 of the fluid channels 12, 14. The second plane P2 is at an intermediate point 35 along the length of the heat exchanger 10N. The intermediate point 35 is between the first end 18 and the second end 26. In particular, the intermediate point 35 is within the first transition zone T1.

The fluid channels 12, 14 are in a second configuration 25N when viewed at the second plane P2. In other words, the fluid channels 12, 14 are in the second configuration 25N at the intermediate point 35 along the length of the heat exchanger 10N. The second configuration 25N is different to the first configuration 20N. That is, the configuration of the fluid channels 12, 14 has changed between the point 7 of the heat exchanger 10N corresponding to the first plane P1 and the point 35 of the heat exchanger 10N corresponding to the second plane P2.

In order to reconfigure the pattern of the fluid channels 12, 14 from the first configuration 20N to the second configuration 25N, one or more group 24 of fluid channels 12, 14 is formed or selected. Each group 24 of fluid channels 12, 14 may be referred to respectively as a first group 24 of fluid channels 12, 14. The one or more group 24 of fluid channels 12, 14 is selected at the outer end of the first end portions E1 of the fluid channels 12, 14. That is, the one or more first group 24 of fluid channels 12, 14 is selected at the first end 18 of the heat exchanger 10N. The fluid channels 12, 14 are arranged in rows 27 and columns 29 at the point at which the first group 24 is formed or selected.

Referring to FIG. 20a, each first group 24 of fluid channels 12, 14 comprises a first subset 24A of the first set C of fluid channels 12. An example first subset 24A of the first set C of fluid channels 12 is shown in FIG. 20a to comprise fluid channels 12ab, 12ac and 12ad. Each first group 24 of fluid channels 12, 14 comprises a first subset 24B of the second set H of fluid channels 14. An example first subset 24B of the second set H of fluid channels 14 is shown in FIG. 20a to comprise fluid channels 14bb, 14bc and 14bd.

The first subset 24A of the first set C of fluid channels 12 comprises only fluid channels 12 of one row 27 of the first set C of fluid channels 12. In particular, one of the first subsets 24A of the first set C of fluid channels 12 of FIG. 20a comprises only fluid channels 12 of a first row 271 of fluid channels 12, at the first point 7 of the heat exchanger 10N. The first subset 24B of the second set H of fluid channels 14 comprises only fluid channels 14 of one row 27 of the second set H of fluid channels 14. In particular, the first subset 24B of the second set H of fluid channels 14 comprises only fluid channels of a second row 272 of fluid channels 14, at the first point 7 of the heat exchanger 10N. The row 27 of fluid channels 12 at the first point 7 along the length of the heat exchanger 10N from which the first subset 24A of the first set C of fluid channels 12 is selected is adjacent to the row 27 of fluid channels 14 from which the first subset 24B of the second set H of fluid channels 14 is selected.

The first groups 24 of fluid channels 12, 14 selected at the first point 7 along the length of the heat exchanger 10N of FIGS. 19 to 20d each comprise six fluid channels 12, 14. Each first group 24 of fluid channels 12, 14 comprises three fluid channels 12 of the first set C of fluid channels 12. Each first group 24 of fluid channels 12, 14 comprises three fluid channels 14 of the second set H of fluid channels 14. It may therefore be said that each first group 24 of fluid channels 12, 14 comprises more than two fluid channels 12 of the first set C of fluid channels 12. It may also be said that each first group 24 of fluid channels 12, 14 comprises more than two fluid channels 14 of the second set H of fluid channels 14.

In this embodiment, each of the first groups 24 of fluid channels 12, 14 are directed through progressive rotation or twisting about a respective first axis 31. This may be referred to as a first rotation. The first axis 31 is parallel to the direction of flow of fluid through the channels 12, 14. In other words, the first axis 31 extends parallel to the longitudinal direction 13 of the heat exchanger 10N. The progressive rotation is illustrated in the sequence of FIGS. 20a to 20b, where the first groups 24 are rotated about respective first axes 31 in a clockwise direction shown by arrow D1, as the respective fluid channels 12, 14 extend away from the first end 18. Each first group 24 is rotated about the respective first axis 31 by a first angle of rotation. In the illustrated embodiment, the first angle of rotation is 180°. That is, each first group 24 of fluid channels 12, 14 rotates about the first axis 31 by an angle of 180° as the respective fluid channels 12, 14 extend away from the first end 18. Applying the first rotation to the first groups 24 of fluid channels 12, 14 changes the configuration of the fluid channels 12, 14 from the first configuration 20N at the first point 7 to the second configuration 25N at the intermediate point 35.

The reconfiguration of the channels 12, 14 from the first configuration 20N to second configuration 25N occurs over a first length T1,1 of the first transition zone T1. In other words, each of the first groups 24 of fluid channels 12, 14 rotate, about their respective first axis 31, along the first length T1,1 of the first transition zone T1.

Each fluid channel 12, 14 of the first group 24 of fluid channels 12, 14 comprises a respective cross sectional midpoint 19. The cross sectional midpoint 19 may be considered a centroid of the respective fluid channel 12, 14 at a point along its length. In some embodiments, the first axis 31 of a respective first group 24 of fluid channels 12, 14 is equidistant from the cross sectional midpoint 19 of each fluid channel 12, 14 of that first group 24 along the first length T1,1 of the first transition zone T1. In some embodiments, a distance between the first axis 31 of at least one of the first groups 24 of fluid channels 12, 14 and the cross sectional midpoint 19 of one of the fluid channels 12, 14 of that first group 24 is different to a distance between that first axis 31 and the cross sectional midpoint of another of the fluid channels 12, 14 of that first group 24. In other words, in some embodiments the cross sectional midpoints 19 are not equidistantly separated from the first axis 31 along the first length T1,1 of the first transition zone T1.

FIG. 20d shows another section of the heat exchanger 10N, in a third plane P3. The third plane P3 is taken at a boundary of the first end portions E1 of the fluid channels 12, 14 and the intermediate portions 16C, 16H of the fluid channels 12, 14. Therefore, the configuration of fluid channels 12, 16 shown in FIG. 20d reflects both the configuration of fluid channels 12, 14 at an inner end of the first end portions E1 and an outer end of the intermediate portions 16C, H (i.e. at the outer end of the heat transfer zone TZ). This point along the length of the heat exchanger 10N may be considered a second intermediate point 37 of the heat exchanger 10N.

The fluid channels 12, 14 are in a third configuration 22N when viewed at the third plane P3. In other words, the fluid channels 12, 14 are in the third configuration 22N at the second intermediate point 37 of the heat exchanger 10N. The third configuration 22N is different to the first configuration 20N. The third configuration 22N is different to the second configuration 25N. That is, the configuration of the fluid channels 12, 14 has changed between the intermediate point 35 and the second intermediate point 37. The third configuration 22N may be referred to as a heat transfer configuration.

In order to reconfigure the pattern of the fluid channels 12, 14 from the second configuration 25N to the third configuration 22N, one or more group 33 of fluid channels 12, 14 is formed or selected. Each group 33 of fluid channels 12, 14 may be referred to respectively as a second group 33 of fluid channels 12, 14.

The one or more second group 33 of fluid channels 12, 14 is selected at the intermediate point 35 along the length of the heat exchanger 10N. The plane P2 is taken at this intermediate point 35. The intermediate point 35 is an intermediate point of the first end portion 18A. In other words, the intermediate point 35 is an intermediate point of the first transition zone T1. The intermediate point 35 corresponds to an inner end of the first length T1,1. That is, the intermediate point 35 is a point positioned after the rotation of the one or more first groups 24 of fluid channels 12, 14 is complete. The fluid channels 12, 14 are again arranged in rows 27 and columns 29 at the intermediate point 35 at which the second groups 33 are formed or selected.

Referring to FIGS. 20c and 20d, each second group 33 of fluid channels 12, 14 comprises a second subset 28A of the first set C of fluid channels 12. Each second group 33 of fluid channels 12, 14 comprises a second subset 28B of the second set H of fluid channels 14. The second subset 28A of the first set C of fluid channels 12 comprises at least one fluid channel 12, 14 of the first subset 24A of the first set C of fluid channels 12. The second subset 28B of the second set H of fluid channels 14 comprises at least one fluid channel 12, 14 of the first subset 24B of the second set H of fluid channels 14.

The second subset 28A of the first set C of fluid channels 12 comprises only fluid channels 12 of the first row 271 of fluid channels 12 at the first point 7 of the heat exchanger 10N. In the illustrated embodiment, one example second subset 28A of the first set C of fluid channels 12 comprises fluid channels 12ab, 12ae and 12ah. It is noted that each of these fluid channels 12 were aligned in the same row 27 at the first point 7 (shown at plane P1).

The second subset 28B of the second set H of fluid channels 14 comprises only fluid channels 14 of the second row 272 of the second set H of fluid channels 14. In the illustrated embodiment, one example second subset 28B of the second set H of fluid channels 14 comprises fluid channels 14bb, 14be and 14bh. It is noted that each of these fluid channels 14 were aligned in the same row 27 at the first point 7 (shown at plane P1). This example second group 33 comprises only fluid channels 12, 14 from the first row 271 of fluid channels 12 and fluid channels from the second row 272 of fluid channels 14 at the first point 7 of the heat exchanger 10N. That is, this example second group 33 comprises only fluid channels from the first row 271 of fluid channels 12 at the first end 18 of the heat exchanger 10N and fluid channels from the second row 272 of fluid channels 14 at the first end 18 of the heat exchanger 10N.

Each second group 33 of fluid channels 12, 14 comprises more than two fluid channels 12 of the first set C of fluid channels 12. In the illustrated embodiment, each second group 33 of fluid channels 12, 14 comprises three fluid channels 12 of the first set C of fluid channels 12. Each second group 33 of fluid channels 12, 14 comprises more than two fluid channels 14 of the second set H of fluid channels 14. In the illustrated embodiment, each second group 33 of fluid channels 12, 14 comprises three fluid channels 12 of the second set H of fluid channels 12.

It will therefore be appreciated that each second group 33 of fluid channels 12, 14 comprises more than four fluid channels 12, 14. In particular, each second group 33 of fluid channels 12, 14 comprises six fluid channels 12, 14. Each second group 33 of fluid channels 12, 14 comprises three fluid channels 12 of the first set C of fluid channels 12 and three fluid channels 14 of the second set H of fluid channels 14.

Each of the second groups 33 of fluid channels 12, 14 is directed through progressive rotation or twisting about a respective second axis 41. This may be referred to as a second rotation. The second axis 41 is parallel to the direction of flow of fluid through the channels 12, 14. In other words, the second axis 41 extends parallel to the longitudinal direction 13 of the heat exchanger 10N. The second axis 41 is parallel to the first axis 31. The progressive rotation is illustrated in FIGS. 20c and 20d, where the second groups 33 are rotated about respective second axes 41 in a clockwise direction shown by arrow D2. Each second group 33 is rotated about the associated second axis 41 by a second angle of rotation. In the illustrated embodiment, the second angle of rotation is 180°. That is, each second group 33 of fluid channels 12, 14 is rotated about the respective second axis 41 by an angle of 180°. Applying the second rotation to the second groups 33 of fluid channels 12, 14 changes the configuration of the fluid channels 12, 14 from the second configuration 25N to the third configuration 22N.

As described herein, the first angle of rotation is 180° and the second angle of rotation is 180°. In some embodiments, the sum of the first angle of rotation and the second angle of rotation is 360°. The first angle of rotation may be different to 180°. Similarly, the second angle of rotation may be different to 180°.

The reconfiguration of the fluid channels 12, 14 from the second configuration 25N to third configuration 22N occurs over a second length T1,2 of the first transition zone T1. In other words, each of the second groups 33 of fluid channels 12, 14 rotate, about their respective second axis 41, along the second length T1,2 of the first transition zone T1. Following this second rotation, the fluid channels 12, 14 are arranged in the third configuration 22N. The third configuration may be referred to as a heat transfer configuration.

The first length T1,1 of the first transition zone T1 is a different length of the first transition zone T1 than the second length T1,2 of the first transition zone T1. In other words, there is no overlap between the first length T1,1 of the first transition zone T1 and the second length T1,2 of the first transition zone T1. The first length T1,1 of the first transition zone T1 may therefore be said to be distinct from the second length T1,2 of the first transition zone T1. In the illustrated embodiment, the first length T1,1 of the first transition zone T1 is adjacent to the second length T1,2 of the first transition zone T1. That is, the first length T1,1 of the first transition zone T1 is immediately followed by the second length T1,2 of the first transition zone T1. It will be appreciated that in some embodiments, at least part of the second length T1,2 of the first transition zone T1 may overlap with at least part of the first length T1,1 of the first transition zone T1. In some embodiments, there may be an intermediate length of the heat exchanger between the first length T1,1 of the first transition zone T1 and the second length T1,2 of the first transition zone T1.

The first length T1,1 of the first transition zone T1 is about equal in length, in the longitudinal direction 13, to the second length T1,2 of the first transition zone T1. However, in some embodiments, the first length T1,1 of the first transition zone T1 may be of a different length, in the longitudinal direction 13, to the second length T1,2 of the first transition zone T1. For example, the first length T1,1 of the first transition zone T1 may be about twice as long as the second length T1,2 of the first transition zone T1.

Each fluid channel 12, 14 of the second group 33 of fluid channels 12, 14 comprises a respective cross sectional midpoint 43. The cross sectional midpoint 43 may be considered a centroid of the respective fluid channel 12, 14 at a point along its length. The second axis 41 of a respective second group 33 of fluid channels 12, 14 is equidistant from the cross sectional midpoint 43 of each fluid channel 12, 14 of that second group 33 along the second length T1,2 of the first transition zone T1. That is, the distance between the second axis 41 of a respective second group 33 of fluid channels 12, 14 and the cross sectional midpoint 43 of each of the fluid channels 12, 14 of that second group 33 is equal. This distance remains equal throughout the rotation of the second group 33 of fluid channels 12, 14. In some embodiments, the distance between the second axis 41 of a respective second group 33 of fluid channels 12, 14 and the cross sectional midpoint 43 of one or more of the fluid channels 12, 14 of that second group 33 may be different to the distance between the second axis 41 and the cross sectional midpoint 43 of another fluid channel 12, 14 of that second group 33, along at least part of the second length T1,2 of the first transition zone T1.

Referring to FIGS. 20a and 20c, it will be appreciated that the first axis 31 of one or more first group 24 of fluid channels 12, 14 and the second axis 41 of the corresponding second group 33 of fluid channels 12, 14 (i.e. the second group 33 that comprises a number of the fluid channels 12, 14 of a respective first group 24) are parallel. If the first axis 31 and/or the corresponding second axis 41 are extended along their lengths so that one is next to the other, the first axis 31 and the second axis 41 are separated by one or more columns 29 of channels 12, 14 at one or more points along the length of the first transition zone T1. In the illustrated embodiment, the first axes 31 shown in FIG. 20a are separated from their corresponding second axes 41 by one column 29 of fluid channels 12, 14 (the column 27 comprising fluid channels 12ad, 14bd, 12cd, 14dd etc. if the heat exchanger 10N is viewed at the first plane P1). That is, the first axis 31 and the corresponding second axis 41 are separated by one column 29 of fluid channels 12, 14 at at least one point of the first transition zone T1.

Each fluid channel 12, 14 of the second group 33 of fluid channels 12, 14 comprises a respective cross sectional midpoint 43. The cross sectional midpoint 43 may be considered a centroid of the respective fluid channel 12, 14 at a point along its length. In some embodiments, the second axis 41 of a respective second group 33 of fluid channels 12, 14 is equidistant from the cross sectional midpoint 43 of each fluid channel 12, 14 of that second group 33 along at least part of the second length T1,2 of the first transition zone T1. In some embodiments, a distance between the second axis 41 and the cross sectional midpoint 43 of one or more fluid channel 12, 14 of a second group 33 of fluid channels is different to a distance between the second axis 41 and the cross sectional midpoint of one or more other fluid channel 12, 14 of that second group 33 of fluid channels 12, 14 along at least part of the second length T1,2 of the first transition zone T1.

The fluid channels 12, 14 are arranged in the heat transfer configuration at the end of the second length T1,2 of the first transition zone T1. An end of the second length T1,2 of the first transition zone T1 corresponds to a start of the heat transfer zone TZ. As the end of the second length T1,2 of the first transition zone T1 corresponds to an end (i.e. the start) of the heat transfer zone TZ, the fluid channels 12, 14 are arranged in the heat transfer configuration when they reach the heat transfer zone.

The effect of the first rotation and the second rotation is that now mutually adjacent channels 12, 14 of different sets C and H have a different, and in this particular embodiment increased, shared heat transfer length. That is, in the heat transfer configuration, the fluid channels 12, 14 have an increased shared heat transfer length.

As described herein, between the transition zones T1 and T2 there is a heat transfer zone TZ. In the heat transfer zone TZ, the fluid channels 12, 14 are maintained in the third configuration 22N. That is, the fluid channels 12, 14 are maintained in the heat transfer configuration as they extend through the heat transfer zone TZ. To maximise heat transfer, the length of the heat transfer zone TZ should be as long as possible in comparison to the overall flow path length of fluid flowing through the heat exchanger 10N.

At the second end 26 of the heat exchanger 10N, the second end portions E2 are arranged in the first configuration 20N. That is, the fluid channels 12, 14 are arranged in alternating rows 27 of fluid channels 12, 14 of the first set C and the second set H. This configuration 20N is shown in a plane P6 in FIG. 20a. The plane P6 may be referred to as a sixth plane P6. The sixth plane P6 is at a sixth point 51 along the length of the heat exchanger 10N. The sixth point 51 is the second end 26 of the heat exchanger 10N.

Referring to FIG. 19, the heat transfer zone TZ ends at a third intermediate point 47 along the length of the heat exchanger 10N. That is, the heat transfer zone TZ extends between the second intermediate point 37 and the third intermediate point 47 of the heat exchanger 10N. The third intermediate point 47 is a fourth point along the heat exchanger 10N that is specifically shown in FIG. 19. The third intermediate point 47 is closer to the second end 26 than the second intermediate point 37. At the third intermediate point 47, the fluid channels 12, 14 are arranged in the third configuration 22N. This configuration is shown with reference to a fourth plane P4 in FIG. 19. As the fluid channels 12, 14 extend towards the second end 26 of the heat exchanger from the third intermediate point 47, their configuration changes to reverse the configuration changes that occurred in the first transition zone T1.

The reconfiguration of the fluid channels 12, 14 from the third configuration 22N in the heat transfer zone TZ to the first configuration 20N at the second end 26 of the heat exchanger 10N occurs through the second transition zone T2. This reconfiguration can occur in a number of ways, each of which involve reversing the effects of the first rotation and the second rotation of the first transition zone T1.

For example, starting at the third intermediate point 47, the fluid channels 12, 14 of the second groups 33 of fluid channels 12, 14 can be rotated, about their respective second axis 41, in a direction that is opposite to the second direction D2 as they extend towards the second end 26. Rotating the second groups 33 of fluid channels 12, 14 by the second angle of rotation (in this case, 180°) in this direction as they extend towards the second end 26 will reverse the change in configuration caused by the second rotation in the first transfer zone T1. That is, rotating the second groups 33 of fluid channels 12, 14, about their respective second axes 41, by 180°, in a direction that is opposite to the second direction D2, will change the configuration of the fluid channels 12, 14 from the third configuration 22N back to the second configuration 25N. This rotation may be referred to as a third rotation. It will be appreciated that as the rotation is through 180°, rotating in the second direction D2 will also achieve the same outcome.

In the illustrated embodiment, the third rotation occurs over a first length T2,1 of the second transition zone T2. That is, the reconfiguration of the fluid channels 12, 14 from the third configuration 22N to the second configuration 25N occurs over the first length T2,1 of the second transition zone T2. The first length T2,1 of the second transition zone T2 extends between the third intermediate point 47 and a fourth intermediate point 49 along the length of the heat exchanger 10N. The first length T2,1 of the second transition zone T2 is between the heat transfer zone TZ and the second end 26 of the heat exchanger 10N. The described rotation of the relevant groups of fluid channels 12, 14 along the first length T2,1 of the second transition zone T2 results in the fluid channels 12, 14 being in the second configuration 25N fourth intermediate point 49. This configuration is shown with reference to a fifth plane P5 in FIG. 19.

The fluid channels 12, 14 of the first groups 24 of fluid channels 12, 14 can be further rotated, about their respective first axis 31, in a direction that is opposite to the first direction D1, along a second length T2,2 of the second transition zone T2. Rotating the first groups 24 of fluid channels 12, 14 by the first angle of rotation (in this case, 180°) in this direction will reverse the change in configuration caused by the first rotation in the first transfer zone T1. That is, rotating the first group 24 of fluid channels 12, 14 about their respective first axis 31, by 180°, in a direction that is opposite to the first direction D1, along the second length T2,2 of the second transition zone T2, will change the configuration of the fluid channels 12, 14 from the second configuration 25N back to the first configuration 20N. It will be appreciated that a 180° rotation in the first direction D1 will also achieve the same result. Following these rotations, the fluid channels 12, 14 will then be arranged in the first configuration 20N at the second end 26 of the heat exchanger 10N. This configuration is shown with reference to the sixth plane P6 in FIG. 19.

The first transition zone T1 is equal in length, in the longitudinal direction 13, to the second transition zone T2. In some embodiments, the first transition zone T1 may be longer, in the longitudinal direction 13, than the second transition zone T2. In some embodiments, the first transition zone T1 may be shorter, in the longitudinal direction 13, than the second transition zone T2.

The heat transfer zone TZ may be of a specified length with respect to one or both of the first transition zone T1 and the second transition zone T2. In the illustrated embodiment, the heat transfer zone TZ is longer than the first transition zone T1 and the second transition zone T2. In some embodiments, the heat transfer zone TZ is longer, in the longitudinal direction 13, than the first transition zone T1. In some embodiments, the heat transfer zone TZ is shorter, in the longitudinal direction 13, than the first transition zone T1. In some embodiments, the heat transfer zone TZ is longer, in the longitudinal direction 13, than the second transition zone T2. In some embodiments, the heat transfer zone TZ is shorter, in the longitudinal direction 13, than the second transition zone T2.

In some embodiments, the heat transfer zone TZ extends for at least one quarter of the length, in the longitudinal direction 13, of the heat exchanger 10N. That is, in at least one example, the channels 12, 14 are maintained in the third configuration 22N, i.e. where the reorientated groups are maintained in their transposed positions, for a length of at least one quarter of the length of the fluid flow path through the heat exchanger 10N.

The first end portions E1C of channels 12 in the first set C may be, or are otherwise connected to, outlets while the first end portions E1H of the channels 14 in the second set H may be, or are otherwise connected to, inlets. Conversely the second end portions E2C the first of channels 12 in the first set C may be inlets while the second end portions E2H of the channels 14 in the second set H may be outlets. With this arrangement of inlets and outlets the heat exchanger 10N are arranged such that the heat exchanger 10N is a counter flow heat exchanger.

In an alternate embodiment it is possible to arrange the first end portions E1 of both sets C, H of fluid channels 12, 14 to be inlets and the second end portions E2 to of the fluid channels 12, 14 to be outlets in which event the heat exchanger 10N would be a parallel or concurrent flow heat exchanger. However, this arrangement may have less thermal efficiency than the counter-flow heat exchanger.

In the third configuration 22N, at least some of the fluid channels 12, 14 may be considered to be in a chequerboard configuration (alternating hot and cold channels in both axes). The chequerboard configuration may be referred to as a chequerboard arrangement. When the fluid channels 12, 14 are arranged in the heat transfer configuration, at least some of the fluid channels 12, 14 are arranged in the chequerboard configuration.

It will be appreciated that the number of first groups 24 that is formed or selected is proportional to the total number of channels 12, 14 of the heat exchanger 10N.

In some embodiments, the cross-sectional shape of one or more of the fluid channels 12, 14 may change along at least part of the first transition zone T1. This change may occur along a third length of the first transition zone T1 as described with reference to the heat exchanger 10N of FIGS. 17 to 18b.

Further, the cross-sectional shape of one or more of the fluid channels 12, 14 may change along at least part of the second transition zone T2. This change may be to reverse a change in cross sectional shape that occurs along at least part of the first transition zone T1. This change may occur along a third length of the second transition zone T2 as described with reference to the heat exchanger 10N of FIGS. 17 to 18b (it will be appreciated that the third length mentioned here may be equivalent to the first length T2,1 of the second transition zone T2 of FIG. 17).

### Relative Linear Translation and Change of Cross-Sectional Shape

### Heat Exchanger 10P

There are alternative ways of reconfiguring the channels 12, 14 of the first set C and the second set H so that the total shared heat transfer length at the first end and/or the second end of the heat exchanger is different to the total shared heat transfer length along the heat transfer zone to control heat transfer between fluids and to optimise the profile of the fluid channels 12, 14 for their respective fluids.

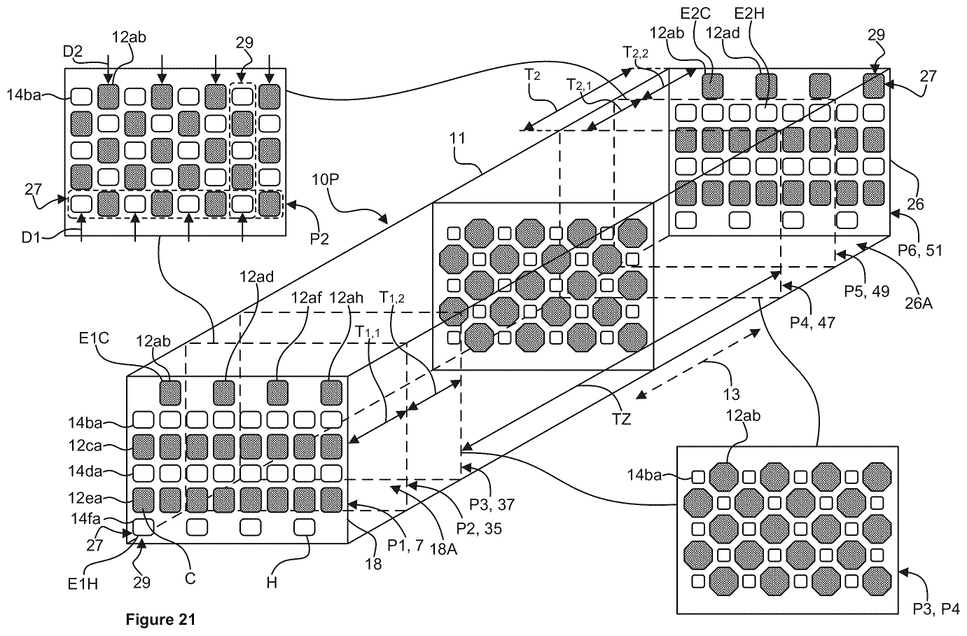

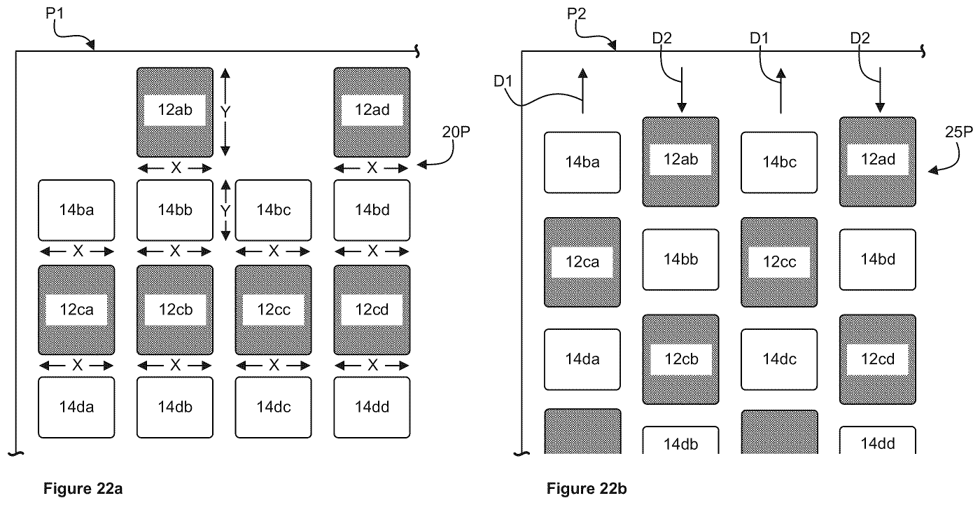

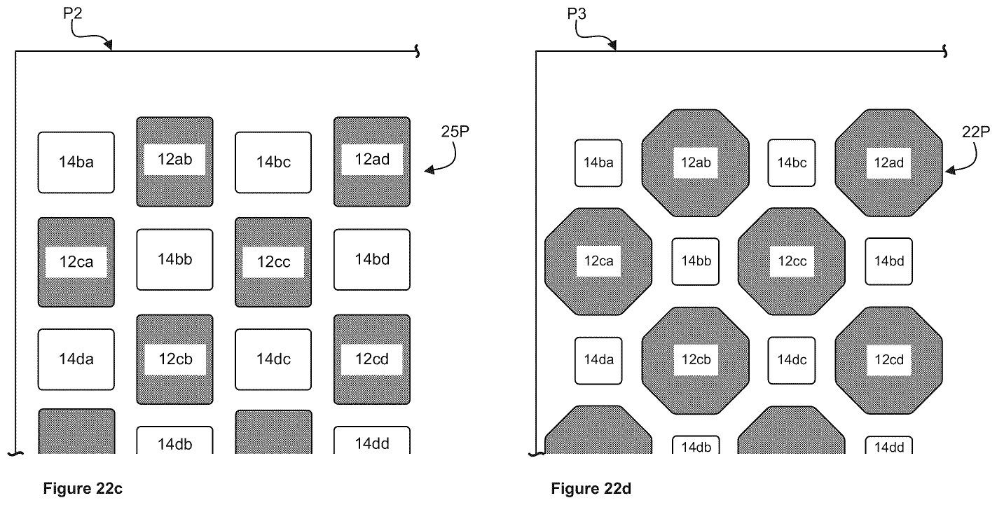

An alternative heat exchanger 10P is shown in FIGS. 21 to 22d. One or more features of the heat exchanger 10P may be the same as, or similar to, one or more features of one or more of the other heat exchangers disclosed herein. However, as described herein, it will be appreciated that one or more features of the heat exchanger 10P is different to one or more features of other heat exchangers described herein.

The heat exchanger 10P extends from a first end 18 to a second end 26. The heat exchanger 10P comprises a first end portion 18A. The first end portion 18A comprises the first end 18 of the heat exchanger 10P. The first end 18 may be considered a longitudinal end of the heat exchanger 10P. The heat exchanger 10P comprises a second end portion 26A. The second end portion 26A comprises the second end 26 of the heat exchanger 10P. The second end 26 may be considered a longitudinal end of the heat exchanger 10P.

The heat exchanger 10P comprises a body 11. The body 11 defines the first end 18 and the second end 26. The body 11 extends from the first end 18 of the heat exchanger 10P to the second end 26 of the heat exchanger 10P in a longitudinal direction 13 of the heat exchanger 10P.

The heat exchanger 10P comprises a plurality of fluid channels 12, 14. The plurality of fluid channels 12, 14 comprises a first set C of fluid channels 12. The plurality of fluid channels 12, 14 comprises a second set H of fluid channels 14. The fluid channels 12, 14 extend through a body 11 of the heat exchanger 10P. The fluid channels 12, 14 are again arranged in a first configuration 20P at the first end 18 of the heat exchanger 10P. Specifically, the fluid channels 12, 14 are arranged in alternating rows 27 (which may also be referred to as alternating planes), as the fluid channels 12, 14 extend into the body 11 of the heat exchanger 10P. The number of rows 27 of the first set C of fluid channels 12 is equal to the number of rows 27 of the second set H of fluid channels 14. The heat exchanger 10P comprises a first transition zone T1. The first transition zone T1 is disposed at or near the first end 18 of the heat exchanger 10P. In some embodiments, the first transition zone T1 may be said to comprise the first end 18 of the heat exchanger 10P. The first transition zone T1 extends along a length of the heat exchanger 10P. In some embodiments, the first end portion 18A of the heat exchanger 10P is the first transition zone T1. One or more of the fluid channels 12, 14 extends through the first transition zone T1. In the illustrated embodiment, each fluid channel 12, 14 extends through the first transition zone T1.

The configuration of the fluid channels 12, 14 changes through at least part of the first transition zone T1. A position of one or more of the fluid channels 12, 14 changes with respect to a position of another one or more of the fluid channels 12, 14 through at least part of the first transition zone T1. A shape of one or more of the fluid channels 12, 14 changes across at least part of the first transition zone T1. Therefore, the change in configuration of the fluid channels 12, 14 across the first transition zone T1 comprises both a change in relative position of one or more fluid channels 12, 14 and a change in shape of one or more fluid channels 12, 14.

The heat exchanger 10P comprises a heat transfer zone TZ. The heat transfer zone TZ may be referred to as an intermediate zone of the heat exchanger 10P. The heat transfer zone TZ extends along a length of the heat exchanger 10P. One or more of the fluid channels 12, 14 extends through the heat transfer zone TZ. In the illustrated embodiment, each fluid channel 12, 14 extends through the heat transfer zone TZ. The heat transfer zone TZ is adjacent to the first transition zone T1.

The heat exchanger 10P comprises a second transition zone T2. The second transition zone T2 is disposed at or near the second end 26 of the heat exchanger 10P. In some embodiments, the second transition zone T2 may be said to comprise the second end 26 of the heat exchanger 10P. The second transition zone T2 extends along a length of the heat exchanger 10P. In some embodiments, the second end portion 26A is the second transition zone T2. One or more of the fluid channels 12, 14 extends through the second transition zone T2. In the illustrated embodiment, each fluid channel 12, 14 extends through the second transition zone T2. In the illustrated embodiment, each fluid channel 12, 14 extends through the first transition zone T1, the heat transfer zone TZ and the second transition zone T2. The heat transfer zone TZ is between the first transition zone T1 and the second transition zone T2.

The configuration of the fluid channels 12, 14 changes through at least part of the second transition zone T2. A position of one or more of the fluid channels 12, 14 changes with respect to a position of another one or more of the fluid channels 12, 14 through at least part of the second transition zone T2. A shape of one or more of the fluid channels 12, 14 may change across at least part of the second transition zone T2. The heat transfer zone TZ is adjacent to the second transition zone T2. In particular, the heat transfer zone TZ is between the first transition zone T2 and the second transition zone T2.

The heat exchanger 10P comprises a plurality of sets C, H of fluid channels 12, 14. Each set C, H comprises a plurality of respective fluid channels 12, 14. In the illustrated embodiment, there are two sets C, H of fluid channels 12, 14. That is, the heat exchanger 10P comprises a first set C of fluid channels 12. The heat exchanger 10P comprises a second set H of fluid channels 14. The second set H of fluid channels 14 comprises a plurality of fluid channels 14.

The first set C of fluid channels 12 comprises a first number of fluid channels 12. The second set H of fluid channels 14 comprises a second number of fluid channels 14. In the illustrated embodiment, the first number of fluid channels 12 is equal to the second number of fluid channels 14. It will be appreciated that in some embodiments, the first number of fluid channels 12 may be different to the second number of fluid channels 14. For example, the first number of fluid channels 12 may be greater than the second number of fluid channels. Alternatively, the second number of fluid channels 14 may be greater than the first number of fluid channels 12.

Each of the fluid channels 12 of the first set C has a respective first end portion E1C. Each of the fluid channels 12 of the first set C has a respective second end portion E2C. Each of the fluid channels 14 of the second set H has a respective first end portion E1H. Each of the fluid channels 14 of the second set H has a respective second end portion E2H. Hereinafter, the first end portions E1C, E1H and the second end portions E2C, E2H may be collectively, and in general, referred to as “first end portions E1” and “second end portions E2” respectively. Further, for ease of description, the end portions in a general sense, whether they be the first end portions or the second end portions, may be referred to hereafter as “end portions E”.

The first end portions E1 extend from the first end 18 of the heat exchanger 10P, along a first portion of the length of the heat exchanger 10P, towards the second end 26 of the heat exchanger 10P. The first end portion E1 of each fluid channel 12, 14 extends through at least part of the first transition zone T1. In some embodiments, the first end portion E1 of each fluid channel 12, 14 is the portion of the fluid channel 12, 14 that extends through the first transition zone T1. That is, the portion of a respective fluid channel 12, 14 that is within the first transition zone T1 may be considered the first end portion E1 of that fluid channel 12, 14.

In some embodiments, a respective end of one of the fluid channels 12, 14 may be considered the end portion E1 of that fluid channel 12, 14. That is, the point of a respective fluid channel 12, 14 that is at the first end 18 of the heat exchanger 10P may be considered the first end portion E1 of that fluid channel 12, 14.

The second end portions E2 extend from the second end 26 of the heat exchanger 10P, along a second portion of the length of the heat exchanger 10P, towards the first end 18 of the heat exchanger 10P. The second end portion E2 of each fluid channel 12, 14 extends through at least part of the second transition zone T2. In some embodiments, the second end portion E2 of each fluid channel 12, 14 is the portion of the fluid channel 12, 14 that extends through the second transition zone T2. That is, the portion of a respective fluid channel 12, 14 that is within the second transition zone T2 may be considered the second end portion E2 of that fluid channel 12, 14.

In some embodiments, a respective end of one of the fluid channels 12, 14 may be considered the end portion E2 of that fluid channel 12, 14. That is, the point of a respective fluid channel 12, 14 that is at the second end 26 of the heat exchanger 10P may be considered the first end portion E1 of that fluid channel 12, 14.

In between the end portions E, each fluid channel 12, 14 has an intermediate portion 16C, 16H respectively. That is, the fluid channels 12 of the first set C have respective intermediate portions 16C. Similarly, the fluid channels 14 of the second set H have respective intermediate portions 16H. Hereinafter, the intermediate portions 16C, 16H may be referred to collectively, and in general, as “intermediate portions 16”.

The intermediate portion 16 of each fluid channel 12, 14 bridges the first end portion E1 and the second end portion E2 of that fluid channel 12, 14. That is, the intermediate portion 16 of a fluid channel 12, 14 extends from an inner end of the first end portion E1 of that fluid channel 12, 14 to an inner end of the second end portion E2 of that fluid channel 12, 14. The intermediate portion 16 of each fluid channel 12, 14 extends through at least part of the heat transfer zone TZ. In some embodiments, the intermediate portion 16C, 16H of each fluid channel 12, 14 is the portion of the fluid channel 12, 14 that extends through the heat transfer zone TZ.

The fluid channels 12, 14 are aligned into a number of rows 27 and a number of columns 29 at one or more points along the length of the heat exchanger 10P. In particular, the end portions E1, E2 of the fluid channels 12, 14 are arranged in rows 27 of fluid channels 12, 14 at each of the first end 18 and the second end 26. Each row 27 of fluid channels 12, 14 at the first end portion 18 and the second end portion comprises only fluid channels 12, 14 from one set C, H of fluid channels 12, 14. In other words, each row 27 of fluid channels 12, 14 comprises either only fluid channels 12 from the first set C of fluid channels 12 or only fluid channels 14 from the second set H of fluid channels 14.

The fluid channels 12, 14 are arranged in a plurality of columns 29 at each of the first end 18 and the second end 26 of the heat exchanger 10P. Each of these columns 29 comprises fluid channels 12, 14 from the first set C and fluid channels from the second set H.

In the illustrated embodiment, an outer end of the first end portion E1C of one or more of the fluid channels 12 of the first set C of fluid channels 12 is disposed between a first adjacent row and a second adjacent row. For example, fluid channel 12ca is disposed between a row 27 comprising fluid channel 14ba and a row 27 comprising fluid channel 14da. This fluid channel 12 is therefore disposed between two rows 27 of fluid channels 14 of the second set H of fluid channels 14. More generally, fluid channels 12 of the first set C are disposed between rows of fluid channels 14 of the second set H, at the first end 18 and the second end 26. Similarly, fluid channels 14 of the second set H are disposed between rows 27 of fluid channels 12 of the first set C, at the first end 18 and the second end 26.

As described herein, the number of rows 27 of the first set C of fluid channels 12 is equal to the number of rows 27 of the second set H of fluid channels 14. However, the top row 27 and bottom row 27 of fluid channels 14, 12 at the first end 18 of the heat exchanger 10P comprise a reduced number of fluid channels 12, 14 relative to other rows 27 of the heat exchanger 10P at the first end 18.

In the illustrated embodiment, the top row 27 of fluid channels 12 comprises only four fluid channels 12 and the bottom row 27 of fluid channels 14 comprises only four fluid channels 14; compared to the eight fluid channels 12, 14 of other rows 27 at the first end 18. In other words, the top row 27 of fluid channels 12 at the first end 18 comprises half the number of fluid channels 12 as the intermediate rows 27 of fluid channels 12, 14 at the first end 18. Similarly, the bottom row 27 of fluid channels 14 at the first end 18 comprises half the number of fluid channels 14 as the intermediate rows 27 of fluid channels 12, 14. It will be understood that the intermediate rows 27 are the rows 27 that are between the top row 27 and the bottom row 27.

In this embodiment, each of the fluid channels 12, 14 has a cross sectional shape in the form of a rounded rectangle with side lengths X and Y at the first end 18. In the first configuration 20P in plane P1 at the first end 18, the total first shared heat transfer length is 32X. This is made up as follows:
between the rows commencing with the channels 14ba and 12ca there is a shared heat transfer length of 8X,
between the rows commencing with the channels 12ca and 14da there is a shared heat transfer length of 8X,
between the rows commencing with the channels 14da and 12ea there is a shared heat transfer length of 8X,
between the rows commencing with the channels 12ab and 14ba there is a shared heat transfer length of 4X, and
between the rows commencing with the channels 12ea and 14fa there is a shared heat transfer length of 4X.

Hence the summation of the length of mutually opposed perimeters of channels in the different sets C and H is: 8X+8X+8X+4X+4X=32X.

Each fluid channel 12, 14 defines a cross-sectional shape at each point along its length. The cross-sectional shape of a respective fluid channel 12, 14 at a point along its length is viewed perpendicular to a direction of flow of fluid through the heat exchanger 10P. The cross-sectional shape of a respective fluid channel 12, 14 at a point along its length encloses a cross-sectional area of that fluid channel 12, 14 at that point.

Each fluid channel 12, 14 defines a first outer end cross-sectional shape enclosing a first outer end cross-sectional area. In particular, the first outer end cross-sectional shape is defined by the first outer end of the fluid channel 12, 14 (i.e. the end of the fluid channel 12, 14 at the first end 18 of the heat exchanger 10P). In other words, the first outer end cross sectional shape of one of the fluid channels 12, 14 is a shape of the respective fluid channel 12, 14 at the outer end of the first end portion E1 of that fluid channel 12, 14. Each fluid channel 12, 14 defines a second outer end cross-sectional shape enclosing a second outer end cross-sectional area. In particular, the second outer end cross-sectional shape is defined by the second outer end of the fluid channel 12, 14 (i.e. the end of the fluid channel 12, 14 at the second end 26 of the heat exchanger 10P). In other words, the second outer end cross sectional shape of one of the fluid channels 12, 14 is a shape of the respective fluid channel 12, 14 at the outer end of the second end portion E2 of that fluid channel 12, 14.

In some embodiments, the first outer end cross sectional area of one or more of the first set C of fluid channels 12 is greater than the first outer end cross sectional area of one or more of the second set H of fluid channels 14. This is the case in FIG. 19. Specifically, the area of a fluid channel 12 of the first set C is greater than the area of a fluid channel 14 of the second set H at the first end 18.

In some embodiments, the second outer end cross sectional area of one or more of the first set C of fluid channels 12 is greater than the second outer end cross sectional area of one or more of the second set H of fluid channels 14. Again, this is the case in FIG. 19.

Specifically, the area of a fluid channel 12 of the first set C is greater than the area of a fluid channel 14 of the second set H at the second end 26.

In some embodiments, the first outer end cross sectional area of one or more of the first set C of fluid channels 12 is the same as the first outer end cross sectional area of one or more of the second set H of fluid channels 14. In some embodiments, the second outer end cross sectional area of one or more of the first set C of fluid channels 12 is the same as the second outer end cross sectional area of one or more of the second set H of fluid channels 14.

Each fluid channel 12, 14 defines an intermediate cross-sectional shape enclosing an intermediate cross-sectional area. The intermediate cross-sectional shape of one of the fluid channels 12, 14 is a cross-sectional shape of the respective fluid channel 12, 14 along at least part of the heat transfer zone TZ.

In the illustrated embodiment, the intermediate cross sectional areas of the fluid channels 12 of the first set C of fluid channels are greater than the intermediate cross-sectional areas of the fluid channels 14 of the second set of fluid channels 14. In some embodiments, however, the intermediate cross sectional area of one or more of the fluid channels 14 of the second set H of fluid channels 14 is greater than the intermediate cross sectional area of one or more of the fluid channels 12 of the first set C of fluid channels 12.

The first outer end cross-sectional shape, second outer end cross sectional shape and/or the intermediate cross sectional shape of one or more of the fluid channels 12, 14 may be a rounded rectangle, a rounded hexagon, a rounded octagon, or a polygon.

In some embodiments, first outer end cross-sectional shape, second outer end cross sectional shape and/or the intermediate cross-sectional shape of one or more of the first set C of fluid channels 12 and/or one or more of the second set H of fluid channels is a mirror image of the shape of another of the first set C or second set H of fluid channels 12, 14, is symmetric about a first axis of symmetry and/or is asymmetric about a second axis of symmetry. In some embodiments, first outer end cross-sectional shape, second outer end cross sectional shape and/or the intermediate cross-sectional shape of one or more of the first set C of fluid channels 12 and/or one or more of the second set H of fluid channels comprises one or more straight sides and one or more curved sides.

It will be noted that at the first end 18, the cross-sectional shape of the fluid channels 12 of the first set C is different to the cross sectional shape of the fluid channels 14 of the second set H. The cross sectionals shape of each fluid channel 12 of the first set C has a major dimension and a minor dimension at the first end 18. Referring to FIG. 22a major dimension is in the Y direction and the minor dimension is in the X direction. The cross sectional shape of each fluid channel 14 of the second set H has a major dimension and a minor dimension at the first end 18. Referring to FIG. 22a major dimension is in the X direction and the minor dimension is in the Y direction. In other words, the major dimension of the fluid channels 14 of the second set H is orthogonal to the major dimension of the fluid channels 12 of the first set H at the first end 18 of the heat exchanger 10P. This is the same at the second end 26. In some embodiments, the cross sectional shape of one or more fluid channel 12, 14 has a major dimension along at least part of its length. The major dimension may be said to be a maximum cross-sectional dimension of the respective fluid channel 12, 14. In some embodiments, the cross sectional shape of one or more fluid channel 12, 14 has a minor dimension along at least part of its length. The minor dimension may be said to be a minimum cross-sectional dimension of the respective fluid channel 12, 14. The major dimension of a fluid channel 12, at a particular point along the length of the fluid channel 12, 14, may be measured along a major axis of the respective fluid channel 12, 14 at that particular point. Similarly, the minor dimension of a fluid channel 12, 14, at a particular point along the length of the fluid channel 12, 14, may be measured along a minor axis of the respective fluid channel 12, 14. The major axis and the minor axis of one or more fluid channel 12, 14 may be orthogonal at one or more points along the length of the fluid channel 12, 14.

The major dimension of one or more of the fluid channels 12 of the first set of fluid channels C may be different to the major dimension of one or more of the fluid channels 14 of the second set of fluid channels H, at one or more points along the length of the heat exchanger 10P. The major dimension of one or more of the fluid channels 12 of the first set of fluid channels C may be greater than the major dimension of one or more of the fluid channels 14 of the second set of fluid channels H, at one or more points along the length of the heat exchanger 10P. The major dimension of one or more of the fluid channels 12 of the first set of fluid channels C may be less than the major dimension of one or more of the fluid channels 14 of the second set of fluid channels H, at one or more points along the length of the heat exchanger 10P. The minor dimension of one or more of the fluid channels 12 of the first set of fluid channels C may be greater than the minor dimension of one or more of the fluid channels 14 of the second set of fluid channels H, at one or more points along the length of the heat exchanger 10P. The minor dimension of one or more of the fluid channels 12 of the first set of fluid channels C may be less than the minor dimension of one or more of the fluid channels 14 of the second set of fluid channels H, at one or more points along the length of the heat exchanger 10P. The major dimension of one or more of the fluid channels 12 of the first set of fluid channels C may be equal to the major dimension of one or more of the fluid channels 14 of the second set of fluid channels H, at one or more points along the length of the heat exchanger 10P. The major dimension of one or more of the fluid channels 12 of the first set of fluid channels C may be equal to the minor dimension of one or more of the fluid channels 14 of the second set of fluid channels H, at one or more points along the length of the heat exchanger 10P. The minor dimension of one or more of the fluid channels 12 of the first set of fluid channels C may be equal to the major dimension of one or more of the fluid channels 14 of the second set of fluid channels H, at one or more points along the length of the heat exchanger 10P. The minor dimension of one or more of the fluid channels 12 of the first set of fluid channels C may be equal to the minor dimension of one or more of the fluid channels 14 of the second set of fluid channels H, at one or more points along the length of the heat exchanger 10P.

In this embodiment, a number of the fluid channels 12, 14 are directed through a translation along a first length T1,1 of the first transition zone T1, such that a position of the translated fluid channels 12, 14 changes. In other words, a first group of fluid channels translates, along at least part of the first transition zone T1, relative to a second group of fluid channels 12, 14. The translation of fluid channels 12, 14 changes the configuration of the fluid channels 12, 14 from the first configuration 20P to a second configuration 25P. That is, the configuration of the fluid channels 12, 14 changes from the first configuration 20P to the second configuration 25P in the first transition zone T1.

The second configuration 25P is shown with reference to a second plane P2, in FIGS. 21 and 22b. The second plane P2 is orthogonal to the longitudinal direction 13. The second plane P2 is parallel to the first plane P1. The second plane P2 is longitudinally displaced with respect to the first plane P1. In particular, the second plane P2 is between the first plane P1 and the second end portions E2 of the fluid channels 12, 14. The second plane P2 is at an intermediate point 35 along the length of the heat exchanger 10P. The intermediate point 35 is between the first end 18 and the second end 26. In particular, the intermediate point 35 is within the first transition zone T1.

The translation of fluid channels 12, 14 along the first length T1,1 of the first transition zone T1 is such that at the end of the first length T1,1 of the first transition zone T1, the fluid channels 12, 14 are again arranged in rows 27 and columns 29. When the fluid channels 12, 14 are in the second configuration 25P, the cross-sectional midpoint 19 of a fluid channel 12, 14 of a particular row 27 is colinear with the cross sectional midpoints 19 of each other fluid channel 12, 14 in that row 27. Similarly, the cross sectional midpoint 19 of a fluid channel 12, 14 of a respective column 29 is colinear with the cross sectional midpoints 19 of each other fluid channel 12, 14 in that column 29.

Therefore, at the intermediate point 35 along the length of the heat exchanger 10P, the fluid channels 12, 14 of each row 27 alternate between fluid channels 12 of the first set C and fluid channels 14 of the second set H. Similarly, the fluid channels 12, 14 of each column 29 alternate between fluid channels 12 of the first set C and fluid channels 14 of the second set H. The fluid channels 12, 14 at the intermediate point 35 may be said to be in a chequerboard configuration. This may be considered to be the case even though the fluid channels 12 of the first set 14 are a different size to the fluid channels 14 of the second set H.

In order to change the configuration of the fluid channels 12, 14 from the first configuration 20P to the second configuration 25P, a plurality of the fluid channels 12, 14 are translated in a first direction D1 as they extend through the first transition zone T1. The plurality of channels 12, 14 that translate in the first direction D1 may be considered the first group of channels 12, 14. In the embodiment of FIGS. 21 to 22d, alternating columns 29 of fluid channels 12, 14 are translated in the first direction D1, along the first length T1,1 of the first transition zone T1. In other words, the first group of channels 12, 14 comprises alternating columns 29 of fluid channels 12, 14, identified at the first end 18. That is, the first group of channels 12, 14 comprises every second column 29 of fluid channels 12, 14. In the illustrated embodiment, the first direction D1 is an upward direction. This translation moves the relevant fluid channels 12, 14 with respect to the fluid channels 12, 14 of the other columns 29.

Each fluid channel 12, 14 of the first group of fluid channels 12, 14 may translate orthogonally to the direction of fluid flow by a distance that is greater than a minor dimension of the respective fluid channel 12, 14. Each fluid channel 12, 14 of the first group of fluid channels 12, 14 may translate orthogonally to the direction of fluid flow by a distance that is greater than a major dimension of the respective fluid channel 12, 14. Each fluid channel 12, 14 of the first group of fluid channels 12, 14 may translate orthogonally to the direction of fluid flow by a distance that is greater than a minor dimension of an adjacent fluid channel 12, 14. Each fluid channel 12, 14 of the first group of fluid channels 12, 14 may translate orthogonally to the direction of fluid flow by a distance that is greater than a major dimension of an adjacent fluid channel 12, 14.

In addition to the above translation, another plurality of the fluid channels 12, 14 are translated in a second direction D2, along at least part of the first transition zone T1. In particular, the other group of alternating columns 29 of fluid channels 12, 14 are translated in the second direction D2, along the first length T1,1 of the first transition zone T1. The second direction D2 is opposite the first direction D1. In the illustrated embodiment, the first direction D1 is a downward direction. This translation moves the relevant fluid channels 12, 14 with respect to the fluid channels 12, 14 of the other columns 29.

It will be appreciated that in some embodiments, translations of mutually exclusive columns 29 in different directions D1, D2 are not necessary. For example, one group of alternating columns 29 may simply translate in the first direction D1 until the fluid channels 12, 14 are in the second configuration 25P at the intermediate point 35. That is, one group of alternating columns 29 may translate in the first direction D1, as they extend along the first length T1,1 of the first transition zone T1, until the fluid channels 12, 14 are again aligned in rows 27 and columns 29. Alternatively, one group of alternating columns 29 may translate in the second direction D2 until the fluid channels 12, 14 are arranged in the second configuration 25P. That is, one group of alternating columns 29 may translate in the second direction D2, as they extend along the first length T1,1 of the first transition zone T1, until the fluid channels 12, 14 are again aligned in rows 27 and columns 29.

Subsequent the translations, the fluid channels 12, 14 are arranged in a new set of rows 27 and columns 29. Thus, each fluid channel of the first group and/or the second group of fluid channels 12, 14 translates such that it is aligned in a row 27 with a fluid channel 12 of which it's outer end (i.e. it's portion at the first end 18) was previously unaligned.

The total shared heat transfer length at the intermediate point 35 is greater than the total shared heat transfer length at the first end 18 of the heat exchanger 10P. As is apparent from FIGS. 21 and 22b, rather than just sharing a heat transfer length along an X axis is was the case at the first end 18, at the intermediate point 35, the fluid channels 12, 14 also share heat transfer lengths in a Y direction. The total shared heat transfer length between the first set C of fluid channels 12 and the second set H of fluid channels 14 may therefore be said to increase as the fluid channels 12, 14 approach the heat transfer zone TZ.

The cross sectional shape of each fluid channel 12 of the first set C of fluid channels 12 changes from a first cross sectional shape to a second cross sectional shape along a second length T1,2 of the first transition zone T1 as the fluid channels 12, 14 extend towards the heat transfer zone TZ. In other words, a cross sectional shape of one or more of the plurality of fluid channels 12, 14 changes, along at least part of the first transition zone T1. The cross-sectional shape may be viewed perpendicular to a direction of flow of fluid through the heat exchanger 10P.

In particular, the cross-sectional shape of each fluid channel 12 of the first set C of fluid channels 12 changes from a rounded rectangle to an octagonal shape at the end of the first transition zone T1. The octagonal shape may be an octagon. The octagonal shape may be a rounded octagon. With such a change, an area of the cross sectional shape of the fluid channels 12 of the first set C of fluid channels 12 increases as the fluid channels 12 approach the heat transfer zone TZ. This change is shown at planes P2 and P3 in FIGS. 22c and 22d.

The cross-sectional shape of each fluid channel 14 of the second set H of fluid channels 14 also changes along the second length T1,2 of the first transition zone T1. In particular, the cross sectional shape of each fluid channel 14 of the second set H of fluid channels 14 changes from a first cross-sectional shape to a second cross sectional shape along the second length T1,2 of the first transition zone T1 as the fluid channels 12, 14 extend towards the heat transfer zone TZ. The cross sectional shape of each fluid channel 14 of the second set H of fluid channels 14 changes from a rounded rectangle to a smaller rounded rectangle at the end of the first transition zone T1. With such a change, an area of the cross sectional shape of the fluid channels 14 of the second set H of fluid channels 14 decreases as the fluid channels 14 approach the heat transfer zone TZ.

The first length T1,1 of the first transition zone T1 is distinct from the second length T2,1 of the first transition zone T1. The second length T2,1 of the first transition zone may overlap at least part of the first length T1,1 of the first transition zone T1.

The changes in shape of the fluid channels 12, 14 result in the configuration of fluid channels 12, 14 changing from the second configuration 25P at the intermediate point 35 along the length of the heat exchanger 10P to a third configuration 22P at the end of the first transition zone T1/start of the heat transfer zone TZ. In other words, the configuration of the fluid channels 12, 14 changes from the second configuration 25P to the third configuration 22P as the fluid channels 12, 14 extend from the intermediate point 35 to a second intermediate point 37 along the length of the heat exchanger 10P. In this case, the third configuration 22P may be considered the heat transfer configuration. In other words, when the fluid channels 12, 14 reach the heat transfer zone TZ, the first set C of fluid channels 12 and the second set H of fluid channels 14 are arranged in the heat transfer configuration.

The total shared heat transfer length between the first set C of fluid channels 12 and the second set H of fluid channels 14 may increase as a result in the change of shape of the fluid channels 12 of the first set C and the fluid channels 14 of the second set H along the second length T1,2 of the first transition zone T1. Thus, a total shared heat transfer length between the first set C of fluid channels 12 and the second set H of fluid channels 14 may increase as the fluid channels 12, 14 approach the heat transfer zone TZ.

The fluid channels 12, 14 maintain the third configuration 22P through the heat transfer zone TZ. In other words, the fluid channels 12 of the first set C and the fluid channels 14 of the second set H are arranged in the heat transfer configuration as they extend through the heat transfer zone TZ. The cross-sectional shape of each fluid channel 12, 14 is constant across the heat transfer zone TZ. The heat transfer zone TZ extends between the second intermediate point 37 and a third intermediate point 47 along the length of the heat exchanger 10P. The fluid channels 12, 14 remain in the third configuration between the second intermediate point 37 and the third intermediate point 47.

Like with other embodiments described herein, the changes in configuration of the fluid channels 12, 14 that occur in the first transition zone T1 are reversed in the second transition zone T2. The cross-sectional shapes of one or more of the fluid channels 12, 14 change along a first length T2,1 of the second transition zone T2. The first length T2,1 of the second transition zone T2 extends between the third intermediate point 47 and a fourth intermediate point 49 along the length of the heat exchanger 10P.

The cross sectional shapes of the fluid channels 12, 14 change from the third configuration 22P (shown at plane P4 in FIG. 21) at the third intermediate point 47 along the length of the heat exchanger 10P, such that the fluid channels 12, 14 are arranged in the second configuration 25P at the fourth intermediate point 49 along the length of the heat exchanger 10P (shown at plane P5 in FIG. 21). This fourth intermediate point 49 is between the end of the heat transfer zone TZ that is closest to the second end 26 of the heat exchanger 10P and the second end 26 of the heat exchanger 10P.

Following this reversion in channel 12, 14 configuration to the second configuration 25P, a number of the fluid channels 12, 14 translate as they extend along a second length T2,2 of the second transition zone T2, such that the configuration of fluid channels 12, 14 changes from the second configuration 25P at the fourth intermediate point 49 to the first configuration 20P at the second end 26 of the heat exchanger 10P (shown at plane P6 in FIG. 21).

### Fluid Channel Positional Translation and Change of Shape

### Heat Exchanger 10Q

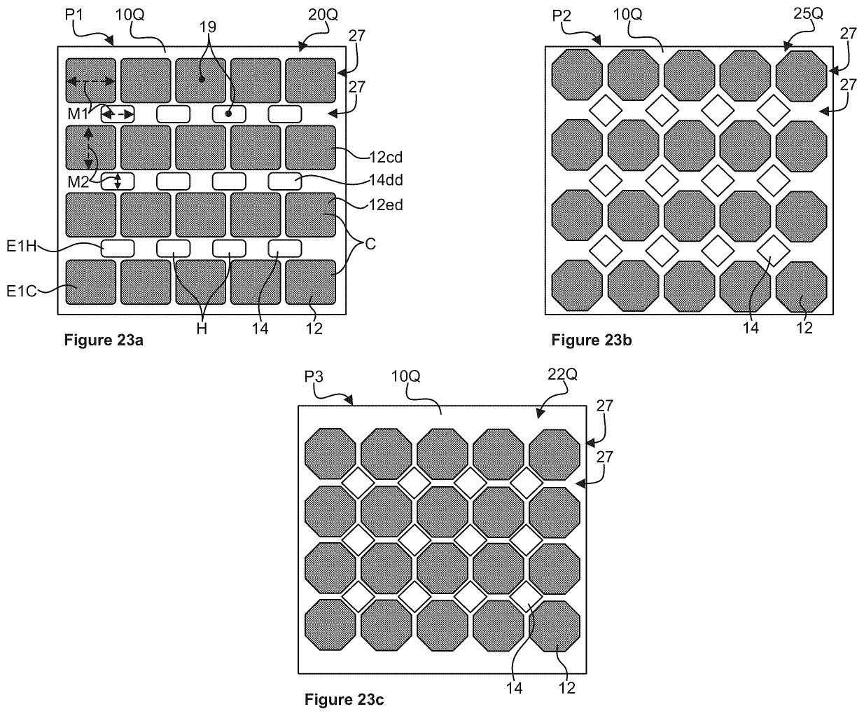

FIGS. 23a to 23c show planes P1, P2 and P3 taken at different points along a heat exchanger 10Q, according to some embodiments. The heat exchanger 10Q may be the same as or similar to one or more of the heat exchangers described herein, in one or more aspects.

The heat exchanger 10Q extends from a first end to a second end. The heat exchanger 10Q comprises a first end portion. The first end portion comprises the first end of the heat exchanger 10Q. The first end may be considered a longitudinal end of the heat exchanger 10Q. The heat exchanger 10Q comprises a second end portion. The second end portion comprises the second end of the heat exchanger 10Q. The second end may be considered a longitudinal end of the heat exchanger 10Q.

The heat exchanger 10Q comprises a body. The body defines the first end and the second end. The body extends from the first end of the heat exchanger 10Q to the second end of the heat exchanger 10Q in a longitudinal direction of the heat exchanger 10Q.

The heat exchanger 10Q comprises a plurality of fluid channels 12, 14. The plurality of fluid channels 12, 14 comprises a first set C of fluid channels 12. The plurality of fluid channels 12, 14 comprises a second set H of fluid channels 14. The fluid channels 12, 14 extend through a body of the heat exchanger 10Q. The fluid channels 12, 14 are again arranged in a first configuration 20Q at the first end of the heat exchanger 10Q. Specifically, the fluid channels 12, 14 are arranged in alternating rows 27 (which may also be referred to as alternating planes), as the fluid channels 12, 14 extend into the body of the heat exchanger 10Q. The number of rows 27 of the first set C of fluid channels 12 is equal to the number of rows 27 of the second set H of fluid channels 14. The heat exchanger 10Q comprises a first transition zone. The first transition zone is disposed at or near the first end of the heat exchanger 10Q. In some embodiments, the first transition zone may be said to comprise the first end of the heat exchanger 10Q. The first transition zone extends along a length of the heat exchanger 10Q. In some embodiments, the first end portion of the heat exchanger 10Q is the first transition zone. One or more of the fluid channels 12, 14 extends through the first transition zone. In the illustrated embodiment, each fluid channel 12, 14 extends through the first transition zone.

The configuration of the fluid channels 12, 14 changes through at least part of the first transition zone. A position of one or more of the fluid channels 12, 14 changes with respect to a position of another one or more of the fluid channels 12, 14 through at least part of the first transition zone. A shape of one or more of the fluid channels 12, 14 changes across at least part of the first transition zone. Therefore, the change in configuration of the fluid channels 12, 14 across the first transition zone comprises both a change in relative position of one or more fluid channels 12, 14 and a change in shape of one or more fluid channels 12, 14.

The heat exchanger 10Q comprises a heat transfer zone. The heat transfer zone may be referred to as an intermediate zone of the heat exchanger 10Q. The heat transfer zone extends along a length of the heat exchanger 10Q. One or more of the fluid channels 12, 14 extends through the heat transfer zone. In the illustrated embodiment, each fluid channel 12, 14 extends through the heat transfer zone. The heat transfer zone is adjacent to the first transition zone.

The heat exchanger 10Q comprises a second transition zone. The second transition zone T2 is disposed at or near the second end of the heat exchanger 10Q. In some embodiments, the second transition zone may be said to comprise the second end of the heat exchanger 10Q. The second transition zone extends along a length of the heat exchanger 10Q. In some embodiments, the second end portion is the second transition zone. One or more of the fluid channels 12, 14 extends through the second transition zone. In the illustrated embodiment, each fluid channel 12, 14 extends through the second transition zone. In the illustrated embodiment, each fluid channel 12, 14 extends through the first transition zone, the heat transfer zone and the second transition zone. The heat transfer zone is between the first transition zone and the second transition zone.

The configuration of the fluid channels 12, 14 changes through at least part of the second transition zone. A position of one or more of the fluid channels 12, 14 changes with respect to a position of another one or more of the fluid channels 12, 14 through at least part of the second transition zone. A shape of one or more of the fluid channels 12, 14 may change across at least part of the second transition zone. The heat transfer zone is adjacent to the second transition zone. In particular, the heat transfer zone is between the first transition zone and the second transition zone.

The heat exchanger 10Q comprises a plurality of sets C, H of fluid channels 12, 14. Each set C, H comprises a plurality of respective fluid channels 12, 14. In the illustrated embodiment, there are two sets C, H of fluid channels 12, 14. That is, the heat exchanger 10Q comprises a first set C of fluid channels 12. The heat exchanger 10Q comprises a second set H of fluid channels 14. The second set H of fluid channels 14 comprises a plurality of fluid channels 14.

The first set C of fluid channels 12 comprises a first number of fluid channels 12. The second set H of fluid channels 14 comprises a second number of fluid channels 14. In the illustrated embodiment, the first number of fluid channels 12 is different to the second number of fluid channels 14. In particular, the first number of fluid channel 12 is greater than the second number of fluid channels 14. It will be appreciated that in some embodiments, the first number of fluid channels 12 may be equal to the second number of fluid channels 14.

Each of the fluid channels 12 of the first set C has a respective first end portion E1C. Each of the fluid channels 12 of the first set C has a respective second end portion. Each of the fluid channels 14 of the second set H has a respective first end portion E1H. Each of the fluid channels 14 of the second set H has a respective second end portion. Hereinafter, the first end portions E1C, E1H and the second end portions may be collectively, and in general, referred to as “first end portions E1” and “second end portions” respectively. Further, for ease of description, the end portions in a general sense, whether they be the first end portions or the second end portions, may be referred to hereafter as “end portions”.

The first end portions E1 extend from the first end of the heat exchanger 10Q, along a first portion of the length of the heat exchanger 10Q, towards the second end of the heat exchanger 10Q. The first end portion E1 of each fluid channel 12, 14 extends through at least part of the first transition zone. In some embodiments, the first end portion E1 of each fluid channel 12, 14 is the portion of the fluid channel 12, 14 that extends through the first transition zone. That is, the portion of a respective fluid channel 12, 14 that is within the first transition zone may be considered the first end portion E1 of that fluid channel 12, 14.

In some embodiments, a respective end of one of the fluid channels 12, 14 may be considered the end portion E1 of that fluid channel 12, 14. That is, the point of a respective fluid channel 12, 14 that is at the first end 18 of the heat exchanger 10L may be considered the first end portion E1 of that fluid channel 12, 14.

The second end portions extend from the second end of the heat exchanger 10Q, along a second portion of the length of the heat exchanger 10Q, towards the first end of the heat exchanger 10Q. The second end portion of each fluid channel 12, 14 extends through at least part of the second transition zone. In some embodiments, the second end portion of each fluid channel 12, 14 is the portion of the fluid channel 12, 14 that extends through the second transition zone. That is, the portion of a respective fluid channel 12, 14 that is within the second transition zone may be considered the second end portion of that fluid channel 12, 14.

In some embodiments, a respective end of one of the fluid channels 12, 14 may be considered the end portion E2 of that fluid channel 12, 14. That is, the point of a respective fluid channel 12, 14 that is at the second end 26 of the heat exchanger 10Q may be considered the first end portion E1 of that fluid channel 12, 14.

In between the end portions E, each fluid channel 12, 14 has an intermediate portion respectively. That is, the fluid channels 12 of the first set C have respective intermediate portions. Similarly, the fluid channels 14 of the second set H have respective intermediate portions. Hereinafter, the intermediate portions may be referred to collectively, and in general, as “intermediate portions”.

The intermediate portion of each fluid channel 12, 14 bridges the first end portion E1 and the second end portion of that fluid channel 12, 14. That is, the intermediate portion of a fluid channel 12, 14 extends from an inner end of the first end portion E1 of that fluid channel 12, 14 to an inner end of the second end portion of that fluid channel 12, 14. The intermediate portion of each fluid channel 12, 14 extends through at least part of the heat transfer zone. In some embodiments, the intermediate portion of each fluid channel 12, 14 is the portion of the fluid channel 12, 14 that extends through the heat transfer zone.

The fluid channels 12, 14 are aligned into a number of rows 27 and a number of columns 29 at one or more points along the length of the heat exchanger 10Q. In particular, the end portions of the fluid channels 12, 14 are arranged in rows 27 of fluid channels 12, 14 at each of the first end and the second end. Each row 27 of fluid channels 12, 14 at the first end portion/first end and the second end portion/second end comprises only fluid channels 12, 14 from one set C, H of fluid channels 12, 14. In other words, each row 27 of fluid channels 12, 14 comprises either only fluid channels 12 from the first set C of fluid channels 12 or only fluid channels 14 from the second set H of fluid channels 14.

The fluid channels 12, 14 are arranged in a plurality of columns 29 at each of the first end and the second end of the heat exchanger 10Q. Each of these columns 29 comprises fluid channels 12 from the first set C and fluid channels 14 from the second set H.

In the illustrated embodiment, an outer end of the first end portion E1C of one or more of the fluid channels 12 of the first set C of fluid channels 12 is disposed between a first adjacent row and a second adjacent row of fluid channels. For example, fluid channel 14dd is disposed between a row 27 comprising fluid channel 12cd and a row 27 comprising fluid channel 12ed. This fluid channel 14dd is therefore disposed between two rows 27 of fluid channels 12 of the first set C of fluid channels 14. More generally, fluid channels 12 of the first set C are disposed between two rows 27 of fluid channels 14 of the second set H, at the first end and the second end of the heat exchanger 10Q. Fluid channels 14 of the second set H are disposed between two rows 27 of fluid channels 12 of the first set C, at the first end and the second end of the heat exchanger 10Q. It will be appreciated that this is not the case for outer rows of the heat exchanger 10Q.

The number of fluid channels 12 of the first set C of fluid channels 12 is greater than the number of fluid channels 14 of the second set H of fluid channels 14.

Each fluid channel 12, 14 defines a cross-sectional shape at each point along its length. The cross-sectional shape of a respective fluid channel 12, 14 at a point along its length is viewed perpendicular to a direction of flow of fluid through the heat exchanger 10Q. The cross-sectional shape of a respective fluid channel 12, 14 at a point along its length encloses a cross-sectional area of that fluid channel 12, 14 at that point.

Each fluid channel 12, 14 defines a first outer end cross-sectional shape enclosing a first outer end cross-sectional area. In particular, the first outer end cross-sectional shape is defined by the first outer end of the fluid channel 12, 14 (i.e. the end of the fluid channel 12, 14 at the first end of the heat exchanger 10Q). In other words, the first outer end cross sectional shape of one of the fluid channels 12, 14 is a shape of the respective fluid channel 12, 14 at the outer end of the first end portion E1 of that fluid channel 12, 14. Each fluid channel 12, 14 defines a second outer end cross sectional shape enclosing a second outer end cross-sectional area. In particular, the second outer end cross-sectional shape is defined by the second outer end of the fluid channel 12, 14 (i.e. the end of the fluid channel 12, 14 at the second end of the heat exchanger 10Q). In other words, the second outer end cross sectional shape of one of the fluid channels 12, 14 is a shape of the respective fluid channel 12, 14 at the outer end of the second end portion of that fluid channel 12, 14.

In the illustrated embodiment, the first outer end cross sectional area of the fluid channels 12 of the first set C of fluid channels 12 is equal to the first outer end cross sectional area of the fluid channels 14 of the second set H of fluid channels 14.

In some embodiments, the first outer end cross sectional area of one or more of the first set C of fluid channels 12 is greater than the first outer end cross sectional area of one or more of the second set H of fluid channels 14. In some embodiments, the second outer end cross sectional area of one or more of the first set C of fluid channels 12 is greater than the second outer end cross sectional area of one or more of the second set H of fluid channels 14.

Each fluid channel 12, 14 defines an intermediate cross-sectional shape enclosing an intermediate cross-sectional area. The intermediate cross-sectional shape of one of the fluid channels 12, 14 is a cross-sectional shape of the respective fluid channel 12, 14 along at least part of the heat transfer zone.

In the illustrated embodiment, the intermediate cross sectional areas of the fluid channels 12 of the first set C of fluid channels are different to the intermediate cross-sectional areas of the fluid channels 14 of the second set H of fluid channels 14. In some embodiments, however, the intermediate cross sectional area of one or more of the fluid channels 14 of the second set H of fluid channels 14 is the same as the intermediate cross sectional area of one or more of the fluid channels 12 of the first set C of fluid channels 12.

The first outer end cross-sectional shape, second outer end cross sectional shape and/or the intermediate cross sectional shape of one or more of the fluid channels 12, 14 may be a rounded rectangle, a rounded hexagon, a rounded octagon, or a polygon.

In some embodiments, first outer end cross-sectional shape, second outer end cross sectional shape and/or the intermediate cross-sectional shape of one or more of the first set C of fluid channels 12 and/or one or more of the second set H of fluid channels is a mirror image of the shape of another of the first set C or second set H of fluid channels 12, 14, is symmetric about a first axis of symmetry and/or is asymmetric about a second axis of symmetry. In some embodiments, first outer end cross-sectional shape, second outer end cross sectional shape and/or the intermediate cross-sectional shape of one or more of the fluid channels of the first set C of fluid channels 12 and/or one or more of the fluid channels 14 of the second set H of fluid channels comprises one or more straight sides and one or more curved sides.

The first plane P1, shown in FIG. 23a, is taken at a first end of the heat exchanger 10Q. The fluid channels 12, 14 are in a first configuration 20Q at the first end of the heat exchanger 10Q. In the first configuration, the fluid channels 12, 14 are arranged into alternating rows 27 or planes of fluid channels 12, 14 of the first set C and the second set H. That is, each row 27 of fluid channels 12, 14 comprises only fluid channels 12, 14 of one set C, H of fluid channels 12, 14, with the rows 27 alternating between rows of fluid channels 12 of the first set C and rows of fluid channels 14 of the second set H.

At the first end of the heat exchanger 10Q, each of the fluid channels 12 of the first set C define a respective cross-sectional shape. In this case, the cross-sectional shape is a rounded rectangle. Each of the fluid channels 14 of the second set H define a respective cross-sectional shape. In this case, the cross sectional shape is a rounded rectangle.

A surface area of the cross sectional shape of a fluid channel 12, 14 on a respective plane may be referred to as a cross sectional surface area of that fluid channel 12, 14. The cross-sectional surface area of each of the fluid channels 12, 14 of the first set is greater than the cross-sectional surface area of each of the fluid channels 14 of the second set H at the first end of the heat exchanger 10Q.

Each fluid channel 12, 14 has a major dimension M1 at the first end of the heat exchanger 10Q. Each fluid channel 12, 14 has a minor dimension M2 at the first end of the heat exchanger 10Q. In the illustrated embodiment, the major dimension M1 of each fluid channel 12 of the first set C is in a horizontal direction. Similarly, the major dimension M1 of each fluid channel 14 of the second set H is in a horizontal direction. In the illustrated embodiment, the minor dimension of each fluid channel 12, 14 is orthogonal to the respective major dimension M1. In some embodiments, the cross sectional shape of one or more fluid channel 12, 14 has a major dimension along at least part of its length. The major dimension may be said to be a maximum cross-sectional dimension of the respective fluid channel 12, 14. In some embodiments, the cross sectional shape of one or more fluid channel 12, 14 has a minor dimension along at least part of its length. The minor dimension may be said to be a minimum cross-sectional dimension of the respective fluid channel 12, 14. The major dimension of a fluid channel 12, at a particular point along the length of the fluid channel 12, 14, may be measured along a major axis of the respective fluid channel 12, 14 at that particular point. Similarly, the minor dimension of a fluid channel 12, 14, at a particular point along the length of the fluid channel 12, 14, may be measured along a minor axis of the respective fluid channel 12, 14. The major axis and the minor axis of one or more fluid channel 12, 14 may be orthogonal at one or more points along the length of the fluid channel 12, 14.

The major dimension of one or more of the fluid channels 12 of the first set of fluid channels C may be different to the major dimension of one or more of the fluid channels 14 of the second set of fluid channels H, at one or more points along the length of the heat exchanger 10Q. The major dimension of one or more of the fluid channels 12 of the first set of fluid channels C may be greater than the major dimension of one or more of the fluid channels 14 of the second set of fluid channels H, at one or more points along the length of the heat exchanger 10Q. The major dimension of one or more of the fluid channels 12 of the first set of fluid channels C may be less than the major dimension of one or more of the fluid channels 14 of the second set of fluid channels H, at one or more points along the length of the heat exchanger 10Q. The minor dimension of one or more of the fluid channels 12 of the first set of fluid channels C may be greater than the minor dimension of one or more of the fluid channels 14 of the second set of fluid channels H, at one or more points along the length of the heat exchanger 10Q. The minor dimension of one or more of the fluid channels 12 of the first set of fluid channels C may be less than the minor dimension of one or more of the fluid channels 14 of the second set of fluid channels H, at one or more points along the length of the heat exchanger 10Q. The major dimension of one or more of the fluid channels 12 of the first set of fluid channels C may be equal to the major dimension of one or more of the fluid channels 14 of the second set of fluid channels H, at one or more points along the length of the heat exchanger 10Q. The major dimension of one or more of the fluid channels 12 of the first set of fluid channels C may be equal to the minor dimension of one or more of the fluid channels 14 of the second set of fluid channels H, at one or more points along the length of the heat exchanger 10Q. The minor dimension of one or more of the fluid channels 12 of the first set of fluid channels C may be equal to the major dimension of one or more of the fluid channels 14 of the second set of fluid channels H, at one or more points along the length of the heat exchanger 10Q. The minor dimension of one or more of the fluid channels 12 of the first set of fluid channels C may be equal to the minor dimension of one or more of the fluid channels 14 of the second set of fluid channels H, at one or more points along the length of the heat exchanger 10Q.

Each fluid channel 12, 14 has a respective cross sectional midpoint 19. The cross sectional midpoint 19 may be considered a centroid of the respective fluid channel 12, 14 at a point along its length. The fluid channels 14 of the second set It will be appreciated that in some embodiments, one or more of the fluid channels 12, 14 does not have a major dimension and/or a minor dimension. For example, one or more of the fluid channels 12, 14 may have a cross-sectional shape at the first end that is a rounded square or a circle (i.e. a shape without a major dimension/minor dimension).

The cross-sectional shape of one or more of the fluid channels 12, 14 changes along a first length of a first transition zone of the heat exchanger 10Q. In particular, the cross sectional shape of each fluid channel 12, 14 changes as the fluid channels 12, 14 extend away from the first end of the heat exchanger 10Q.

The second plane P2, shown in FIG. 23b, shows the fluid channels 12, 14 arranged in a second configuration 25Q at an intermediate point along the length of the heat exchanger 10Q. The intermediate point is within the first transition zone. As can be seen by comparing FIG. 23a with FIG. 23b, the cross sectional shape of the fluid channels 12, 14 has changed between the first configuration 20Q and the second configuration 25Q.

In particular, the fluid channels 12 of the first set C change from a first cross sectional shape at the first end to a second cross sectional shape at the intermediate point along the length of the heat exchanger 10Q. In the illustrated embodiment, the second cross-sectional shape is an octagon.

The fluid channels 14 of the second set H change from a first cross sectional shape at the first end to a second cross sectional shape at the intermediate point along the length of the heat exchanger 10Q. In the illustrated embodiment, the second cross sectional shape is a diamond.

The third plane P3, shown in FIG. 23c, shows the fluid channels 12, 14 arranged in a third configuration 22Q at a second intermediate point along the length of the heat exchanger 10Q. The second intermediate point is at an inner end of the first transition zone. The second intermediate point is between the first intermediate point and a second end 26 of the heat exchanger 10Q. As can be seen by comparing FIG. 23b with FIG. 23c, the relative position of each fluid channel 12, 14 has changed with respect to each adjacent fluid channel 12, 14.

In particular, as the fluid channels extend from the intermediate point along the length of the heat exchanger 10Q to the second intermediate point, a plurality of of the fluid channels 12, 14 translate such that the distances between their cross sectional midpoints 19 and the cross sectional midpoints 19 of adjacent fluid channels 12, 14 decreases. That is, the fluid channels 12, 14 compress together as they extend from the intermediate point to the second intermediate point.

The third configuration 22Q is the heat transfer configuration of this embodiment. The fluid channels 12, 14 are maintained in the third configuration 22Q as they extend through the heat transfer zone of the heat exchanger 10Q. The changes in configuration of the fluid channels are then reversed within a second transition zone at an opposite end of the heat exchanger 10Q as the first transition zone. Across a first length of the second transition zone, the fluid channels 12, 14 translate such that the distance between their cross sectional midpoints 19 increases. That is, the fluid channels 12, 14 decompress. Then, across a second length of the second transition zone, the cross-sectional shape of each fluid channel 12, 14 changes. The cross sectional shapes change such that at the second end of the heat exchanger 10Q, the fluid channels 12, 14 are again arranged in the first configuration 20Q.

The change in configuration of the fluid channels of this heat exchanger 10Q provides a number of advantages. Specifically, the shared heat transfer length between the fluid channels increase due to the change in shape of the fluid channels 12, 14. Further, by compressing the channels 12, 14 together, the efficiency of heat transfer between the fluids within the channels 12, 14 can be increased.

### Heat Exchanger 10R

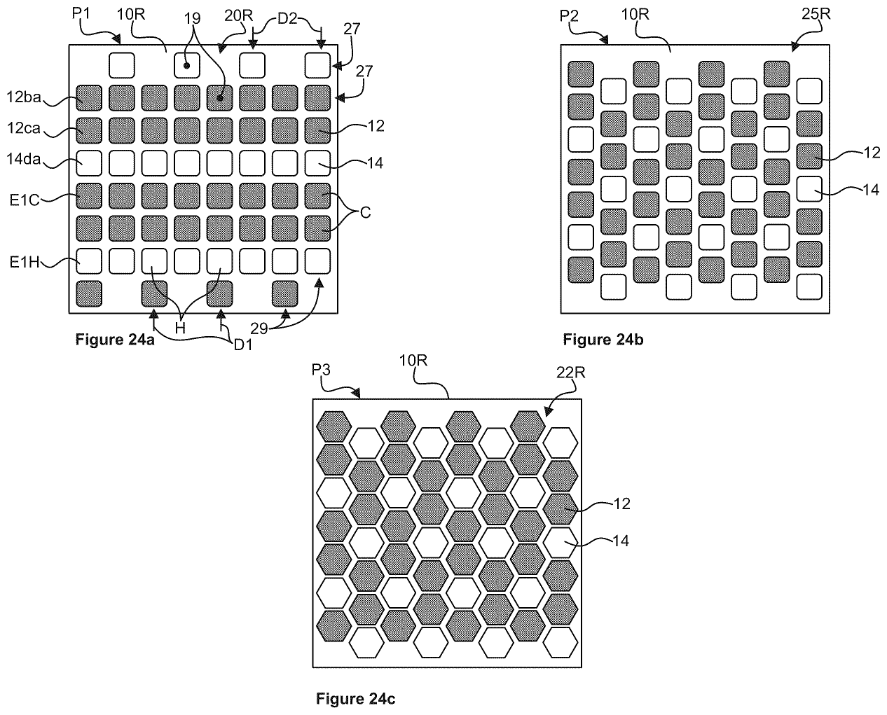

FIGS. 24a to 24c show planes P1, P2 and P3 taken at different points along a heat exchanger 10R, according to some embodiments. The heat exchanger 10R may be the same as or similar to one or more of the heat exchangers described herein, in one or more aspects.

The heat exchanger 10R extends from a first end to a second end. The heat exchanger 10R comprises a first end portion. The first end portion comprises the first end of the heat exchanger 10R. The first end may be considered a longitudinal end of the heat exchanger 10R. The heat exchanger 10R comprises a second end portion. The second end portion comprises the second end of the heat exchanger 10R. The second end may be considered a longitudinal end of the heat exchanger 10R.

The heat exchanger 10R comprises a body. The body defines the first end and the second end. The body extends from the first end of the heat exchanger 10R to the second end of the heat exchanger 10R in a longitudinal direction of the heat exchanger 10R.

The heat exchanger 10R comprises a plurality of fluid channels 12, 14. The plurality of fluid channels 12, 14 comprises a first set C of fluid channels 12. The plurality of fluid channels 12, 14 comprises a second set H of fluid channels 14. The fluid channels 12, 14 extend through a body of the heat exchanger 10R. The fluid channels 12, 14 are again arranged in a first configuration 20R at the first end of the heat exchanger 10R. Specifically, the fluid channels 12, 14 are arranged in rows 27 (which may also be referred to as planes), as the fluid channels 12, 14 extend into the body of the heat exchanger 10R. The number of rows 27 of the first set C of fluid channels 12 is different to the number of rows 27 of the second set H of fluid channels 14. In particular, at the first end, the number of rows 27 of fluid channels 12 of the first set C is greater than the number of rows 27 of fluid channels of the second set H.

The heat exchanger 10R comprises a first transition zone. The first transition zone is disposed at or near the first end of the heat exchanger 10R. In some embodiments, the first transition zone may be said to comprise the first end of the heat exchanger 10R. The first transition zone extends along a length of the heat exchanger 10R. In some embodiments, the first end portion of the heat exchanger 10R is the first transition zone. One or more of the fluid channels 12, 14 extends through the first transition zone. In the illustrated embodiment, each fluid channel 12, 14 extends through the first transition zone.

The configuration of the fluid channels 12, 14 changes through at least part of the first transition zone. A position of one or more of the fluid channels 12, 14 changes with respect to a position of another one or more of the fluid channels 12, 14 through at least part of the first transition zone. A shape of one or more of the fluid channels 12, 14 changes across at least part of the first transition zone. Therefore, the change in configuration of the fluid channels 12, 14 across the first transition zone comprises both a change in relative position of one or more fluid channels 12, 14 and a change in shape of one or more fluid channels 12, 14.

The heat exchanger 10R comprises a heat transfer zone. The heat transfer zone may be referred to as an intermediate zone of the heat exchanger 10R. The heat transfer zone extends along a length of the heat exchanger 10R. One or more of the fluid channels 12, 14 extends through the heat transfer zone. In the illustrated embodiment, each fluid channel 12, 14 extends through the heat transfer zone. The heat transfer zone is adjacent to the first transition zone.

The heat exchanger 10R comprises a second transition zone. The second transition zone is disposed at or near the second end of the heat exchanger 10R. In some embodiments, the second transition zone may be said to comprise the second end of the heat exchanger 10R. The second transition zone extends along a length of the heat exchanger 10R. In some embodiments, the second end portion is the second transition zone. One or more of the fluid channels 12, 14 extends through the second transition zone. In the illustrated embodiment, each fluid channel 12, 14 extends through the second transition zone. In the illustrated embodiment, each fluid channel 12, 14 extends through the first transition zone, the heat transfer zone and the second transition zone. The heat transfer zone is between the first transition zone and the second transition zone.

The configuration of the fluid channels 12, 14 changes through at least part of the second transition zone. A position of one or more of the fluid channels 12, 14 changes with respect to a position of another one or more of the fluid channels 12, 14 through at least part of the second transition zone. A shape of one or more of the fluid channels 12, 14 may change across at least part of the second transition zone. The heat transfer zone is adjacent to the second transition zone. In particular, the heat transfer zone is between the first transition zone and the second transition zone.

The heat exchanger 10R comprises a plurality of sets C, H of fluid channels 12, 14. Each set C, H comprises a plurality of respective fluid channels 12, 14. In the illustrated embodiment, there are two sets C, H of fluid channels 12, 14. That is, the heat exchanger 10R comprises a first set C of fluid channels 12. The heat exchanger 10R comprises a second set H of fluid channels 14.

The first set C of fluid channels 12 comprises a first number of fluid channels 12. The second set H of fluid channels 14 comprises a second number of fluid channels 14. In the illustrated embodiment, the first number of fluid channels 12 is different to the second number of fluid channels 14. In particular, the first number of fluid channel 12 is greater than the second number of fluid channels 14. It will be appreciated that in some embodiments, the first number of fluid channels 12 may be equal to the second number of fluid channels 14.

Each of the fluid channels 12 of the first set C has a respective first end portion E1C. Each of the fluid channels 12 of the first set C has a respective second end portion. Each of the fluid channels 14 of the second set H has a respective first end portion E1H. Each of the fluid channels 14 of the second set H has a respective second end portion. Hereinafter, the first end portions E1C, E1H and the second end portions may be collectively, and in general, referred to as “first end portions E1” and “second end portions” respectively. Further, for ease of description, the end portions in a general sense, whether they be the first end portions or the second end portions, may be referred to hereafter as “end portions”.

The first end portions E1 extend from the first end of the heat exchanger 10R, along a first portion of the length of the heat exchanger 10R, towards the second end of the heat exchanger 10R. The first end portion E1 of each fluid channel 12, 14 extends through at least part of the first transition zone. In some embodiments, the first end portion E1 of each fluid channel 12, 14 is the portion of the fluid channel 12, 14 that extends through the first transition zone. That is, the portion of a respective fluid channel 12, 14 that is within the first transition zone may be considered the first end portion E1 of that fluid channel 12, 14.

In some embodiments, a respective end of one of the fluid channels 12, 14 may be considered the end portion E1 of that fluid channel 12, 14. That is, the point of a respective fluid channel 12, 14 that is at the first end 18 of the heat exchanger 10L may be considered the first end portion E1 of that fluid channel 12, 14.

The second end portions extend from the second end of the heat exchanger 10R, along a second portion of the length of the heat exchanger 10R, towards the first end of the heat exchanger 10R. The second end portion of each fluid channel 12, 14 extends through at least part of the second transition zone. In some embodiments, the second end portion of each fluid channel 12, 14 is the portion of the fluid channel 12, 14 that extends through the second transition zone. That is, the portion of a respective fluid channel 12, 14 that is within the second transition zone may be considered the second end portion of that fluid channel 12, 14.

In some embodiments, a respective end of one of the fluid channels 12, 14 may be considered the end portion E2 of that fluid channel 12, 14. That is, the point of a respective fluid channel 12, 14 that is at the second end 26 of the heat exchanger 10R may be considered the first end portion E1 of that fluid channel 12, 14.

In between the end portions, each fluid channel 12, 14 has a respective intermediate portion. That is, the fluid channels 12 of the first set C have respective intermediate portions. Similarly, the fluid channels 14 of the second set H have respective intermediate portions. Hereinafter, the intermediate portions may be referred to collectively, and in general, as “intermediate portions”.

The intermediate portion of each fluid channel 12, 14 bridges the first end portion E1 and the second end portion of that fluid channel 12, 14. That is, the intermediate portion of a fluid channel 12, 14 extends from an inner end of the first end portion E1 of that fluid channel 12, 14 to an inner end of the second end portion of that fluid channel 12, 14. The intermediate portion of each fluid channel 12, 14 extends through at least part of the heat transfer zone. In some embodiments, the intermediate portion of each fluid channel 12, 14 is the portion of the fluid channel 12, 14 that extends through the heat transfer zone.

The fluid channels 12, 14 are aligned into a number of rows 27 and a number of columns 29 at one or more points along the length of the heat exchanger 10R. In particular, the end portions of the fluid channels 12, 14 are arranged in rows 27 of fluid channels 12, 14 at each of the first end and the second end. Each row 27 of fluid channels 12, 14 at the first end portion/first end and the second end portion/second end comprises only fluid channels 12, 14 from one set C, H of fluid channels 12, 14. In other words, each row 27 of fluid channels 12, 14 comprises either only fluid channels 12 from the first set C of fluid channels 12 or only fluid channels 14 from the second set H of fluid channels 14.

The fluid channels 12, 14 are arranged in a plurality of columns 29 at each of the first end and the second end of the heat exchanger 10R. Each of these columns 29 comprises fluid channels 12 from the first set C and fluid channels 14 from the second set H.

In the illustrated embodiment, an outer end of the first end portion E1C of one or more of the fluid channels 12 of the first set C of fluid channels 12 is disposed between a first adjacent row and a second adjacent row of fluid channels. For example, fluid channel 12ca is disposed between a row 27 comprising fluid channel 14da and a row 27 comprising fluid channel 12ba. This fluid channel 12ca is therefore disposed between one row 27 of fluid channels 14 of the second set H of fluid channels 14 and one row 27 of fluid channels 12 of the first set C of fluid channels 12. More generally, fluid channels 12 of the first set C are disposed between a row 27 of fluid channels 14 of the second set H and a row 27 of fluid channels 12 of the first set C, at the first end and the second end of the heat exchanger 10R. Fluid channels 14 of the second set H are disposed between two rows 27 of fluid channels 12 of the first set C, at the first end and the second end of the heat exchanger 10R. It will be appreciated that this will not be the case for outer rows.

The number of fluid channels 12 of the first set C of fluid channels 12 is greater than the number of fluid channels 14 of the second set H of fluid channels 14.

Each fluid channel 12, 14 defines a cross-sectional shape at each point along its length. The cross-sectional shape of a respective fluid channel 12, 14 at a point along its length is viewed perpendicular to a direction of flow of fluid through the heat exchanger 10R. The cross-sectional shape of a respective fluid channel 12, 14 at a point along its length encloses a cross-sectional area of that fluid channel 12, 14 at that point.

Each fluid channel 12, 14 defines a first outer end cross-sectional shape enclosing a first outer end cross-sectional area. In particular, the first outer end cross-sectional shape is defined by the first outer end of the fluid channel 12, 14 (i.e. the end of the fluid channel 12, 14 at the first end of the heat exchanger 10R). In other words, the first outer end cross sectional shape of one of the fluid channels 12, 14 is a shape of the respective fluid channel 12, 14 at the outer end of the first end portion E1 of that fluid channel 12, 14. Each fluid channel 12, 14 defines a second outer end cross sectional shape enclosing a second outer end cross-sectional area. In particular, the second outer end cross-sectional shape is defined by the second outer end of the fluid channel 12, 14 (i.e. the end of the fluid channel 12, 14 at the second end of the heat exchanger 10R). In other words, the second outer end cross sectional shape of one of the fluid channels 12, 14 is a shape of the respective fluid channel 12, 14 at the outer end of the second end portion of that fluid channel 12, 14.

In the illustrated embodiment, the first outer end cross sectional area of the fluid channels 12 of the first set C of fluid channels 12 is equal to the first outer end cross sectional area of the fluid channels 14 of the second set H of fluid channels 14.

In some embodiments, the first outer end cross sectional area of one or more of the first set C of fluid channels 12 is greater than the first outer end cross sectional area of one or more of the second set H of fluid channels 14. In some embodiments, the second outer end cross sectional area of one or more of the first set C of fluid channels 12 is greater than the second outer end cross sectional area of one or more of the second set H of fluid channels 14.

Each fluid channel 12, 14 defines an intermediate cross-sectional shape enclosing an intermediate cross-sectional area. The intermediate cross-sectional shape of one of the fluid channels 12, 14 is a cross-sectional shape of the respective fluid channel 12, 14 along at least part of the heat transfer zone.

In the illustrated embodiment (see FIG. 24c), the intermediate cross sectional areas of the fluid channels 12 of the first set C of fluid channels are the same as the intermediate cross-sectional areas of the fluid channels 14 of the second set H of fluid channels 14. In some embodiments, however, the intermediate cross sectional area of one or more of the fluid channels 14 of the second set H of fluid channels 14 is different to the intermediate cross sectional area of one or more of the fluid channels 12 of the first set C of fluid channels 12.

The first outer end cross-sectional shape, second outer end cross sectional shape and/or the intermediate cross sectional shape of one or more of the fluid channels 12, 14 may be a rounded rectangle, a rounded hexagon, a rounded octagon, or a polygon.

In some embodiments, first outer end cross-sectional shape, second outer end cross sectional shape and/or the intermediate cross-sectional shape of one or more of the first set C of fluid channels 12 and/or one or more of the second set H of fluid channels is a mirror image of the shape of another of the first set C or second set H of fluid channels 12, 14, is symmetric about a first axis of symmetry and/or is asymmetric about a second axis of symmetry. In some embodiments, first outer end cross-sectional shape, second outer end cross sectional shape and/or the intermediate cross-sectional shape of one or more of the fluid channels of the first set C of fluid channels 12 and/or one or more of the fluid channels 14 of the second set H of fluid channels comprises one or more straight sides and one or more curved sides.

The first plane P1, shown in FIG. 24a, is taken at a first end of the heat exchanger 10R. The fluid channels 12, 14 are in a first configuration 20R at the first end of the heat exchanger 10R. In the first configuration, the fluid channels 12, 14 are arranged into a number of rows 27 or planes of fluid channels 12, 14. Each row 27 comprises fluid channels 12, 14 of only one of the first set C and the second set H. That is, each row 27 of fluid channels 12, 14 comprises only fluid channels 12, 14 of one set C, H of fluid channels 12, 14. The set C, H of fluid channels 12, 14 in a particular row 27 follows a pattern as the first end of the heat exchanger 10R is traversed from one lateral side (e.g. an upper side) to another lateral side (e.g. a lower side). The pattern comprises a first row 27 of fluid channels 14 of the second set H, followed by two rows 27 of fluid channels 12 of the first set C. While the illustrated heat exchanger 10R has only 8 rows, it will be appreciated that the number of rows 27 can scale upwards significantly, with this pattern repeating. In other words, the heat exchanger 10R comprises two rows 27 of fluid channels 12 of the first set C for every one row 27 of fluid channels 14 of the second set H. The upper and lower rows 27 comprise about half of the number of fluid channels 12, 14 as intermediate rows between the upper and lower rows 27.

At the first end of the heat exchanger 10R, each of the fluid channels 12 of the first set C define a respective cross-sectional shape. In this case, the cross-sectional shape is a rounded rectangle. Each of the fluid channels 14 of the second set H define a respective cross-sectional shape. In this case, the cross sectional shape is a rounded rectangle.

A surface area of the cross sectional shape of a fluid channel 12, 14 on a respective plane may be referred to as a cross sectional surface area of that fluid channel 12, 14. The cross-sectional surface area of each of the fluid channels 12, 14 of the first set C is about the same as the cross-sectional surface area of each of the fluid channels 14 of the second set H at the first end of the heat exchanger 10R.

Each fluid channel 12, 14 has a respective cross sectional midpoint 19. The cross sectional midpoint 19 may be considered a centroid of the respective fluid channel 12, 14 at a point along its length.

The second plane P2, shown in FIG. 24b, shows the fluid channels 12, 14 arranged in a second configuration 25R at an intermediate point along the length of the heat exchanger 10R. The intermediate point is within the first transition zone of the heat exchanger 10R. The intermediate point is between the first end and the second end of the heat exchanger 10R. As can be seen by comparing FIG. 24a with FIG. 24b, the relative position of one or more of the fluid channels 12, 14 has changed with respect to one or more other fluid channels 12, 14.

In order to change the configuration of the fluid channels 12, 14 from the first configuration 20R to the second configuration 25R, a plurality of the fluid channels 12, 14 are translated in a first direction D1 as they extend through the first transition zone. In the embodiment of FIGS. 24a to 24c, alternating columns 29 of fluid channels 12, 14 are translated in the first direction D1, along a first length of the first transition zone. In the illustrated embodiment, the first direction D1 is an upward direction. This translation moves the relevant fluid channels 12, 14 with respect to the fluid channels 12, 14 of the other columns 29.

In addition to the above translation, another plurality of the fluid channels 12, 14 are translated in a second direction D2, along at least part of the first transition zone. In particular, the other set of alternating columns 29 of fluid channels 12, 14 are translated in the second direction D2, along the first length of the first transition zone. The second direction D2 is opposite the first direction D1. In the illustrated embodiment, the second direction D2 is a downward direction. This translation moves the relevant fluid channels 12, 14 with respect to the fluid channels 12, 14 of the other columns 29.

It will be appreciated that in some embodiments, translations of mutually exclusive columns 29 in different directions D1, D2 are not necessary. For example, one group of alternating columns 29 may simply translate in the first direction D1 until the fluid channels 12, 14 are in a second configuration 25P at the intermediate point. That is, one group of alternating columns 29 may translate in the first direction D1, as they extend along the first length of the first transition zone, until the fluid channels 12, 14 are aligned in the second configuration 25R. Alternatively, one group of alternating columns 29 may translate in the second direction D2 until the fluid channels 12, 14 are arranged in the second configuration 25R.

In the second configuration 25R, the fluid channels 12, 14 of each row are offset with respect to the fluid channels 12, 14 of the adjacent rows. The cross-sectional shape of one or more of the fluid channels 12, 14 changes along a second length of the first transition zone of the heat exchanger 10R. In particular, the cross sectional shape of each fluid channel 12, 14 changes as the fluid channels 12, 14 extend away from the intermediate point along the length of the heat exchanger 10R, towards the second end of the heat exchanger 10R.

The third plane P3, shown in FIG. 24c, shows the fluid channels 12, 14 arranged in a third configuration 22R at a second intermediate point along the length of the heat exchanger 10R. The second intermediate point is at an inner end of the first transition zone. The second intermediate point may correspond to a point at which the first transition zone changes to the heat transfer zone. As can be seen by comparing FIG. 24b with FIG. 24c, the cross sectional shape of the fluid channels 12, 14 has changed between the second configuration 25R and the third configuration 22R.

In particular, the fluid channels 12 of the first set C change from a first cross sectional shape at the first intermediate point to a second cross sectional shape at the second intermediate point along the length of the heat exchanger 10R. In the illustrated embodiment, the second cross-sectional shape is a hexagon.

The fluid channels 14 of the second set H change from a first cross sectional shape at the first intermediate point to a second cross sectional shape at the second intermediate point along the length of the heat exchanger 10R. In the illustrated embodiment, the second cross sectional shape is a hexagon.

The third configuration 22R is the heat transfer configuration of this embodiment. The fluid channels 12, 14 are maintained in the third configuration 22R as they extend through the heat transfer zone of the heat exchanger 10R. The changes in configuration of the fluid channels are then reversed within a second transition zone at an opposite end of the heat exchanger 10R as the first transition zone. Across a first length of the second transition zone, the cross sectional shape of each fluid channel 12, 14 changes. The cross-sectional shapes change such that at a third intermediate point along the length of the heat exchanger (that is within the second transition zone), the fluid channels 12, 14 are again arranged in the second configuration 25R. Across a second length of the second transition zone, the fluid channels 12, 14 translate to reverse the translation across the first length of the first transition zone. Therefore, at the second end of the heat exchanger 10R, the fluid channels are again arranged in the first configuration 20R.

The change in configuration of the fluid channels 12, 14 of this heat exchanger 10R provides a number of advantages. Specifically, the shared heat transfer length between the fluid channels 12, 14 increases due to the translation and change in shape of the fluid channels 12, 14.

### Heat Exchanger 10S

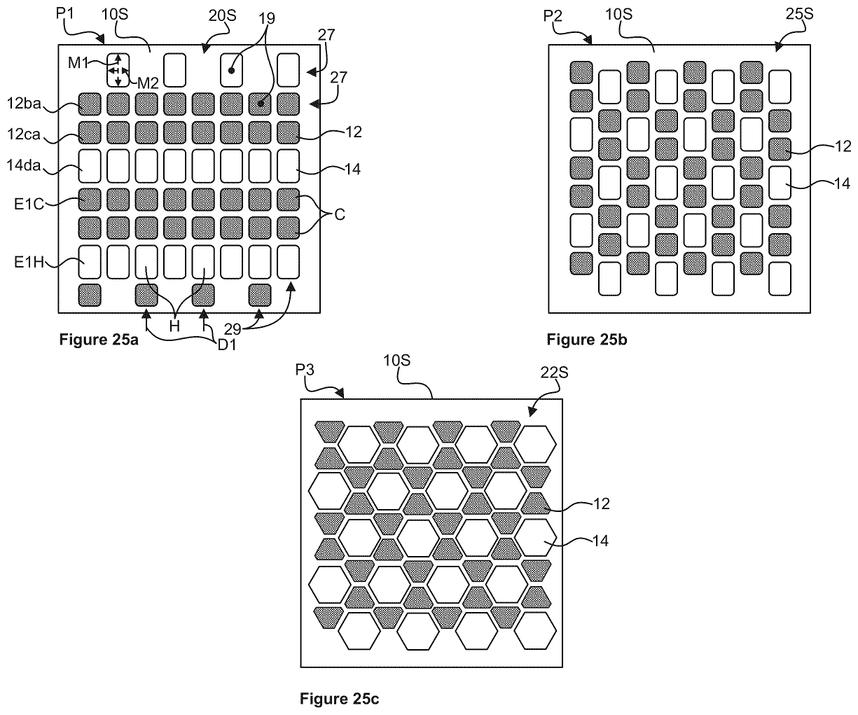

FIGS. 25a to 25c show planes P1, P2 and P3 taken at different points along a heat exchanger 10S, according to some embodiments. The heat exchanger 10S may be the same as or similar to one or more of the heat exchangers described herein, in one or more aspects.

The heat exchanger 10S extends from a first end to a second end. The heat exchanger 10S comprises a first end portion. The first end portion comprises the first end of the heat exchanger 10S. The first end may be considered a longitudinal end of the heat exchanger 10S.

The heat exchanger 10S comprises a second end portion. The second end portion comprises the second end of the heat exchanger 10S. The second end may be considered a longitudinal end of the heat exchanger 10S.

The heat exchanger 10S comprises a body. The body defines the first end and the second end. The body extends from the first end of the heat exchanger 10S to the second end of the heat exchanger 10S in a longitudinal direction of the heat exchanger 10S.

The heat exchanger 10S comprises a plurality of fluid channels 12, 14. The plurality of fluid channels 12, 14 comprises a first set C of fluid channels 12. The plurality of fluid channels 12, 14 comprises a second set H of fluid channels 14. The fluid channels 12, 14 extend through a body of the heat exchanger 10S. The fluid channels 12, 14 are again arranged in a first configuration 20S at the first end of the heat exchanger 10S. Specifically, the fluid channels 12, 14 are arranged in rows 27 (which may also be referred to as planes), as the fluid channels 12, 14 extend into the body of the heat exchanger 10S. The number of rows 27 of the first set C of fluid channels 12 is different to the number of rows 27 of the second set H of fluid channels 14. In particular, at the first end, the number of rows 27 of fluid channels 12 of the first set C is greater than the number of rows 27 of fluid channels of the second set H.

The heat exchanger 10S comprises a first transition zone. The first transition zone is disposed at or near the first end of the heat exchanger 10S. In some embodiments, the first transition zone may be said to comprise the first end of the heat exchanger 10S. The first transition zone extends along a length of the heat exchanger 10S. In some embodiments, the first end portion of the heat exchanger 10S is the first transition zone. One or more of the fluid channels 12, 14 extends through the first transition zone. In the illustrated embodiment, each fluid channel 12, 14 extends through the first transition zone.

The configuration of the fluid channels 12, 14 changes through at least part of the first transition zone. A position of one or more of the fluid channels 12, 14 changes with respect to a position of another one or more of the fluid channels 12, 14 through at least part of the first transition zone. A shape of one or more of the fluid channels 12, 14 changes across at least part of the first transition zone. Therefore, the change in configuration of the fluid channels 12, 14 across the first transition zone comprises both a change in relative position of one or more fluid channels 12, 14 and a change in shape of one or more fluid channels 12, 14.

The heat exchanger 10S comprises a heat transfer zone. The heat transfer zone may be referred to as an intermediate zone of the heat exchanger 10S. The heat transfer zone extends along a length of the heat exchanger 10S. One or more of the fluid channels 12, 14 extends through the heat transfer zone. In the illustrated embodiment, each fluid channel 12, 14 extends through the heat transfer zone. The heat transfer zone is adjacent to the first transition zone.

The heat exchanger 10S comprises a second transition zone. The second transition zone is disposed at or near the second end of the heat exchanger 10S. In some embodiments, the second transition zone may be said to comprise the second end of the heat exchanger 10S. The second transition zone extends along a length of the heat exchanger 10S. In some embodiments, the second end portion is the second transition zone. One or more of the fluid channels 12, 14 extends through the second transition zone. In the illustrated embodiment, each fluid channel 12, 14 extends through the second transition zone. In the illustrated embodiment, each fluid channel 12, 14 extends through the first transition zone, the heat transfer zone and the second transition zone. The heat transfer zone is between the first transition zone and the second transition zone.

The configuration of the fluid channels 12, 14 changes through at least part of the second transition zone. A position of one or more of the fluid channels 12, 14 changes with respect to a position of another one or more of the fluid channels 12, 14 through at least part of the second transition zone. A shape of one or more of the fluid channels 12, 14 may change across at least part of the second transition zone. The heat transfer zone is adjacent to the second transition zone. In particular, the heat transfer zone is between the first transition zone and the second transition zone.

The heat exchanger 10S comprises a plurality of sets C, H of fluid channels 12, 14. Each set C, H comprises a plurality of respective fluid channels 12, 14. In the illustrated embodiment, there are two sets C, H of fluid channels 12, 14. That is, the heat exchanger 10S comprises a first set C of fluid channels 12. The heat exchanger 10S comprises a second set H of fluid channels 14.

The first set C of fluid channels 12 comprises a first number of fluid channels 12. The second set H of fluid channels 14 comprises a second number of fluid channels 14. In the illustrated embodiment, the first number of fluid channels 12 is different to the second number of fluid channels 14. In particular, the first number of fluid channel 12 is greater than the second number of fluid channels 14. It will be appreciated that in some embodiments, the first number of fluid channels 12 may be equal to the second number of fluid channels 14.

Each of the fluid channels 12 of the first set C has a respective first end portion E1C. Each of the fluid channels 12 of the first set C has a respective second end portion. Each of the fluid channels 14 of the second set H has a respective first end portion E1H. Each of the fluid channels 14 of the second set H has a respective second end portion. Hereinafter, the first end portions E1C, E1H and the second end portions may be collectively, and in general, referred to as “first end portions E1” and “second end portions” respectively. Further, for ease of description, the end portions in a general sense, whether they be the first end portions or the second end portions, may be referred to hereafter as “end portions”.

The first end portions E1 extend from the first end of the heat exchanger 10S, along a first portion of the length of the heat exchanger 10S, towards the second end of the heat exchanger 10S. The first end portion E1 of each fluid channel 12, 14 extends through at least part of the first transition zone. In some embodiments, the first end portion E1 of each fluid channel 12, 14 is the portion of the fluid channel 12, 14 that extends through the first transition zone. That is, the portion of a respective fluid channel 12, 14 that is within the first transition zone may be considered the first end portion E1 of that fluid channel 12, 14.

In some embodiments, a respective end of one of the fluid channels 12, 14 may be considered the end portion E1 of that fluid channel 12, 14. That is, the point of a respective fluid channel 12, 14 that is at the first end 18 of the heat exchanger 10L may be considered the first end portion E1 of that fluid channel 12, 14.

The second end portions extend from the second end of the heat exchanger 10S, along a second portion of the length of the heat exchanger 10S, towards the first end of the heat exchanger 10S. The second end portion of each fluid channel 12, 14 extends through at least part of the second transition zone. In some embodiments, the second end portion of each fluid channel 12, 14 is the portion of the fluid channel 12, 14 that extends through the second transition zone. That is, the portion of a respective fluid channel 12, 14 that is within the second transition zone may be considered the second end portion of that fluid channel 12, 14.

In some embodiments, a respective end of one of the fluid channels 12, 14 may be considered the end portion E2 of that fluid channel 12, 14. That is, the point of a respective fluid channel 12, 14 that is at the second end 26 of the heat exchanger 10S may be considered the first end portion E1 of that fluid channel 12, 14.

In between the end portions, each fluid channel 12, 14 has a respective intermediate portion. That is, the fluid channels 12 of the first set C have respective intermediate portions. Similarly, the fluid channels 14 of the second set H have respective intermediate portions. Hereinafter, the intermediate portions may be referred to collectively, and in general, as “intermediate portions”.

The intermediate portion of each fluid channel 12, 14 bridges the first end portion E1 and the second end portion of that fluid channel 12, 14. That is, the intermediate portion of a fluid channel 12, 14 extends from an inner end of the first end portion E1 of that fluid channel 12, 14 to an inner end of the second end portion of that fluid channel 12, 14. The intermediate portion of each fluid channel 12, 14 extends through at least part of the heat transfer zone. In some embodiments, the intermediate portion of each fluid channel 12, 14 is the portion of the fluid channel 12, 14 that extends through the heat transfer zone.

The fluid channels 12, 14 are aligned into a number of rows 27 and a number of columns 29 at one or more points along the length of the heat exchanger 10S. In particular, the end portions of the fluid channels 12, 14 are arranged in rows 27 of fluid channels 12, 14 at each of the first end and the second end. Each row 27 of fluid channels 12, 14 at the first end portion/first end and the second end portion/second end comprises only fluid channels 12, 14 from one set C, H of fluid channels 12, 14. In other words, each row 27 of fluid channels 12, 14 comprises either only fluid channels 12 from the first set C of fluid channels 12 or only fluid channels 14 from the second set H of fluid channels 14.

The fluid channels 12, 14 are arranged in a plurality of columns 29 at each of the first end and the second end of the heat exchanger 10S. Each of these columns 29 comprises fluid channels 12 from the first set C and fluid channels 14 from the second set H.

In the illustrated embodiment, an outer end of the first end portion E1C of one or more of the fluid channels 12 of the first set C of fluid channels 12 is disposed between a first adjacent row and a second adjacent row of fluid channels. For example, fluid channel 12ca is disposed between a row 27 comprising fluid channel 14da and a row 27 comprising fluid channel 12ba. This fluid channel 12ca is therefore disposed between one row 27 of fluid channels 14 of the second set H of fluid channels 14 and one row 27 of fluid channels 12 of the first set C of fluid channels 12. More generally, fluid channels 12 of the first set C are disposed between a row 27 of fluid channels 14 of the second set H and a row 27 of fluid channels 12 of the first set C, at the first end and the second end of the heat exchanger 10S. Fluid channels 14 of the second set H are disposed between two rows 27 of fluid channels 12 of the first set C, at the first end and the second end of the heat exchanger 10S. It will be appreciated that this will not be the case for outer rows.

The number of fluid channels 12 of the first set C of fluid channels 12 is greater than the number of fluid channels 14 of the second set H of fluid channels 14.

Each fluid channel 12, 14 defines a cross-sectional shape at each point along its length. The cross-sectional shape of a respective fluid channel 12, 14 at a point along its length is viewed perpendicular to a direction of flow of fluid through the heat exchanger 10S. The cross-sectional shape of a respective fluid channel 12, 14 at a point along its length encloses a cross-sectional area of that fluid channel 12, 14 at that point.

Each fluid channel 12, 14 defines a first outer end cross-sectional shape enclosing a first outer end cross-sectional area. In particular, the first outer end cross-sectional shape is defined by the first outer end of the fluid channel 12, 14 (i.e. the end of the fluid channel 12, 14 at the first end of the heat exchanger 10S). In other words, the first outer end cross sectional shape of one of the fluid channels 12, 14 is a shape of the respective fluid channel 12, 14 at the outer end of the first end portion E1 of that fluid channel 12, 14. Each fluid channel 12, 14 defines a second outer end cross sectional shape enclosing a second outer end cross-sectional area. In particular, the second outer end cross-sectional shape is defined by the second outer end of the fluid channel 12, 14 (i.e. the end of the fluid channel 12, 14 at the second end of the heat exchanger 10S). In other words, the second outer end cross sectional shape of one of the fluid channels 12, 14 is a shape of the respective fluid channel 12, 14 at the outer end of the second end portion of that fluid channel 12, 14.

In the illustrated embodiment, the first outer end cross sectional area of each of the fluid channels 12 of the first set C of fluid channels 12 is less than the first outer end cross sectional area of the fluid channels 14 of the second set H of fluid channels 14.

Each fluid channel 12, 14 defines an intermediate cross-sectional shape enclosing an intermediate cross-sectional area. The intermediate cross-sectional shape of one of the fluid channels 12, 14 is a cross-sectional shape of the respective fluid channel 12, 14 along at least part of the heat transfer zone.

In the illustrated embodiment (see FIG. 24c), the intermediate cross sectional areas of the fluid channels 12 of the first set C of fluid channels are different to the intermediate cross-sectional areas of the fluid channels 14 of the second set H of fluid channels 14. In some embodiments, however, the intermediate cross sectional area of one or more of the fluid channels 14 of the second set H of fluid channels 14 may be the same as the intermediate cross sectional area of one or more of the fluid channels 12 of the first set C of fluid channels 12.

The first outer end cross-sectional shape, second outer end cross sectional shape and/or the intermediate cross sectional shape of one or more of the fluid channels 12, 14 may be a rounded rectangle, a rounded hexagon, a rounded octagon, or a polygon.

In some embodiments, first outer end cross-sectional shape, second outer end cross sectional shape and/or the intermediate cross-sectional shape of one or more of the first set C of fluid channels 12 and/or one or more of the second set H of fluid channels is a mirror image of the shape of another of the first set C or second set H of fluid channels 12, 14, is symmetric about a first axis of symmetry and/or is asymmetric about a second axis of symmetry. In some embodiments, first outer end cross-sectional shape, second outer end cross sectional shape and/or the intermediate cross-sectional shape of one or more of the fluid channels of the first set C of fluid channels 12 and/or one or more of the fluid channels 14 of the second set H of fluid channels comprises one or more straight sides and one or more curved sides.

The first plane P1, shown in FIG. 25a, is taken at a first end of the heat exchanger 10S. The fluid channels 12, 14 are in a first configuration 20S at the first end of the heat exchanger 10S. In the first configuration, the fluid channels 12, 14 are arranged into a number of rows 27 or planes of fluid channels 12, 14. Each row 27 comprises fluid channels 12, 14 of only one of the first set C and the second set H. That is, each row 27 of fluid channels 12, 14 comprises only fluid channels 12, 14 of one set C, H of fluid channels 12, 14. The set C, H of fluid channels 12, 14 in a particular row 27 follows a pattern as the first end of the heat exchanger 10S is traversed from one lateral side (e.g. an upper side) to another lateral side (e.g. a lower side). The pattern comprises a first row 27 of fluid channels 14 of the second set H, followed by two rows 27 of fluid channels 12 of the first set C. While the illustrated heat exchanger 10S has only 8 rows, it will be appreciated that the number of rows 27 can scale upwards significantly, with this pattern repeating. In other words, the heat exchanger 10S comprises two rows 27 of fluid channels 12 of the first set C for every one row 27 of fluid channels 14 of the second set H. The upper and lower rows 27 comprise about half of the number of fluid channels 12, 14 as intermediate rows between the upper and lower rows 27.

At the first end of the heat exchanger 10S, each of the fluid channels 12 of the first set C define a respective cross-sectional shape. In this case, the cross-sectional shape is a rounded rectangle. Each of the fluid channels 14 of the second set H define a respective cross-sectional shape. In this case, the cross sectional shape is a rounded rectangle.

A surface area of the cross sectional shape of a fluid channel 12, 14 on a respective plane may be referred to as a cross sectional surface area of that fluid channel 12, 14. The cross-sectional surface area of each of the fluid channels 12, 14 of the first set C is different to the cross-sectional surface area of each of the fluid channels 14 of the second set H at the first end of the heat exchanger 10S.

Each fluid channel 14 of the second set H has a major dimension M1 at the first end of the heat exchanger 10S. Each fluid channel 14 of the second set H has a minor dimension M2 at the first end of the heat exchanger 10S. In the illustrated embodiment, the major dimension M1 of each fluid channel 14 of the second set H is in a vertical direction. The minor dimension of each fluid channel 14 of the second set H is orthogonal to the respective major dimension M1. In the illustrated embodiment, this is a horizontal direction. In some embodiments, the cross sectional shape of one or more fluid channel 12, 14 has a major dimension along at least part of its length. The major dimension may be said to be a maximum cross-sectional dimension of the respective fluid channel 12, 14. In some embodiments, the cross sectional shape of one or more fluid channel 12, 14 has a minor dimension along at least part of its length. The minor dimension may be said to be a minimum cross-sectional dimension of the respective fluid channel 12, 14. The major dimension of a fluid channel 12, at a particular point along the length of the fluid channel 12, 14, may be measured along a major axis of the respective fluid channel 12, 14 at that particular point. Similarly, the minor dimension of a fluid channel 12, 14, at a particular point along the length of the fluid channel 12, 14, may be measured along a minor axis of the respective fluid channel 12, 14. The major axis and the minor axis of one or more fluid channel 12, 14 may be orthogonal at one or more points along the length of the fluid channel 12, 14.

The major dimension of one or more of the fluid channels 12 of the first set of fluid channels C may be different to the major dimension of one or more of the fluid channels 14 of the second set of fluid channels H, at one or more points along the length of the heat exchanger 10S. The major dimension of one or more of the fluid channels 12 of the first set of fluid channels C may be greater than the major dimension of one or more of the fluid channels 14 of the second set of fluid channels H, at one or more points along the length of the heat exchanger 10S. The major dimension of one or more of the fluid channels 12 of the first set of fluid channels C may be less than the major dimension of one or more of the fluid channels 14 of the second set of fluid channels H, at one or more points along the length of the heat exchanger 10S. The minor dimension of one or more of the fluid channels 12 of the first set of fluid channels C may be greater than the minor dimension of one or more of the fluid channels 14 of the second set of fluid channels H, at one or more points along the length of the heat exchanger 10S. The minor dimension of one or more of the fluid channels 12 of the first set of fluid channels C may be less than the minor dimension of one or more of the fluid channels 14 of the second set of fluid channels H, at one or more points along the length of the heat exchanger 10S. The major dimension of one or more of the fluid channels 12 of the first set of fluid channels C may be equal to the major dimension of one or more of the fluid channels 14 of the second set of fluid channels H, at one or more points along the length of the heat exchanger 10S. The major dimension of one or more of the fluid channels 12 of the first set of fluid channels C may be equal to the minor dimension of one or more of the fluid channels 14 of the second set of fluid channels H, at one or more points along the length of the heat exchanger 10S. The minor dimension of one or more of the fluid channels 12 of the first set of fluid channels C may be equal to the major dimension of one or more of the fluid channels 14 of the second set of fluid channels H, at one or more points along the length of the heat exchanger 10S. The minor dimension of one or more of the fluid channels 12 of the first set of fluid channels C may be equal to the minor dimension of one or more of the fluid channels 14 of the second set of fluid channels H, at one or more points along the length of the heat exchanger 10S.

Each fluid channel 12, 14 has a respective cross sectional midpoint 19. The cross sectional midpoint 19 may be considered a centroid of the respective fluid channel 12, 14 at a point along its length. It will be appreciated that in some embodiments, one or more of the fluid channels 12, 14 does not have a major dimension and/or a minor dimension. For example, the fluid channels 12 of the first set C are rounded rectangles that do not have a specific major or minor dimension.

The second plane P2, shown in FIG. 25b, shows the fluid channels 12, 14 arranged in a second configuration 25S at an intermediate point along the length of the heat exchanger 10S. The intermediate point is within the first transition zone of the heat exchanger 10S. The intermediate point is between the first end and the second end of the heat exchanger 10S. As can be seen by comparing FIG. 25a with FIG. 25b, the relative position of one or more of the fluid channels 12, 14 has changed with respect to one or more other fluid channels 12, 14.

In order to change the configuration of the fluid channels 12, 14 from the first configuration 20S to the second configuration 25S, a plurality of the fluid channels 12, 14 are translated in a first direction D1 as they extend through the first transition zone. In the embodiment of FIGS. 25a to 25c, alternating columns 29 of fluid channels 12, 14 are translated in the first direction D1, along a first length of the first transition zone. In the illustrated embodiment, the first direction D1 is an upward direction. This translation moves the relevant fluid channels 12, 14 with respect to the fluid channels 12, 14 of the other columns 29.

In addition to the above translation, another plurality of the fluid channels 12, 14 are translated in a second direction D2, along at least part of the first transition zone. In particular, the other set of alternating columns 29 of fluid channels 12, 14 are translated in the second direction D2, along the first length of the first transition zone. The second direction D2 is opposite the first direction D1. In the illustrated embodiment, the second direction D2 is a downward direction. This translation moves the relevant fluid channels 12, 14 with respect to the fluid channels 12, 14 of the other columns 29.

It will be appreciated that in some embodiments, translations of mutually exclusive columns 29 in different directions D1, D2 are not necessary. For example, one group of alternating columns 29 may simply translate in the first direction D1 until the fluid channels 12, 14 are in a second configuration 25S at the intermediate point. That is, one group of alternating columns 29 may translate in the first direction D1, as they extend along the first length of the first transition zone, until the fluid channels 12, 14 are aligned in the second configuration 25S. Alternatively, one group of alternating columns 29 may translate in the second direction D2 until the fluid channels 12, 14 are arranged in the second configuration 25S.

In the second configuration 25S, the fluid channels 12, 14 of each row are offset with respect to the fluid channels 12, 14 of the adjacent rows. The cross-sectional shape of one or more of the fluid channels 12, 14 changes along a second length of the first transition zone of the heat exchanger 10S. In particular, the cross sectional shape of each fluid channel 12, 14 changes as the fluid channels 12, 14 extend away from the intermediate point along the length of the heat exchanger 10S, towards the second end of the heat exchanger 10S.

The third plane P3, shown in FIG. 25c, shows the fluid channels 12, 14 arranged in a third configuration 22S at a second intermediate point along the length of the heat exchanger 10S. The second intermediate point is at an inner end of the first transition zone. The second intermediate point may correspond to a point at which the first transition zone changes to the heat transfer zone. As can be seen by comparing FIG. 25b with FIG. 25c, the cross sectional shape of the fluid channels 12, 14 has changed between the second configuration 25S and the third configuration 22S.

In particular, the fluid channels 14 of the second set H change from a first cross sectional shape at the first intermediate point to a second cross sectional shape at the second intermediate point along the length of the heat exchanger 10S. In the illustrated embodiment, the second cross-sectional shape is a hexagon.

Each of the fluid channels 13 of the first set C change from a first cross sectional shape at the first intermediate point to a respective second cross sectional shape at the second intermediate point along the length of the heat exchanger 10S. The second cross sectional shape of a subset of the fluid channels 12 of the first set C is different from the second cross sectional shape of another subset of the fluid channels 12 of the second set C in at least one aspect. In the illustrated embodiment, the shape is the same; however, it is rotated by 180 degrees in some instances. That is, for some fluid channels 12 of the first set C, the second cross sectional shape is a mirror image of the second cross¬sectional shape of other fluid channels 12.

The second cross sectional shape of the fluid channels 12 of the first set C is symmetric about one axis. The second cross sectional shape of the fluid channels 12 of the first set C is asymmetric about another axis. The axis about which the second cross sectional shape of the fluid channels 12 of the first set C is asymmetric is orthogonal to the axis about which the second cross sectional shape is symmetric. The second cross sectional shape is a 6-sided polygon.

The third configuration 22S is the heat transfer configuration of this embodiment. The fluid channels 12, 14 are maintained in the third configuration 22S as they extend through the heat transfer zone of the heat exchanger 10S. The changes in configuration of the fluid channels 12, 14 are then reversed within a second transition zone at an opposite end of the heat exchanger 10S as the first transition zone. Across a first length of the second transition zone, the cross sectional shape of each fluid channel 12, 14 changes. The cross-sectional shapes change such that at a third intermediate point along the length of the heat exchanger 10S (that is within the second transition zone), the fluid channels 12, 14 are again arranged in the second configuration 25S. Across a second length of the second transition zone, the fluid channels 12, 14 translate to reverse the translation across the first length of the first transition zone. Therefore, at the second end of the heat exchanger 10S, the fluid channels are again arranged in the first configuration 20S.

The change in configuration of the fluid channels 12, 14 of this heat exchanger 10S provides a number of advantages. Specifically, the shared heat transfer length between the fluid channels 12, 14 increases due to the translation and change in shape of the fluid channels 12, 14.

### Joint and Several Nature of Embodiments

Now that numerous embodiments of the heat exchanger 10 have been described above it should be understood that various embodiments of the heat exchanger 10 may stand alone as separate embodiments or aspects of the disclosed heat exchanger; or can be combined in various combinations to form other embodiments or aspects of the heat exchanger. For example:
The embodiment of the heat exchanger 10a shown in FIGS. 1a-2d may stand alone or may be further modified or varied by of incorporating one of the surface finishes described above, or have an alternate ratio of channels 12 to channels 14 such as the embodiment 10d, or be formed with channels 12, 14 in the heat transfer zone TZ of different configuration as in the embodiment 10e, or have the channels 12, 14 arranged so is to vary in cross sectional shape along the length of the channels such as shown in FIG. 11;
Embodiments of the heat exchanger 10a-10S in addition to the possible variations noted immediately above may also be formed with more than two sets of heat exchanger channels H, C. For example, embodiments of the heat exchanger may be arranged to enable the flow of three for more fluids, in a manner to facilitate heat exchange between fluids.
Embodiments of the heat exchanger 10a-10S are described and illustrated as being provided with sets of channels H, C which terminated in headers at opposite ends of the heat exchanger. However, embodiments of the disclosed heat exchanger to be provided with sets of channels H, C which follow in broad terms a U-shaped configuration so that all of the headers are at one end of the heat exchanger.

### Method of Construction

Many of the above described embodiments of the disclosed heat exchanger could be constructed or manufactured using conventional manufacturing techniques. However, it is believed that at least some of the embodiments would be very challenging in an engineering sense and/or otherwise extremely expensive and moreover not commercially feasible to manufacture using conventional manufacturing techniques. Nonetheless, it is believed that using additive manufacturing techniques, or other recently developed manufacturing techniques, heat exchangers in accordance with the present disclosure can be manufactured at a significantly reduced cost as compared to traditional manufacturing techniques. At least a portion of one or more of the embodiments of the disclosed heat exchange system may be formed using a rapid prototyping or additive layer manufacturing process. In other embodiments, the entire heat exchange system is formed using a rapid prototyping or additive layer manufacturing process. In general, additive manufacturing techniques provide flexibility in free-form fabrication without geometric constraints, fast material processing time, and innovative joining techniques.

Some examples of additive layer manufacturing processes include, but are not limited to: micro-pen deposition in which liquid media is dispensed with precision at the pen tip and then cured; selective laser sintering in which a laser is used to sinter a powder media in precisely controlled locations; laser wire deposition in which a wire feedstock is melted by a laser and then deposited and solidified in precise locations to build the product; electron beam melting; laser engineered net shaping; and direct metal deposition. Other additive manufacturing techniques include, for example, direct metal laser sintering or direct metal laser fusion with, for example, nickel base super-alloys, low density titanium, or aluminium alloys. Another technique includes electron beam melting with titanium, titanium aluminide, and nickel base super-alloy materials. Still further, casting or metal injection moulding (MIM) may be employed.

Various components of the heat exchanger, whether made by additive manufacturing techniques or otherwise, may be brazed or otherwise joined together to form a completed heat exchange system. By way of example, the illustrated embodiment of the heat exchanger can be manufactured by a three-dimensional printing process such as that outlined in detail in United States U.S. Pat. No. 6,623,687 (issued to Gervasi dated 23 Sep. 2003), the contents of which are hereby incorporated in their entirety by way of reference. When three-dimensional printing has been completed, the heat exchanger that is removed from the additive manufacturing system may undergo finishing treatments. Finishing treatments may include, for example, aging, annealing, quenching, peening, polishing, hot isostatic pressing (HIP), or coatings. If necessary, the heat exchanger may be machined to final specifications.

Additive manufacture may be used to form a single heat exchanger or to form a plurality of heat exchangers simultaneously. Simultaneous fabrication of a number of components may reduce cost and variability of the manufacturing process. Preferably the material from which the heat exchanger is printed is, or includes, a metallic material. Other embodiments of the disclosed heat exchanger may be manufactured using alternative methods, such as the individual machining of various layers, for example. In accordance with this method, each individually machined layer defines at least some portions of the flow paths. Once machined, the individual layers are bonded together by an adhesive, welding, or other such means.

It has been appreciated by the inventor of the current application that the use of the three-dimensional printing manufacturing method provides significant freedom to design and manufacture a heat exchanger having a relatively complex arrangement of fluid channels. Durability and life span of the heat exchanger of embodiments of the disclosed heat exchanger may be improved by manufacturing each portion of the heat exchange system using designs that minimize the structural stresses that will be encountered during operation, and by improving the physical connection between the various components.

It expected that the disclosed heat exchangers will be suitable for use in a wide array of applications. Some non-limiting examples include auxiliary power units, environmental control systems, chemical reaction systems, and any other systems where heat exchange between two fluid media (gas, liquid, etc.) is either required or desirable.

The specific geometry of the first and second fluid channels in terms of cross-sectional area, spacing and groupings may be determined by computational fluid/heat transfer analysis and by corresponding stress analysis to optimize the overall performance of the heat exchanger with respect to pressure drops, heat transfer, stress, and weight.

When using the additive manufacturing techniques for construction of the disclosed heat exchangers the entire heat exchanger including the headers can be made in a continuous process. Alternately a main body of the heat exchanger and the headers may each be made using the additive manufacturing technique but form separately and subsequently joined together. For example, with reference to FIG. 1a, the main body of the heat exchanger between ends 18 and 26 may be made separately from the headers represented in FIG. 1b. The headers may then be subsequently attached to the main body.

While several exemplary embodiments have been presented in the foregoing detailed description, it should be appreciated that a vast number of variations exist. It should also be appreciated that the exemplary embodiments of the heat exchange are only examples, and are not intended to limit the scope, applicability, or configuration of the present disclosure in any way. Rather, the foregoing detailed description will provide those skilled in the art with a convenient road map for implementing an exemplary embodiment of the disclosed heat exchanger.

In the preceding description and claims which follow, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the disclosed heat exchanger.

What is claimed:

1. A heat exchanger comprising:
a plurality of sets of fluid channels, each fluid channel having first and second end portions and an intermediate portion between the first and second end portions;
the first end portions, in a plane perpendicular to a direction of fluid flow in the channels, have respective end perimeters which are in a first configuration, wherein adjacent end portions of different sets of fluid channels have a total first shared heat transfer length being a summation of lengths of mutually opposed perimeters of the adjacent end portions of the different sets;
the intermediate portions in a plane transverse to the direction of fluid flow have respective intermediate channel perimeters, the intermediate portions having a second configuration with a total second shared heat transfer length, being a summation of lengths of mutually opposed channel perimeters of the adjacent channels of the different sets;
wherein the total second shared heat transfer length is different to the total first heat transfer length; and
wherein in the first configuration the first end portions of the channels are arranged in alternating planes of channels so that each plane contains only channels from the same set of channels.

2. The heat exchanger according to claim 1, wherein, in the second configuration, the channels are arranged in a chequerboard configuration.

3. The heat exchanger according to claim 1, comprising at least one group of reconfiguring channels each group of reconfiguring channels having at least two channels from mutually different sets of channels; and wherein the at least one group of reconfiguring channels is reconfigured relative to adjacent channels from the first configuration to the second configuration.

4. The heat exchanger according to claim 3, wherein each group of reconfiguring channels is progressively rotated or twisted about an axis parallel to a direction of flow of fluid through the channels.

5. The heat exchanger according to claim 4, wherein each group of reconfiguring channels is progressively rotated or twisted to an extent so that the channels in the reconfiguring group are, in at least one plane perpendicular to a flow of fluid, transposed relative to their position at one of the ends of the corresponding channels.

6. The heat exchanger according to claim 5, wherein the channels in the reconfiguring group are maintained in their transposed position for at least a quarter of a length of the intermediate portion of the channels in the reconfiguring group.

7. The heat exchanger according to claim 6, wherein the channels in the reconfiguring group of channels have their first end portions arranged in the first configuration and their second end portions in the first configuration and wherein the reconfiguring group of channels is progressively rotated or twisted from their transposed position so that the second end portions of the channels are in the first configuration.

8. The heat exchanger according to claim 1, wherein a cross sectional shape of one or more channels in at least one of the sets of channels changes for at least a portion of the length of the one or more channels from the end portion to the intermediate portion.

9. The heat exchanger according to claim 8, wherein the change in cross sectional shape of a first set of channels is accompanied by a change in juxtaposition of the first set of channels relative to a second set of channels.

10. The heat exchanger according to claim 8, wherein a cross sectional shape of the first set of channels is arranged so that a perimeter of the first set of channels lies adjacent to a perimeter of two or more channels of a second set of channels.

11. The heat exchanger according to claim 8, wherein the cross sectional shape of one or more channels in the intermediate portion is generally triangular.

12. The heat exchanger according to claim 8, wherein the cross sectional shape at the end portion of one or more channels is selected from the group comprising: circle, ellipse, polygon with four or more sides and a rounded polygon with four or more sides.

13. The heat exchanger according to claim 1, wherein a cross sectional area of one or more channels in at least one of the sets of channels changes for at least a portion of the length of the one or more channels from the end portion to the intermediate portion.

14. The heat exchanger according to claim 8, wherein at least a second set of the plurality of sets of channels is configured to have a cross sectional shape or area at the end portion that is different from a cross sectional shape or area at the intermediate portion.

15. The heat exchanger according to claim 2, wherein the first configuration is a matrix comprising alternating rows of channels of different sets so that each row in the matrix comprises only channels of the same set, and wherein the channels in the matrix are aligned in columns, and wherein mutually adjacent columns of channels are progressively offset relative to each other in a direction of the columns from the first ends to the intermediate portion so as to be arranged in the chequerboard configuration.

16. The heat exchanger according to claim 1, wherein the plurality of sets of fluid channels comprises a first set of channels and a second fluid channels, and wherein, in the first configuration, the first end portions of the first set of channels have a first spacing from the first end portions of the second set of channels, and in the second configuration, the intermediate portions of the first set of channels have a second spacing from the intermediate portions of the second channels, wherein the second spacing is less than the first spacing.

17. The heat exchanger according to claim 1, wherein one or more of the channels in at least one of the sets of channels follow a three-dimensional helical or spiral path.

18. The exchanger according to claim 1, wherein the total second shared heat transfer length is greater than the total first shared heat transfer length.

19. A method of constructing a heat exchanger of claim 1, comprising progressively building the plurality of sets of channels using an additive manufacturing technique.

20. A method of manufacturing a heat exchanger having at least two sets of channels comprising:
using an additive manufacturing technique to progressively build at least a main body of the heat exchanger, the main body being provided with a plurality of sets of fluid flow channels, each channel defining a respective fluid flow path having a first end portion, a second end portion and an intermediate portion, wherein the configuration of the plurality of sets of channels at one of the end portions is different to the configuration of the set of channels in the intermediate portion;
arranging the first end portions in a first configuration of alternating planes of channels so that each plane contains only channels from the same set of channels;
rearranging or reorienting the channels so that the intermediate portions are in a second configuration which is different to the first configuration; and
rearranging or reorienting the channels from the second configuration so the second end portions revert to the first configuration.
